(19) United States
(12) Patent Application Publication
(10) Pub. No.: US 2010/0215191 A1
(43) Pub. Date: Aug. 26, 2010

(54) SOUND DETERMINATION DEVICE, SOUND DETECTION DEVICE, AND SOUND DETERMINATION METHOD

(76) Inventors: Shinichi YOSHIZAWA, Osaka (JP); Yoshihisa Nakatoh, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/773,102

(22) Filed: May 4, 2010

Related U.S. Application Data
(63) Continuation of application No. PCT/JP2009/004855, filed on Sep. 25, 2009.

(30) Foreign Application Priority Data
Sep. 30, 2008 (JP) 2008-253105

(51) Int. Cl. H04B 15/00

(52) U.S. Cl. 381/94.2

(57) ABSTRACT

A noise removal device includes: an FFT analysis unit which receives a mixed sound including to-be-extracted sounds and noises, and determines frequency signals at time points in a time width; and a to-be-extracted sound determination unit which determines, for each to-be-extracted sound, frequency signals at the time points, satisfying conditions of (i) being equal to or greater than a first threshold value in number and (ii) having a phase distance between the frequency signals that is equal to or smaller than a second threshold value, wherein the phase distance is a distance between phases ψ′(t) of the condition-satisfying frequency signals when a phase of a frequency signal at a current time point t is ψ(t) (radian) and the phase ψ′(t) is mod 2π(ψ(t)−2πft), f denoting a reference frequency, and the predetermined time width is within 2 to 4 times the time window widths of the window functions.

### CROSS REFERENCE TO RELATED APPLICATION

This is a continuation application of PCT application No. PCT/JP2009/004855, filed on Sep. 25, 2009, designating the United States of America.

### BACKGROUND OF THE INVENTION

(1) Field of the Invention

The present invention relates to a sound determination device which determines frequency signals of to-be-extracted sounds included in a mixed sound on a per time-frequency domain basis, and in particular to a sound determination device which separates toned sounds such as an engine sound, a siren sound, and a voice, in distinction from toneless sounds such as a wind noise, a rain sound, and a background noise, and determines frequency signals of a toned sound (or a toneless sound) on a per time-frequency domain basis.

(2) Description of the Related Art

There are first conventional techniques intended to try to extract pitch cycles of an input audio signal (a mixed sound), and determine a sound having no pitch cycle to be a noise (For example, see Patent Reference 1: Japanese Unexamined Patent Application Publication No. 5-210397, (Claim 2, FIG. 1)). In the first conventional techniques, a voice is recognized based on an input voice determined to be a target voice. FIG. 1 is a block diagram showing the structure of a noise removal device according to the first conventional technique disclosed in Patent Reference 1.

The noise removal device includes a recognition unit 2501, a pitch extraction unit 2502, a determination unit 2503, and a cycle range storage unit 2504.

The recognition unit 2501 is a processing unit which outputs a target voice to be recognized included in a signal segment estimated to be a voice portion (sound to be extracted) in an input audio signal (a mixed sound). The pitch extraction unit 2502 is a processing unit which extracts a pitch cycle from the input audio signal. The determination unit 2503 is a processing unit which outputs a result of voice recognition based on (i) the target voice to be recognized in the signal segment outputted by the recognition unit 2501 and (ii) the result of pitch extraction performed on the signal in the segment extracted by the pitch extraction unit 2502. The cycle range storage unit 2504 is a recording device which stores a cycle range corresponding to the pitch cycle to be extracted by the pitch extraction unit 2502. This noise removal device either determines a signal in the signal segment to be of a target voice when the pitch cycle is within a predetermined range, or determines a signal to be of a noise when the pitch cycle is outside the predetermined range.

In addition, there are second conventional techniques intended to finally determine the presence or absence of an input of a human voice based on the results of determinations made by three determination units (for example, see Patent Reference 2: Japanese Unexamined Patent Application Publication No. 2006-194959, Claim 1). The first determination unit determines that a human voice (sound to be extracted) is inputted when a signal component having a harmonic structure is detected from the input signal (mixed sound). The second determination unit determines that a human voice is inputted when the frequency center of gravity of the input signal is within a predetermined frequency range. The third determination unit determines that a human voice is inputted when the power ratio of the input signal with respect to a noise level stored in the noise level storage unit exceeds a predetermined threshold value.

In addition, there are third conventional techniques that are coding methods of efficiently coding an audio signal with a determination that noises are dominant in a portion having a phase varying at random (for example, see Patent Reference 3: Japanese Unexamined Patent Application Publication No. 2002-515610, (Paragraph 0013)).

### SUMMARY OF THE INVENTION

The first conventional technique is configured to extract pitch cycles on a per time segment basis. For this, it is impossible to determine, on a per time-frequency domain basis, a frequency signal of a to-be-extracted sound included in a mixed sound. In addition, it is impossible to determine a sound having a varying pitch cycle such as an engine sound (having a pitch cycle varying depending on the number of turns of the engine).

In addition, the second conventional technique is configured to determine a to-be-extracted sound, based on the spectrum shape such as the harmonic structure and the frequency center of gravity. For this, it is impossible to determine a to-be-extracted sound when the sound includes great noises causing distortion in the spectrum shape. In a particular case of a to-be-extracted sound having a spectrum shape distorted due to noises but is maintained when seen partially on a per time-frequency domain basis, it is impossible to determine that the frequency signal in the portion is a frequency signal of the to-be-extracted sound.

In addition, since the third conventional technique is configured to code an audio signal, it is difficult to apply the configuration to a technique of extracting only a to-be-extracted sound from a mixed sound.

The present invention has been made to solve the aforementioned problems, and has an object to provide a sound determination device and the like which can determine a frequency signal of a to-be-extracted sound included in a mixed sound, on a per time-frequency domain basis. In particular, the present invention has an object to provide a sound determination device and the like which can separate toned sounds such as an engine sound, a siren sound, and a voice in distinction from toneless sounds such as a wind noise, a rain sound, and a background noise, and determine frequency signals of a toned sound (or a toneless sound) on a per time-frequency domain basis.

A sound determination device according to an aspect of the present invention includes: a frequency analysis unit configured to receive a mixed sound including sounds to be extracted and noises, multiply the mixed sound by window functions having predetermined time window widths, and determine frequency signals at time points included in a predetermined time width of the mixed sound multiplied by the window functions; and a to-be-extracted sound determination unit configured to determine, for each of the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals at the time points in the predetermined time width, wherein the phase distance is a distance between phases ψ′(t) of the condition-satisfying frequency signals when a phase of a frequency signal at a current time point t among the time points is ψ(t) (radian) and the phase ψ′(t) is expressed by an expression ψ′(t)=mod 2π(ψ(t)−2πft), f denoting a reference frequency, and the predetermined time width is set to be within a range from 2 to 4 times the time window widths of the window functions.

This configuration is intended to use a distance (an indicator for measuring a time shape of a phase ψ′(t) in a predetermined time width) according to the expression ψ′(t)=mod 2π(ψ(t)−2πft) (here, f denotes a reference frequency) when the phase of a frequency signal at a current time point t is ψ(t) (radian). This separates toned sounds such as an engine sound, a siren sound, and a voice in distinction from toneless sounds such as a wind noise, a rain sound, and a background sound, on a per time-frequency domain basis. In addition, it is possible to determine frequency signals of a toned sound (or a toneless sound).

Further, the time width used to calculate a phase distance is determined to be within a range from 2 to 4 times a time window width (corresponding to a time resolution) of a window function. With this, it is possible to determine a time width used to calculate a phase distance based on the time resolution (the time window width of the window function), thereby making it possible to determine frequency signals of a to-be-extracted sound using various time resolutions. The use of suitable time resolutions makes it possible to accurately determine a to-be-extracted sound particularly in the case of determining frequency signals of a to-be-extracted sound having a temporally varying frequency structure. For example, fine time resolutions are used to determine frequency signals of a to-be-extracted sound such as a voice having a frequency structure which varies significantly and quickly, and rough time resolutions (fine frequency resolutions) are used to determine frequency signals of a to-be-extracted sound such as an engine sound during an idle running state having a frequency structure which varies slowly.

If a frequency signal of a to-be-extracted sound is determined using an unsuitable time resolution (a time window width of a window function), the phase is distorted by a mixed-in sound and thus the phase distance is inevitably increased. For this reason, even in this case, there is no possibility that a frequency signal of a noise is determined to be a frequency signal of a to-be-extracted sound.

It is preferable that the frequency analysis unit is configured to determine frequency signals at time points at a 1/f interval from among the frequency signals at the time points in the predetermined time width by calculation using each of the window functions having the time window widths, f denoting a reference frequency, the to-be-extracted sound determination unit is configured to determine whether or not each of the frequency signals determined by the calculation using a corresponding one of the window functions is a frequency signal of one of the sounds to be extracted, and that the sound determination device further includes a sound detection unit configured to generate and output a to-be-extracted sound detection flag when at least one frequency signal at one of the time points determined by the calculation using a corresponding one of the window functions is determined to be a frequency signal of one of the sounds to be extracted.

With this structure, it is possible to detect a to-be-extracted sound using the result of a determination using a time resolution suitable for the to-be-extracted sound from among the results of determinations using plural time resolutions (time window widths of window functions), thereby making it possible to accurately detect the to-be-extracted sound and notify a user of the detection result. For example, a vehicle detection device with an embedded nose removal device can accurately detect an engine sound (to-be-extracted sound) and notify a driver of the presence of an approaching vehicle.

It is preferable that the to-be-extracted sound determination unit is configured to: classify the frequency signals into groups of frequency signals satisfying the conditions of (i) being equal to or greater than the first threshold value in number and (ii) having the phase distance between the frequency signals that is equal to or smaller than the second threshold value; check whether or not a phase distance between the respective groups of frequency signals is equal to or greater than a third threshold value; and determine the respective groups of frequency signals to be of different kinds of sounds to be extracted when the phase distance between the respective groups of frequency signals is equal to or greater than the third threshold value.

With this structure, it is possible to separate different kinds of to-be-extracted sounds included in a time-frequency domain from one another, and separately determine the respective to-be-extracted sounds. For example, it is possible to separately determine engine sounds from plural vehicles. A vehicle detection device to which a noise removal device according to the present invention is applied allows a driver to recognize the presence of plural vehicles and thus to drive safely. In addition, an audio output device for which a noise removal device according to the present invention is applied can separately determine voices of people, and thus can output as sounds the voices separately.

It is further preferable that the to-be-extracted sound determination unit selects a frequency signal at a current time point appearing at a 1/f (f denotes a reference frequency) time interval from among frequency signals at time points included in the predetermined time width, and calculates the phase distance using the frequency signal at the selected time point.

According to this structure, the phase distance of the frequency signals at a 1/f time interval can be easily calculated according to the expression ψ′(t)=mod 2π(ψ(t)−2πft)=ψ(t) (here, f denotes a reference frequency).

It is further preferable that the aforementioned sound determination device further includes a phase modification unit configured to modify the phase ψ(t) (radian) of the frequency signal at the current time point t to ψ′(t) according to the expression ψ′(t)=mod 2π(ψ(t)−2πft), f denoting the reference frequency, wherein the to-be-extracted sound determination unit is configured to calculate the phase distance ψ(t) using the modified phase ψ′(t) of lo the frequency signal.

This structure is intended to modify the phase distances expressed by the expression ψ′(t)=mod 2π(ψ(t)−2πft). With this, it is possible to easily calculate the phase distances of frequency signals at a time interval shorter than a 1/f time interval, according to the expression ψ′(t)=mod 2π(ψ(t)−2πft) (here, f denotes a reference frequency). For this, it is possible to determine frequency signals of a to-be-extracted sound on a per short time domain basis even in a low frequency band with a long 1/f time interval, by the simple calculation using the expression ψ′(t)=mod 2π (ψ(t)−2πft).

The sound detection device according to another aspect of the present invention includes: the aforementioned sound detection device; and a sound detection unit which generates and outputs a to-be-extracted sound detection flag when the sound detection device determines that a frequency signal among the frequency signals of the mixed sound is a frequency signal of one of the to-be-extracted sounds. With this structure, it is possible to detect the to-be-extracted sound on a per time-frequency domain basis, and notify a user the detected to-be-extracted sound. For example, a vehicle detection device with an embedded noise removal device according to the present invention can detect that an engine sound is a to-be-extracted sound, and notify a driver of the presence of an approaching vehicle.

It is preferable that the frequency analysis unit is configured to receive mixed sounds through microphones, and generate frequency signals from each of the mixed sounds, the to-be-extracted sound determination unit is configured to determine the sounds to be extracted in each of the mixed sounds, and that the sound detection unit is configured to generate and output a to-be-extracted sound detection flag when the sound determination device determines that a frequency signal at one of the time points among the frequency signals of at least one of the mixed sounds is a frequency signal of one of the sounds to be extracted.

This structure increases the possibility of detecting a to-be-extracted sound which cannot be detected from a mixed sound received through a microphone due to an influence of noises, using another microphone. For this reason, the number of detection errors can be reduced. For example, a vehicle detection device with an embedded noise removal device according to the present invention can utilize such mixed sound that is less affected by a wind noise because the mixed sound has been received through a microphone disposed to reduce the influence. For this, it is possible to accurately detect that an engine sound is a to-be-extracted sound, and notify a driver of the presence of an approaching vehicle. It may be considered that a mixed sound with great noises makes a bad influence. However, the present invention has a feature of allowing elimination of this bad influence by automatic noise removal utilizing the nature that temporal phase variations are irregular in time-frequency domains with great noises.

A sound extraction device according to another aspect of the present invention includes: the aforementioned sound detection device; and a sound extraction unit which outputs the frequency signals determined to be frequency signals of one of the to-be-extracted sounds when the sound detection device determines that the frequency signals included in the frequency signals of the mixed sound are frequency signals of the one of the to-be-extracted sounds.

With this structure, it is possible to use the frequency signals, of the to-be-extracted sound, determined on a per time-frequency domain basis. For this, for example, an audio output device with an embedded noise removal device according to the present invention can reproduce a clear extracted sound from which noises have been removed. In addition, a sound source direction detection device with an embedded noise removal device according to the present invention can calculate a sound source direction of a clear extracted sound from which noises have been removed. In addition, a sound recognition device with an embedded noise removal device according to the present invention can accurately recognize a sound even when the sound is surrounded by noises.

It is to be noted that the present invention can be implemented not only as a sound detection device including unique units as mentioned above, but also as a sound determination method having the steps corresponding to the unique units included in the sound detection device and as a sound determination program causing a computer to execute the unique steps included in the sound determination method. As a matter of course, such program can be distributed through recording media such as CD-ROMs (Compact Disc-Read Only Memories) and via communication networks such as the Internet.

With a sound determination device and the like according to the present invention, it is possible to determine frequency signals of a to-be-extracted sound included in a mixed sound on a per time-frequency domain basis. In particular, it is possible to separate toned sounds such as an engine sound, a siren sound, and a voice in distinction from toneless sounds such as a wind noise, a rain sound, and a background noise, and determine frequency signals of a toned sound (or a toneless sound) on a per time-frequency domain basis.

For example, the present invention can be applied to an audio output device which receives input audio frequency signals determined on a per time-frequency domain basis, and output the extracted sound using an inverse frequency transform. In addition, the present invention can be applied to a sound source direction detection device which receives, for each Of to-be-extracted sounds in each of mixed sounds inputted through at least two microphones, input frequency signals determined on a per time-frequency basis, and outputs information indicating the sound source direction of the to-be-extracted sound. Further, the present invention can be applied to a sound identification device which receives input frequency signals, of each of to-be-extracted sounds, determined on a per time-frequency domain basis, and performs voice recognition and sound identification. Furthermore, the present invention can be applied to a wind noise level determination device which receives input frequency signals, of a wind noise, determined on a per time-frequency domain basis, and output information indicating the magnitude of the signal power. In addition, the present invention can be applied to a vehicle detection device which receives input frequency signals, of a running noise due to friction of tires, determined on a per time-frequency domain basis, and detect a vehicle based on the signal power. Further, the present invention can be applied to a vehicle detection device which detects frequency signals, of an engine sound, determined on a per time-frequency domain basis, and notify a driver of the presence of an approaching vehicle. Furthermore, the present invention can be applied to an emergency vehicle detection device which detects frequency signals, of a siren sound, determined on a per time-frequency domain basis, and notify a driver of the presence of an approaching emergency vehicle.

### FURTHER INFORMATION ABOUT TECHNICAL BACKGROUND TO THIS APPLICATION

The disclosure of Japanese Patent Application No. 2008-253105 filed on Sep. 30, 2008, including specification, drawings and claims is incorporated herein by reference in its entirety.

The disclosure of PCT application No. PCT/JP2009/004855 filed on Sep. 25, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the overall structure of a conventional noise removal device;

FIG. 2 is a diagram illustrating the definitions of phases in the present invention;

Each of FIGS. 3A and 3B is a conceptual diagram illustrating a feature in the present invention;

Each of FIGS. 4A and 4B is a diagram illustrating the relationship between the property of a sound source of a toned sound and phases of the toned sound;

FIG. 5 is an external view of a noise removal device according to Embodiment 1 of the present invention;

FIG. 6 is a block diagram showing the overall structure of a noise removal device according to Embodiment 1 of the present invention;

FIG. 7 is a block diagram showing a to-be-extracted sound determination unit 101(j) of the noise removal device according to Embodiment 1 of the present invention;

FIG. 8 is a flowchart indicating a procedure of operations performed by the noise removal device according to Embodiment 1 of the present invention;

FIG. 9 is a flowchart indicating Step S301(j) of determining each of frequency signals of a to-be-extracted sound; S301(j) is performed, as one of the operations in the procedure, by the noise removal device according to Embodiment 1 of the present invention;

FIG. 10 is a diagram showing an exemplary spectrogram of a mixed sound 2401;

FIG. 11 is a diagram showing an exemplary spectrogram of a sound used to generate the mixed sound 2401;

FIG. 12 is a diagram illustrating an exemplary method of selecting frequency signals;

Each of FIGS. 13A and 13B is a diagram illustrating an exemplary method of selecting frequency signals;

FIG. 14 is a diagram illustrating an exemplary method of calculating a phase distance;

FIG. 15 is a diagram showing a spectrogram of a sound extracted from a mixed sound 2401;

FIG. 16 is a schematic diagram showing the phases of frequency signals, of a mixed sound, in a time range (predetermined time width) used to calculate phase distances;

FIG. 17 is a diagram illustrating phase distances expressed by the expression ψ′(t)=mod 2π(ψ(t)−2πft) (here, f denotes a reference frequency);

FIG. 18 is a diagram illustrating a mechanism of temporally shifting a current phase counterclockwise;

FIG. 19 is a diagram illustrating phase distances expressed by the expression ψ′(t)=mod 2π(ψ(t)−2πft) (here, f denotes a reference frequency);

FIG. 20 is a block diagram showing the overall structure of the noise removal device according to Embodiment 1 of the present invention;

FIG. 21 is a diagram showing time waveforms of frequency signals at 200 Hz of the mixed sound 2401;

FIG. 22 is a diagram showing time waveforms of frequency signals in sine waves at 200 Hz used to generate the mixed sound 2401;

FIG. 23 is a diagram showing time waveforms of frequency signals at 200 Hz extracted from the mixed sound 2401;

FIG. 24 is a diagram illustrating an exemplary method of generating a histogram of phase components of frequency signals;

FIG. 25 is a diagram showing frequency signals selected by a frequency signal selection unit 200(j) and an exemplary histogram of phases of the selected frequency signals;

FIG. 26 is a block diagram showing the overall structure of a noise removal device according to Embodiment 2 of the present invention;

FIG. 27 is a block diagram showing a to-be-extracted sound determination unit 1502(j) of the noise removal device according to Embodiment 2 of the present invention;

FIG. 28 is a flowchart indicating a procedure of operations performed by the noise removal device according to Embodiment 2 of the present invention;

FIG. 29 is a flowchart indicating Step S1701(j) of determining frequency signals of a to-be-extracted sound; S1701(j) is performed, as one of the operations in the procedure, by the noise removal device according to Embodiment 2 of the present invention;

Each of FIGS. 30 to 32 is a diagram illustrating an exemplary method of modifying phase differences due to time differences;

FIG. 33 is a schematic diagram showing the phases of frequency signals, of a mixed sound, in a time range (predetermined time width) used to calculate phase distances;

FIG. 34 is a schematic diagram showing phases of a mixed sound in a predetermined time width;

FIG. 35 is a diagram illustrating an exemplary method of generating a histogram of phase components of frequency signals;

FIG. 36 is a block diagram showing the overall structure of a vehicle detection device according to Embodiment 3 of the present invention;

FIG. 37 is a block diagram showing a to-be-extracted sound determination unit 4103(j) of the vehicle detection device according to Embodiment 3 of the present invention;

FIG. 38 is a flowchart indicating a procedure of operations performed by the vehicle detection device according to Embodiment 3 of the present invention;

FIG. 39 is a diagram showing an exemplary spectrogram of a mixed sound 2401(1) and a mixed sound 2401(2);

Each of FIGS. 40 and 41 is a diagram illustrating a method of setting a suitable reference frequency f;

FIG. 42 is a diagram showing an example of a result of determining a frequency signal of an engine sound;

FIG. 43 is a diagram illustrating an exemplary method of generating a to-be-extracted sound detection flag;

Each of FIGS. 44 and 45 is a diagram with reference to which a temporal variation in phase is considered;

FIG. 46 is a diagram showing a result of analyzing a temporal variation in phase of a motorbike sound;

FIG. 47 is a diagram showing an example of a result of determining frequency signals of a siren sound;

FIG. 48 is a diagram showing an example of a result of determining frequency signals of a voice;

FIG. 49A is a diagram showing a result of detecting an input sine wave of 100 Hz;

FIG. 49B is a diagram showing a result of detecting an input white noise;

FIG. 49C is a diagram showing a result of detecting a mixed sound including the input sine wave of 100 Hz and the white noise;

FIG. 50A is a diagram showing a result of detecting an input sine wave of 100 Hz;

FIG. 50B is a diagram showing a result of detecting an input white noise;

FIG. 50C is a diagram showing a result of detecting a mixed sound including the input sine wave of 100 Hz and the white noise;

FIG. 51 is a diagram showing the relationships between window functions and the time window widths thereof;

FIG. 52 is a diagram showing exemplary spectrograms of an engine sound, a wind noise, and a mixed sound including the engine sound and the wind noise;

Each of FIGS. 53 to 62 is a diagram showing an example of a result of determining frequency signals of the engine sound, based on the engine sound, the wind noise, and the mixed sound including the engine sound and the wind noise;

FIG. 63 is a diagram showing exemplary spectrograms of a voice, a wind noise, and a mixed sound including the voice and the wind noise;

Each of FIGS. 64 to 67 is a diagram showing an example of a result of determining frequency signals of a voice, based on the sound, the wind noise, and the mixed sound including the voice and the wind noise;

FIG. 68 is a diagram showing exemplary spectrograms of a siren sound, a running sound (frictional noise from tires), and a mixed sound including the siren sound and the running sound (frictional noise from tires); and

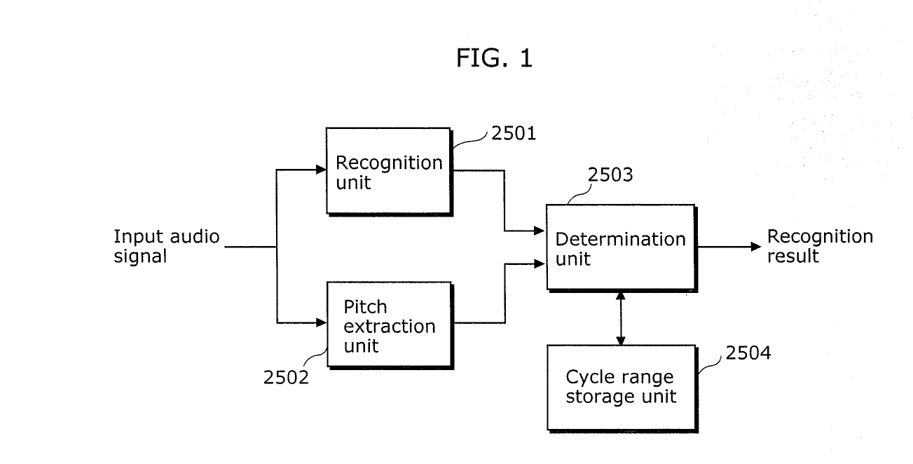

Each of FIGS. 69 to 71 is a diagram showing exemplary spectrograms of a siren sound, a running sound (frictional noise from tires), and a mixed sound including the siren sound and the running sound (frictional noise from tires).

### DESCRIPTION OF THE PREFERRED EMBODIMENTS

A feature of the present invention is to separate toned sounds such as an engine sound, a siren sound, and a voice in distinction from toneless sounds such as a wind noise, a rain sound, and a background noise, using frequency analysis of an input mixed sound made based on whether or not analysis-target frequency signals have a phase that temporally varies at a regular interval of 1/f (f denotes a reference frequency), and determine, for each of reference frequencies f, the frequency signals to be of a toned sound (or a toneless sound) on a per time-frequency domain basis.

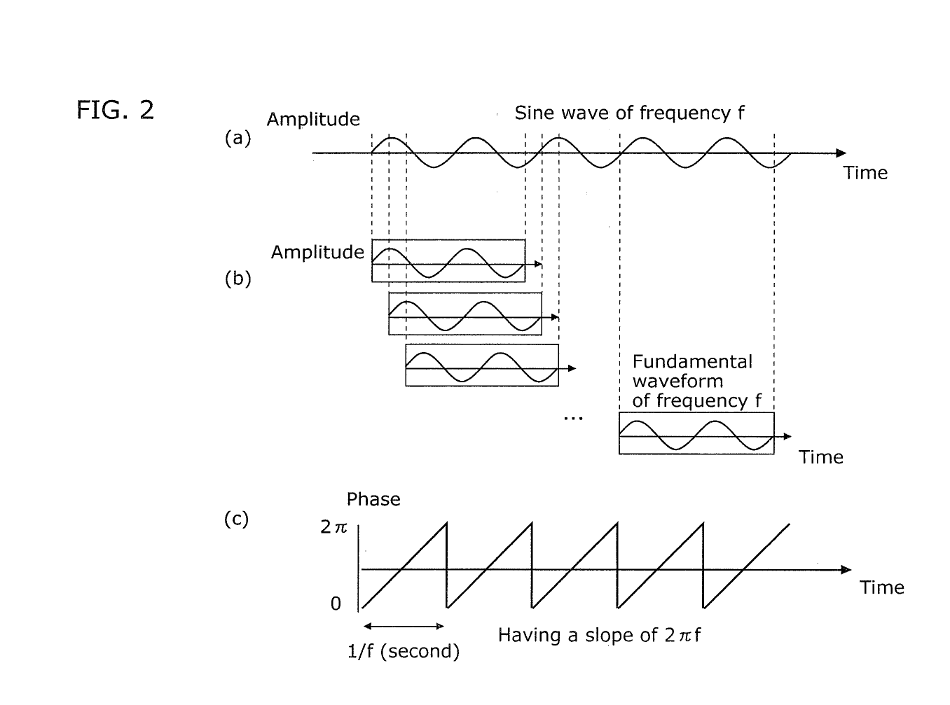

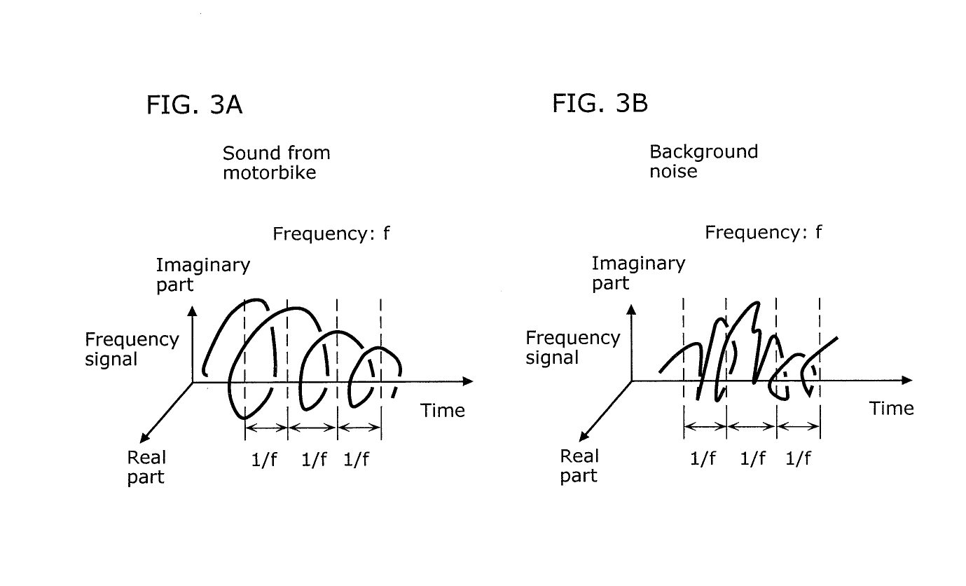

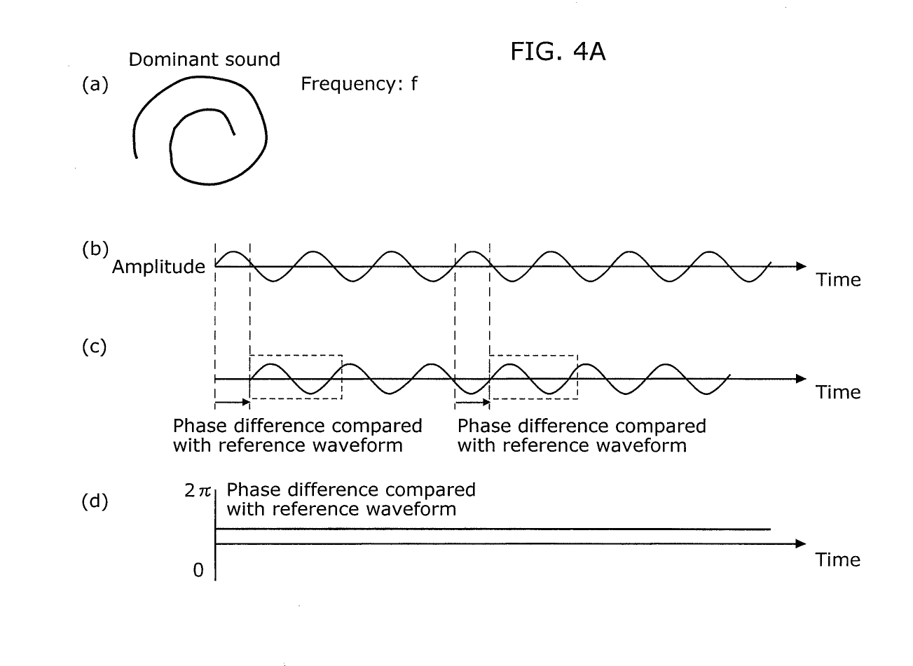

Here, a phase used in the present invention is defined with reference to FIG. 2. FIG. 2(a) shows an input mixed sound. The horizontal axis represents time, and the vertical axis represents amplitude. This example uses a sine wave of a frequency f. In addition, FIG. 2(b) shows a conceptual diagram of a fundamental waveform (a sine wave of a frequency f) selected in the case of performing frequency analysis using discrete Fourier transform. The horizontal and vertical axes are the same as in FIG. 2(a). This fundamental waveform is convoluted into the input mixed sound to determine frequency signals (phases). In this example, frequency signals (phases) at plural time points are calculated by convoluting the fundamental waveform into the mixed sound with shifts in the time axis direction. FIG. 2(c) shows the results obtained through this processing. The horizontal axis represents time, and the vertical axis represents phase. The input mixed sound is a sine wave of a frequency f in this case, and the pattern of the phase at the frequency f is repeated at a regular time cycle of 1/f.

A “phase” in the present invention is defined as a phase calculated with shifts of a fundamental waveform in a time axis direction as shown in FIG. 2. Each of FIGS. 3A and 3B is a conceptual diagram illustrating a feature of the present invention. FIG. 3A is a schematic diagram showing a result of frequency analysis of a motorbike sound (engine sound) performed using a frequency f. FIG. 3B is a schematic diagram showing a result of frequency analysis of a background noise performed using a frequency f. In each diagram, the horizontal axis is the time axis and the vertical axis is the frequency axis. As shown in FIG. 3A, a current phase of a frequency signal shifts at a regular time interval of 1/f (f denotes a reference frequency) and at an equal angle speed of 0 to 2π (radian) while the magnitude of the amplitude (power) of the frequency signal changes due to a temporal variation in frequency. For example, a current phase of a frequency signal of 100 Hz rotates by 2π (radian) in a 10-ms interval, and a current phase of a frequency signal of 200 Hz rotates by 2π (radian) in a 5-ms interval. In contrast, a frequency signal in a toneless sound such as a background noise has a phase that shifts irregularly with time. In addition, a portion distorted due to a mixed-in sound also has a phase that shifts irregularly with time. In this way, it is possible to determine, in a time-frequency domain, a frequency signal having a phase that shifts regularly with time. This makes it possible to determine frequency signals of a toned sound such as an engine sound, a siren sound, and a voice in distinction from toneless sounds such as a wind noise, a rain sound, and a background noise by determining, on a per time-frequency basis, frequency signals having a phase that shifts regularly with time. Alternatively, it is possible to separate a toneless sound from toned sounds and determine frequency signals of the toneless sound.

Here, a description is given of a toned sound and a toneless sound focusing on the relationship between (i) the difference in the properties of the sound sources and (ii) the phases.

FIG. 4A(a) is a schematic diagram showing phases of a toned sound having a frequency f (examples of toned sounds include an engine sound, a siren sound, a voice, and a sine wave). FIG. 4A(b) is a diagram showing a reference waveform of a frequency f. FIG. 4A(c) is a diagram showing a dominant audio waveform of a toned sound having a frequency f. FIG. 4A(d) is a diagram showing a phase difference from the reference waveform. More specifically, FIG. 4A(b) is a diagram showing a phase difference of an audio waveform from the reference waveform shown in FIG. 4A(b).

FIG. 4B(a) is a schematic diagram of phases of toneless sounds having a frequency f (examples of toneless sounds include a background noise, a wind noise, a rain sound, and a white noise). FIG. 4B(b) is a diagram showing a reference waveform of a frequency f. FIG. 4B(c) is a diagram showing audio waveforms of toneless sounds (sounds A to C) having a frequency f. FIG. 4B(d) is a diagram showing phase differences from a reference waveform. More specifically, FIG. 4B(b) is a diagram showing phase differences of an audio waveform shown in FIG. 4B(c) from the reference waveform shown in FIG. 4B(b).

As shown in FIG. 4A(a) and 4 A(c), a toned sound (an engine sound, a siren sound, a voice, a sine wave, or the like) has, at a frequency f, an audio waveform in which a sine wave having a frequency f is dominant. On the other hand, a toneless sound (a background noise, a wind noise, a rain sound, a white noise, or the like) has, at a frequency f, an audio waveform in which plural sine waves having a frequency f are mixed.

Here, a description is given of the reason why a toneless sound shows plural waveforms.

In the case of a background noise, this is because the background noise contains plural distant sounds (having the same frequency) overlapped with each other in a short time segment (in the order of several hundred milliseconds or below).

In the case of a wind noise generated due to turbulence, this is also because, the wind noise contains plural spiral sounds (having the same frequency band) overlapped with each other in a short time segment (in the order of several hundred milliseconds or below).

In the case of a rain sound, the rain sound contains plural rain drop sounds (having the same frequency band) overlapped with each other in a short time segment (in the order of several hundred milliseconds or below).

In each of FIGS. 4A(c) and FIG. 4B(c), the horizontal axis represents time, and the vertical axis represents amplitude.

First, phases of a toned sound are considered with reference to FIG. 4A(b) to 4A(d). Here, a sine wave of a frequency f as shown in FIG. 4A(b) is prepared as a reference waveform. The horizontal axis represents time, and the vertical axis represents amplitude. This reference waveform is a constant waveform obtained from a fundamental waveform in discrete Fourier transform as shown in FIG. 2(b) without shifting the fundamental waveform in the time axis direction. FIG. 4A(c) is a dominant audio waveform at a frequency f of a toned sound. FIG. 4A(d) shows the phase difference between the reference waveform shown in FIG. 4A(b) and the audio waveform shown in FIG. 4A(c). As clear from FIG. 4A(d), the toned sound has a phase that slightly fluctuates with time, making small differences in phases between its dominant audio waveform shown in FIG. 4A(c) and the reference waveform shown in FIG. 4A(b). Here, considering the relationship with a phase defined in the present invention, the phase is represented as a value obtained by adding, to the phase difference shown in FIG. 4A(d), a phase increment of 2πft made in the case where the fundamental waveform shown in FIG. 2(b) shifts by t in the time axis direction. A toned sound has an approximately constant value as the phase difference as shown in FIG. 4A(d). For this, a phase pattern obtained by adding 2πft to a phase difference in the present invention is repeated at a regular time cycle of 1/f as shown in FIG. 2(c).

Next, phases of a toneless sound are considered with reference to FIG. 4B(b) to 4B(d). Here, a sine wave of a frequency f as shown in FIG. 4B(b) is prepared as a reference waveform, as in the case of using FIG. 4A(b). The horizontal axis represents time, and the vertical axis represents amplitude. FIG. 4B(c) shows audio waveforms of plural mixed sine waves (of sounds A to C) at a frequency f of a toneless sound. These audio waveforms are mixed at a short time interval in the order of several hundred milliseconds or below. FIG. 4B(d) shows phase differences between the reference waveform shown in FIG. 4B(b) and the waveforms of mixed sounds shown in FIG. 4B(c). At the starting time point in FIG. 4B(d), the phase difference of a sound A appears because the amplitude of the sound A is greater than those of sounds B and C. At the middle time point, the phase difference of the sound B appears because the amplitude of the sound B is greater than those of the sounds A and C. At the ending time point, the phase difference of the sound C appears because the amplitude of the sound C is greater than those of the sounds A and B. In this way, the toneless sound has a phase that significantly fluctuates with time, making small differences in phases between its audio waveforms of plural sounds shown in FIG. 4B(c) and the reference waveform shown in FIG. 4B(b), at a short time interval in the order of several hundred millisecond or below. Here, considering the relationship with a phase defined in the present invention, the phase is represented as a value obtained by adding, to the phase difference shown in FIG. 4B(d), a phase increment of 2πft made in the case where the fundamental waveform shown in FIG. 2(b) shifts by t in the time axis direction. For this, a phase pattern of a toneless sound in the present invention is not repeated at a regular time cycle of 1/f.

In this way, it is possible to calculate a phase distance based on the magnitudes of temporal fluctuations in the phase difference from the reference waveform as shown in FIGS. 4A(d) to 4B(d), and determine a toned sound and/or a toneless sound. In addition, it is possible to calculate a phase distance based on a shift from a time waveform having a phase that cyclically shifts at a 1/f (f denotes a reference frequency) interval, using the phase obtained, in the present invention, with shifts of the fundamental waveform as shown in FIG. 2(c) in the time axis direction, and to determine a toned sound and/or a toneless sound. Each of these specific methods involves determining a toned sound and/or a toneless sound, based on a phase distance that is the distance between phases expressed by the expression ψ′(t)=mod 2π(ψ(t)−2πft)=ψ(t) (here, f denotes a reference frequency).

Further, there is a difference in the degrees of regularity in the temporal phase variations between (i) a sound such as a siren sound that sounds mechanical and is similar to a sine wave and (ii) a sound such as a motorbike sound (engine sound) that is physically mechanical.

For this, the degrees of regularity in the temporal phase variations are represented using the following expression:

Sine wave>siren sound>motorbike sound (engine sound)>background noise [Expression 1]

Accordingly, the determination of the degrees of regularity in temporal phase variations is only a requirement for determining a frequency signal of a motorbike sound, from a mixed sound containing a siren sound, the motorbike sound, and a background noise.

In addition, in the present invention, the use of phase distances makes it possible to determine frequency signals of a to-be-extracted sound irrespective of the relationship between the frequency signal power of a noise and that of the to-be-extracted sound. For example, even in the case where the frequency signal power of a noise is great in a certain time-frequency domain, the use of this regularity in the phases makes it possible to determine frequency signals that represent the to-be-extracted sound and has, in a time-frequency domain, a power greater than that of the noise, and also determine even frequency signals that represent the to-be-extracted sound and has, in a time-frequency domain, a power smaller than that of the noise.

Hereinafter, embodiments of the present invention are described with reference to the drawings.

### Embodiment 1

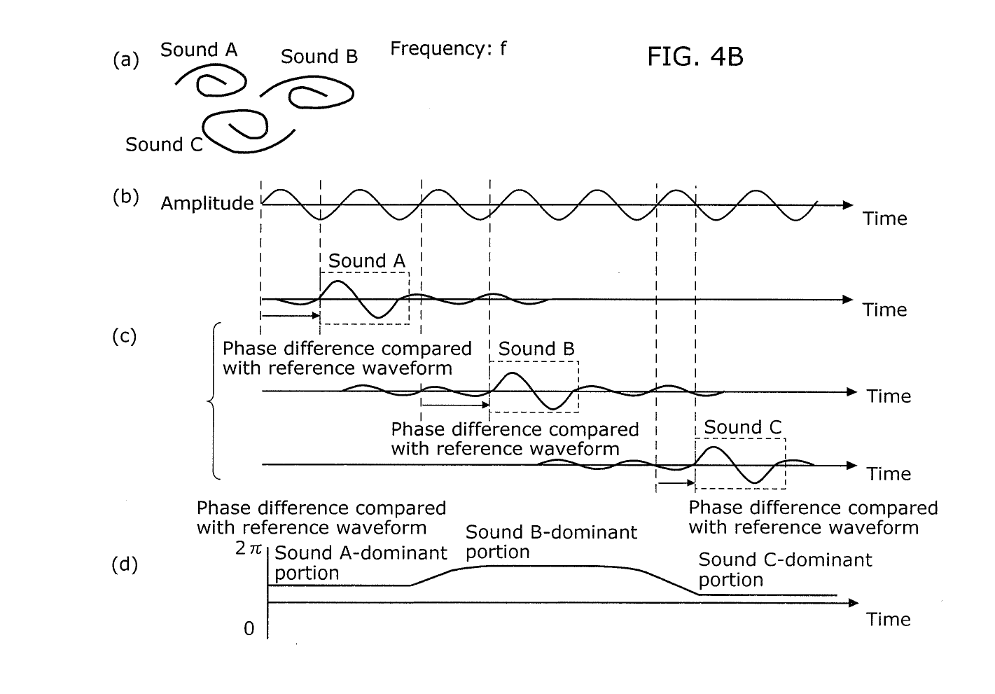

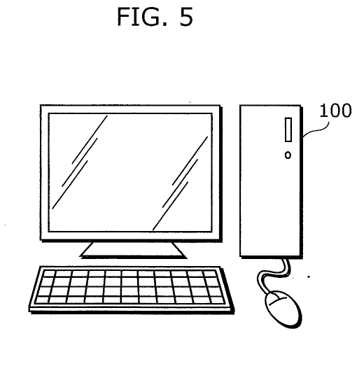

FIG. 5 is an external view of a noise removal device according to Embodiment 1 of the present invention,. A noise removal device 100 includes a frequency analysis unit, a to-be-extracted sound determination unit, and a sound extraction unit, and is operated by executing a program for causing a CPU that is one of the components of a computer to execute the functions of these processing units. Various intermediate data, data indicating execution results, and the like are stored in a memory.

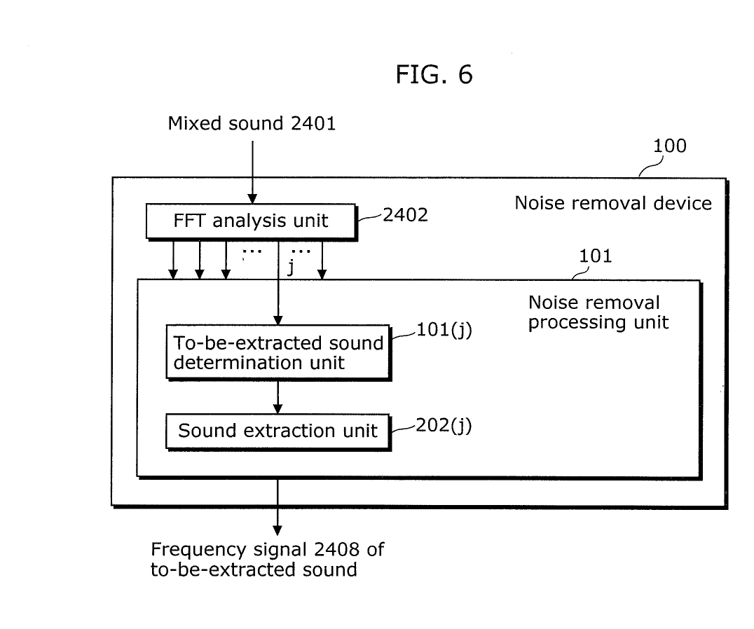

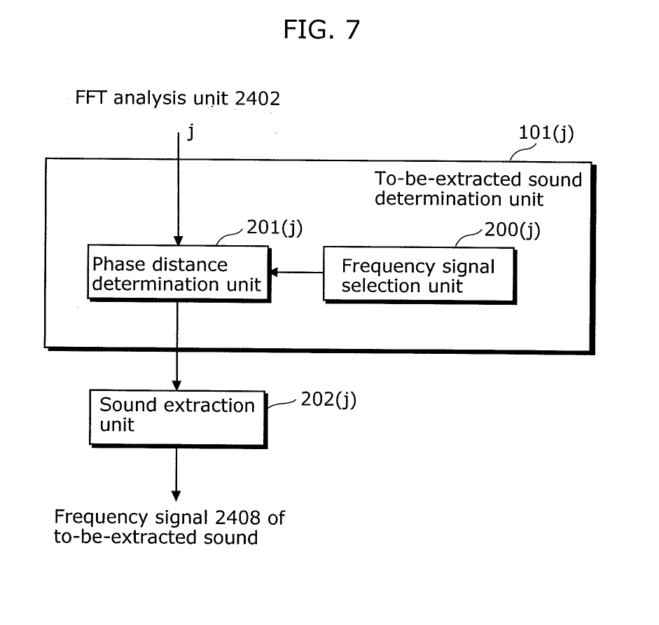

Each of FIG. 6 and FIG. 7 is a block diagram showing the structure of the noise removal device according to Embodiment 1 of the present invention.

In FIG. 6, the noise removal device 100 includes an FFT analysis unit 2402 (the frequency analysis unit) and a noise removal processing unit 101 (including the to-be-extracted sound determination unit and the sound extraction unit). The FFT analysis unit 2402 and the noise removal processing unit 101 are operated by executing a program causing a computer to execute the functions of the respective processing units.

The FFT analysis unit 2402 is a processing unit that performs fast Fourier transform on an input mixed sound 2401 to determine frequency signals of the mixed sound 2401. At this time, the frequency signals of the mixed sound 2401 are determined by multiplexing the mixed sound 2401 by a window function having a predetermined time window width. Hereinafter, it is assumed that the number of frequency bands of each of the frequency signals determined by the FFT analysis unit 2402 is denoted as M, and that the numbers specifying the respective frequency bands are denoted as j (j=1 to M).

The noise removal processing unit 101 includes a to-be-extracted sound determination unit 101(j) (j=1 to M) and a sound extraction unit 202(j) (j=1 to M). The noise removal processing unit 101 is a processing unit that removes noises from the frequency signals determined by the FFT analysis unit 2402 by extracting the frequency signals of the to-be-extracted sound from the mixed sound, on a per frequency band j (j =1 to M) basis, using the to-be-extracted sound determination unit 101(j) (j=1 to M) and the sound extraction unit 202(j) (j=1 to M).

The to-be-extracted sound determination unit 101(j) (j=1 to M) calculates, using the frequency signals at plural time points that are selected from among the time points at a 1/f (f denotes a reference frequency) time interval in a predetermined time width, phase distances between a frequency signal at a current time point for analysis and frequency signals at time points different from the current time point for analysis. At this time, the number of frequency signals used to calculate phase distances is equal to or exceeds a first threshold value. In addition, each of the phase distances is of the frequency signal when the phase of the frequency signal at a current time point t is ψ(radian), and that the phase is represented using the expression ψ′(t)=mod 2π(ψ(t)−2πft) (here, f denotes a reference frequency). In addition, the time length corresponding to the predetermined time width is set to be within a range of 2 to 4 times the time window width of the window function. The frequency signals at the time points for analysis at which their phase distances are equal to or smaller than a second threshold value are determined to be frequency signals 2408 of the to-be-extracted sound.

Lastly, the sound extraction unit 202(j) (j=1 to M) removes noises from the mixed sound by extracting the frequency signals 2408, of the to-be-extracted sound, determined by the to-be-extracted sound determination unit 101(j) (j=1 to M).

Performing this processing at sequentially-shifted time points having a predetermined time width makes it possible to extract the frequency signals 2408 of the to-be-extracted sound on a per time-frequency domain basis. FIG. 7 is a block diagram showing the structure of the to-be-extracted sound determination unit 101(j) (j=1 to M).

The to-be-extracted sound determination unit 101(j) (j=1 to M) includes a frequency signal selection unit 200(j) (j=1 to M) and a phase distance determination unit 201(j) (j=1 to M).

The frequency signal selection unit 200(j) (j=1 to M) is a processing unit that selects, as frequency signals to be used to calculate phase distances, frequency signals equal to or greater than the first threshold value in number from among the frequency signals having a predetermined time width. At this time, the time length corresponding to the predetermined time width is set to be within a range from 2 to 4 times the time window width of the window function. The phase distance determination unit 201(j) (j=1 to M) is a processing unit that calculates the phase distances using the phases of the frequency signals selected by the frequency signal selection unit 200(j) (j=1 to M), and determines the frequency signals that yield a phase distance equal to or smaller than the second threshold value to be frequency signals 2408 of the to-be-extracted sound.

Next, a description is given of operations performed by the noise removal device 100 configured as described above.

The following describes processing performed on an i-th frequency band. The same processing as described below is performed on the other frequency bands. Here, a description is given of an exemplary case where the center frequency of the frequency band matches the reference frequency (frequency f according to the expression ψ′(t)=mod 2π(ψ(t)−2πft) used to calculate the phase distance. In this case, it is possible to determine whether or not the to-be-extracted sound is present in the frequency f. Another method may be used to determine frequency signals of the to-be-extracted sound assuming that plural frequencies including the frequency band are the reference frequencies. In this case, it is possible to determine whether or not a to-be-extracted sound is present in the frequency around the center frequency.

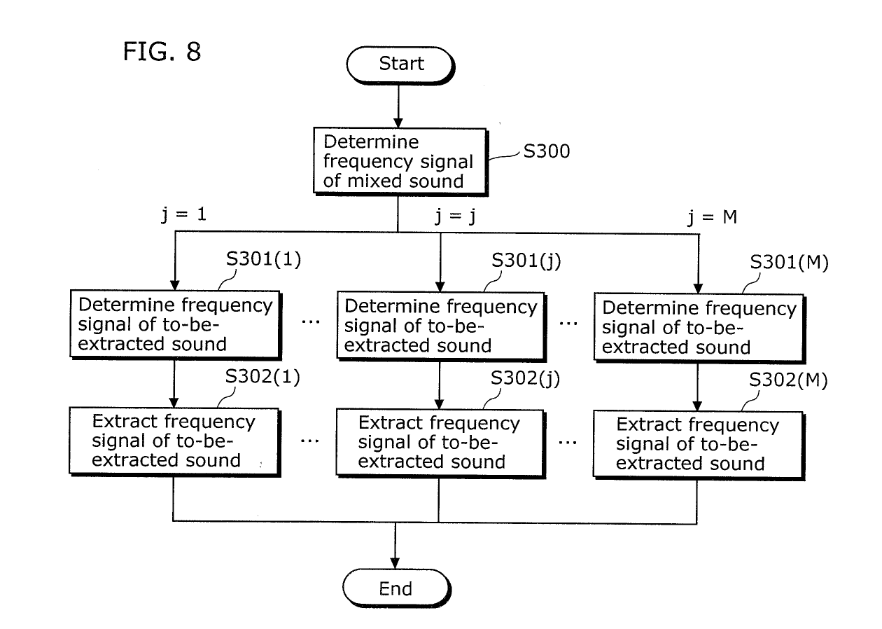

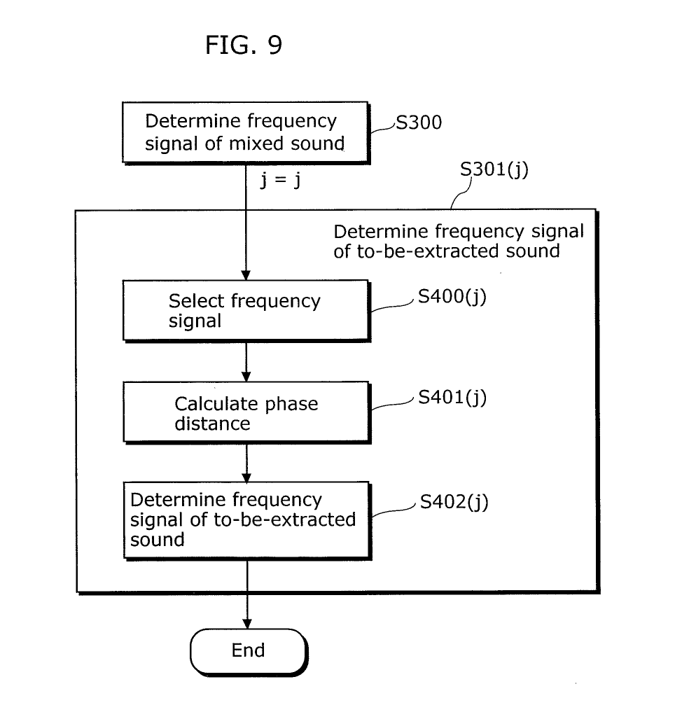

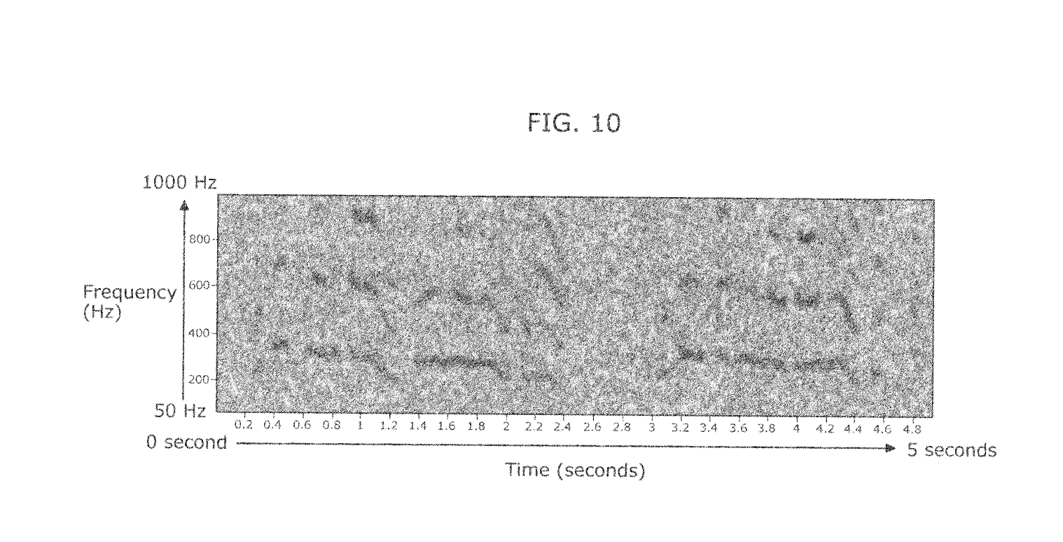

Each of FIG. 8 and FIG. 9 is a flowchart indicating a procedure of operations performed by the noise removal device 100.

Here, a description is given of taking an exemplary case of using, as the mixed sound 2401, a mixed sound including a voice (voiced sound) and a white noise (the mixed sound is generated by mixing the voice and the white noise on a computer). In this example, the object is to extract frequency signals of the voice (toned sound) by removing the white noise (toneless sound) from the mixed sound 2401.

FIG. 10 shows an exemplary spectrogram of the mixed sound 2401 as a mixture of the voice and the white noise. The horizontal axis is the time axis, and the vertical axis is the frequency axis. The power of a frequency signal is represented using color contrast, and specifically, a dark color shows a frequency signal portion in which the power is great. The spectrogram represented here is at 0 to 5 second portion of the frequency range from 50 to 1000 Hz. In the presentation, the phase components of the frequency signal are not shown

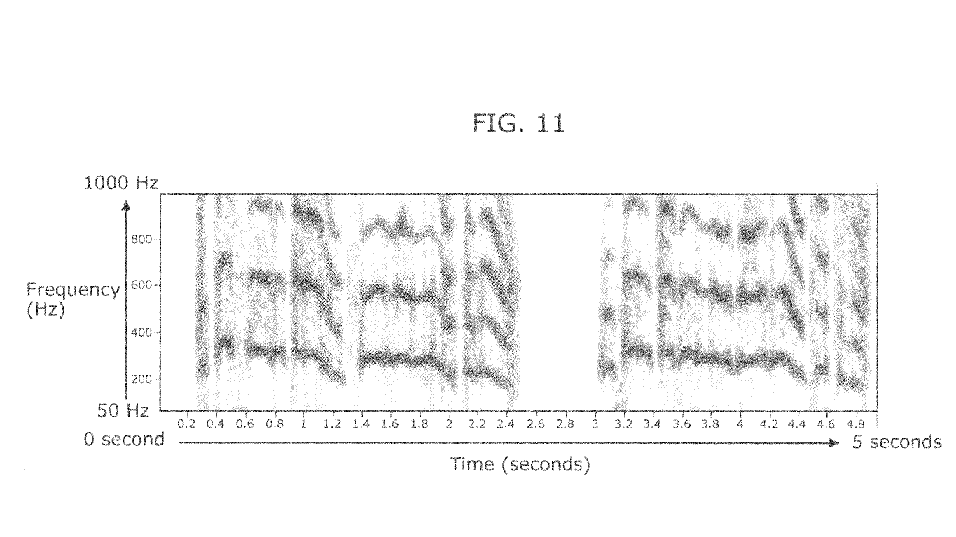

FIG. 11 shows a spectrogram of the voice used to generate the mixed sound 2401 shown in FIG. 10. The way of presentation is the same as in FIG. 10, and thus no detailed description thereof is repeated.

As shown in FIGS. 10 and 11, the voice of the mixed sound 2401 can be observed only in the frequency signal portion in which the power is great. As clear from this, the harmonic structure of the voice is partially lost.

First, the FFT analysis unit 2402 performs fast Fourier transform on the input mixed sound 2401 to determine the frequency signal of the mixed sound 2401 (Step S300). The frequency signal obtained using fast Fourier transform in this example is on complex space. A condition for fast Fourier transform in this example is to process the mixed sound 2401 sampled at a sampling frequency of 16000 Hz using a Hanning window having a time window width of ΔT=64 ms (1024 pt). In addition, the frequency signals at the respective time points are calculated with time shifts of 1 pt (0.0625 ms) in the time axis direction. FIG. 10 shows the frequency signal powers as the processing results.

Next, the noise removal processing unit 101 causes its to-be-extracted sound determination unit 101(j) to determine the frequency signal of each time-frequency domain of the mixed sound, on a per frequency band basis, using the frequency signals calculated by the FFT analysis unit 2402. Subsequently, the noise removal processing unit 101 removes noises by causing its sound extraction unit 202(j) to extract the frequency signal, of the to-be-extracted sound, determined by the to-be-extracted sound determination unit 101(j) (Step S302(j)). The following describes processing performed on i-th frequency band. The same processing is performed on the other frequency bands. In this example, the center frequency of the i-th frequency band is f.

The to-be-extracted sound determination unit 101(j) calculates a phase distance between a frequency signal at a current time point for analysis and frequency signals at all the time points other than the current time point for analysis, using the frequency signals at all the time points having a time interval of 1/f in a predetermined time width within a range from 2 to 4 times the time window width of the window function (Hanning window) (here, the predetermined time width is 192 ms that is 3 times the time window width). Here, a value used as the first threshold value corresponds to 30 percent of the number of frequency signals having a 1/f time interval included in the predetermined time width. Thus, in this example, phase distances are calculated using all the frequency signals included in the predetermined time width when the number of frequency signals having a 1/f time interval included in the predetermined time width is equal to or greater than the first threshold value. The frequency signals at the time points for analysis at which their phase distances are equal to or smaller than the second threshold value are determined to be frequency signals 2408 of the to-be-extracted sound (Step S301(j)). Lastly, the sound extraction unit 202(j) removes noises by causing its to-be-extracted sound determination unit 101(j) to extract the frequency signals determined to be the frequency signals of the to-be-extracted sound (Step S302(j)). Here, a description is given of a case of using a frequency f of 500 Hz.

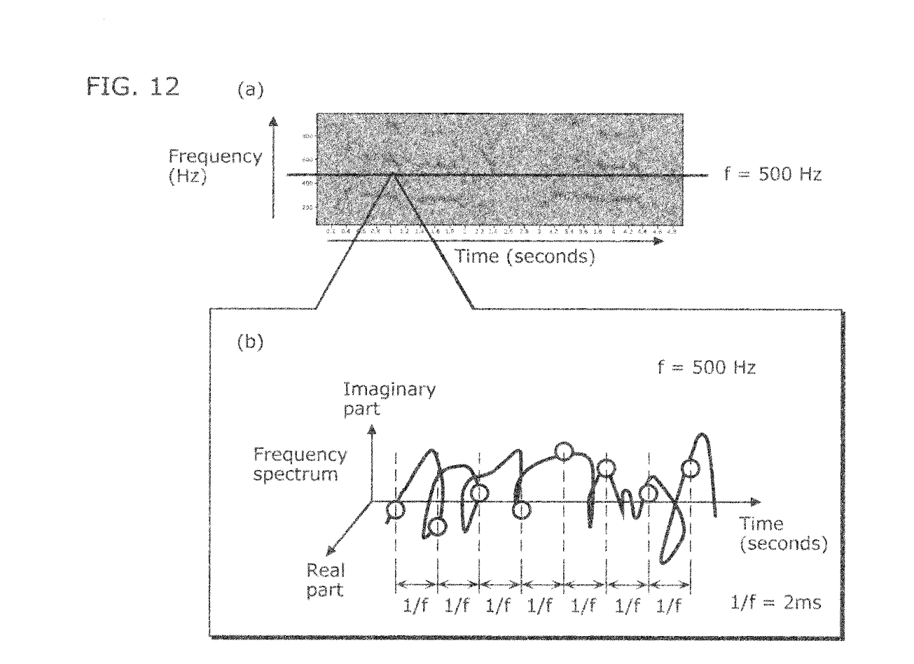

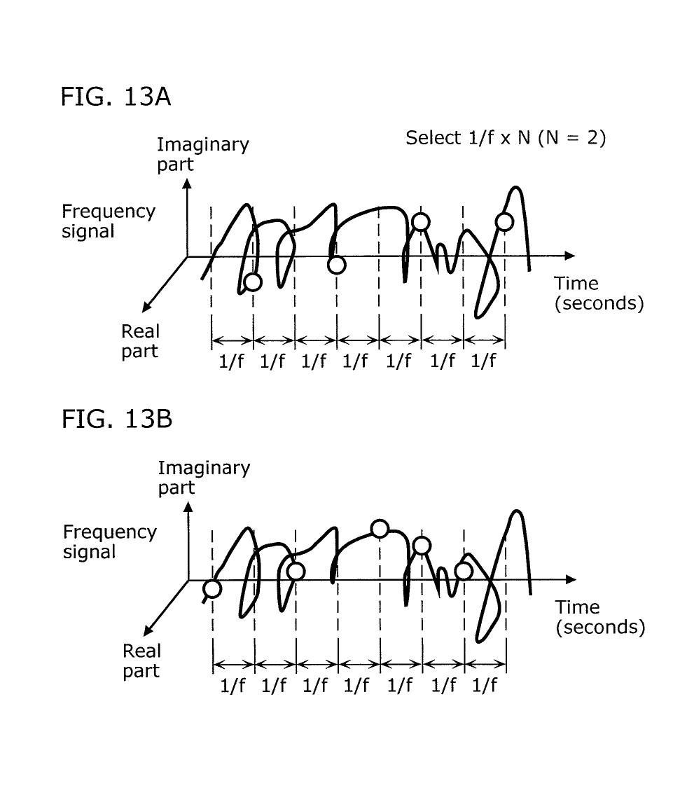

FIG. 12(b) schematically shows a frequency signal at 500 Hz in the mixed sound 2401 shown in FIG. 12(a). FIG. 12(a) is the same as FIG. 10. In FIG. 12(b), the horizontal axis is the time axis, and the two axes in the vertical plane represent the real part and imaginary part of the frequency signal. In this example, 1/f is 2 ms because the frequency f is 500 Hz.

First, the frequency signal selection unit 200(j) selects, in number equal to or greater than the first threshold value, all frequency signals having a 1/f time interval in a predetermined time width (3 times the time window width of the window function) (Step S400(j)). This threshold is placed because it is difficult to determine regularity of a temporal variation in phase when the number of frequency signals selected to calculate the phase distance is not sufficient. FIG. 12(b) shows, using open circles, the positions of frequency signals selected at a 1/f time interval. Here, as shown in FIG. 12(b), all the frequency signals are selected at the respective time points at a time interval of 1/f corresponding to 2 ms.

Here, each of FIGS. 13A and 13B shows another method of selecting frequency signals. The way of presentation is the same as in FIG. 12(b), and thus no detailed description thereof is repeated. FIG. 13A shows an example of selecting frequency signals at time points at a time interval obtained according to an expression 1/f×N (N=2) from among the time points at a 1/f time interval. In addition, FIG. 13B shows an example of selecting frequency signals at time points selected at random from among the time points at a 1/f time interval. In other words, the method of selecting frequency signals may be any other methods of selecting frequency signals obtainable at time points at a 1/f time interval. It should be noted that the number of frequency signals to be selected needs to be equal to or greater than the first threshold value.

Here, the frequency signal selection unit 200(j) sets a time range (predetermined time width), of the frequency signal, which the phase distance determination unit 201(j) uses to calculate the phase distance. The method of setting the time range is described later together with a description given of the phase distance determination unit 201(j).

Next, the phase distance determination unit 201(j) calculates the phase distance, using all the frequency signals selected by the frequency signal selection unit 200(j) (Step S401(j)). The phase distance used here is an inverse of a cross-correlation value between frequency signals normalized by signal power.

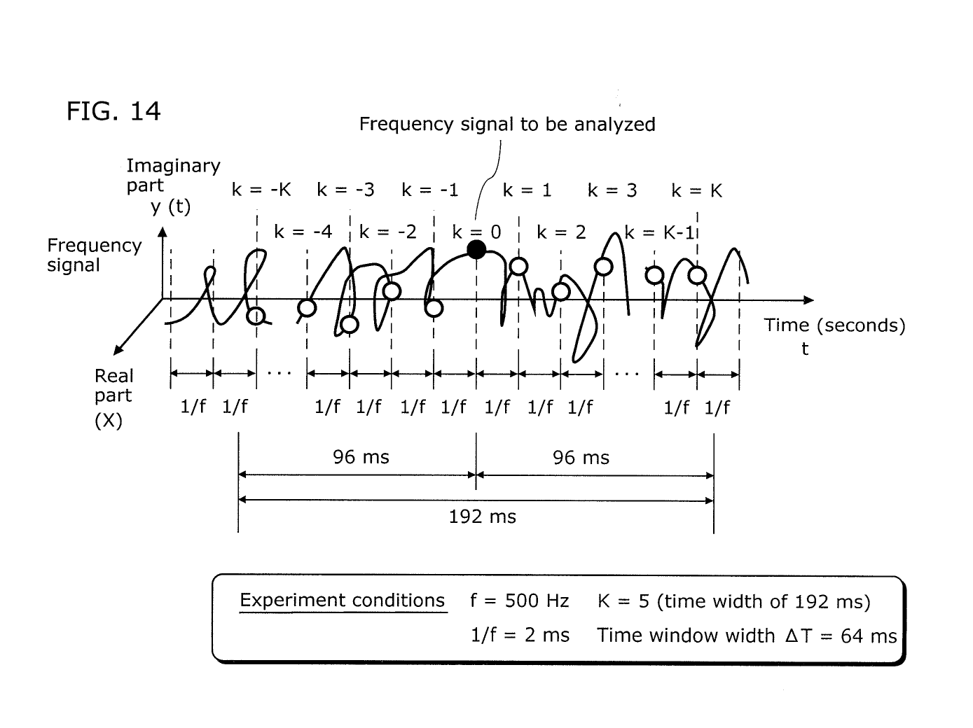

FIG. 14 shows an example of how to calculate a phase distance. With regard to the presentation in FIG. 14, the same description given of FIG. 12(b) is not repeated. In FIG. 14, a filled circle denotes a frequency signal at a current time point for analysis, and open circles denote frequency signals selected at time points other than the current time point for analysis.

In this case, the frequency signals used to calculate phase distances with a current analysis-target frequency signal are the frequency signals at the time points (denoted by the open circles) other than the current time point for analysis in all the time points having a 1/f (corresponding to 2 ms) time interval included in a time range within ±96 ms (the predetermined time width is 192 ms) from the current time point (denoted by the filled circle) for analysis. Here, the time length corresponding to the predetermined time width is shown by a value experimentally determined from the characteristics of the voice that is the to-be-extracted sound.

Here, the method of calculating the phase distance is described below. In this example, the frequency signals of a 1/f time interval are used to calculate phase distances.

The following represents the real part of a frequency signal.

xₖ(k=−K, . . . ,−2,−1,0,1,2, . . . , K) [Expression 2]

The following represents the imaginary part of the frequency signal.

yₖ(k=−K, . . . ,−2,−1,0,1,2, . . . , K) [Expression 3]

Here, a symbol k is a number specifying the frequency signal. The frequency signal represented as k=0 is the frequency signal at the current time point for analysis. The frequency signals represented as k (k=−K, . . . , −2, −1, 1, 2, . . . , K) other than 0 are the frequency signals used to calculate the phase distances with the current frequency signal at the current time point for analysis (See FIG. 14).

Here, in order to calculate a phase distance, the frequency signals normalized by signal power are calculated.

The following represents the value obtained by normalizing the real part of a frequency signal using signal power.

$${x}_{k}^{′} = \frac{{x}_{k}}{\sqrt{{( {x}_{k} )}^{2} + {( {y}_{k} )}^{2}}} \\ ( k = - K , … , - 2 , - 1 , 0 , 1 , 2 , … , K ) \qquad [ Expression 4 ]$$

The following represents the value obtained by normalizing the imaginary part of the frequency signal using signal power.

$${y}_{k}^{′} = \frac{{y}_{k}}{\sqrt{{( {x}_{k} )}^{2} + {( {y}_{k} )}^{2}}} \\ ( k = - K , … , - 2 , - 1 , 0 , 1 , 2 , … , K ) \qquad [ Expression 5 ]$$

The phase distance S is calculated using the following.

S=1/(Σ_{k=-K}^{k=1}(x′₀×x′ₖ+y′₀×y′ₖ)+Σₖ₌₁^{k=K}(x′₀×x′ₖ+y′₀×y′ₖ)+α) [Expression 6]

Here, the phase of the frequency signal is expressed by the expression ψ′(t)=mod 2π(ψ(t)−2πft)=ψ(t), and thus it is possible to calculate the phase distance using the frequency signal directly.

Other methods of calculating phase distances S are indicated below. One is a method using normalization by the total number of frequency signals in a cross-correlation calculation according to the following expression.

S=1/(1/2K(Σ_{k=-K}^{k=1}(x′₀×x′ₖ+y′₀×y′ₖ)+Σₖ₌₁^{k=K}(x′₀×x′ₖ+y′₀×y′ₖ))+α) [Expression 7]

Another is a method of further adding a phase distance between frequency signals at time points for analysis according to the following expression.

S=1/(Σ_{k=-K}^{k=K}(x′₀×x′ₖ+y′₀×y′ₖ)+α) [Expression 8]

Another is a method using a difference error of a frequency signal according to the following expression.

S=1/2K+1Σ_{k=-K}^{k=K}\sqrt{(x′₀−x′ₖ)²+(y′₀−y′ₖ)²} [Expression 9]

Another is a method using a difference error of a phase according to the following expression.

$$\begin{matrix}S = 1 / 2 K + 1 {\sum }_{k = - K}^{k = K} \vert mod 2 π ( arctan ( {y}_{0} / {x}_{0} ) ) - \\ mod 2 π ( arctan ( {y}_{k} / {x}_{k} ) ) \vert \\ = 1 / 2 K + 1 {\sum }_{k = - K}^{k = K} \vert ϕ ( 0 ) - ϕ ( k ) \vert\end{matrix} \qquad [ Expression 10 ]$$

Another is a method using a value of phase variance. According to the expression ψ′(t)=mod 2π(ψ(t)−2πft)=ψ(t), it is possible to easily calculate the phase distance.

Here, α in Expressions 6 to 8 is a small value predetermined in order to prevent infinite divergence of S.

α [Expression 11]

It is also good to calculate a phase distance considering that the phase values are in a torus (that is, 0 (radian) and 2π (radian) are the same). For example, in the case of calculating a phase distance using the phase difference error shown in Expression 10, it is also good to calculate a phase distance using the following right term.

|mod 2π(arctan(y₀/x₀))−mod 2π(arctan(yₖ/xₖ))|≡min{51 mod 2π(arctan(y₀/x₀))−mod 2π(arctan(yₖ/xₖ))|, |mod 2π(arctan(y₀/x₀))−(mod 2π(arctan(yₖ/xₖ))+2π)|, |mod 2π(arctan(y₀/x₀))−(mod 2π(arctan(yₖ/xₖ))−2π)|} Expression 12]

Next, the phase distance determination unit 201(j) determines, to be a frequency signal 2408 of the to-be-extracted sound (voice), each of the analysis-target frequency signals having a phase distance equal to or smaller than the second threshold value (Step S402(j)). The second threshold value is set to a value experimentally determined based on the phase distance between the voice and a white noise included in a 192-ms time width (the predetermined time width). These processes are performed on all the analysis-target frequency signals at the time points calculated with time shifts of 1 pt (0.0625 ms) in the time axis direction.

Lastly, the sound extraction unit 202(j) removes noises by causing its to-be-extracted sound determination unit 101(j) to extract the frequency signals determined to be frequency signals 2408 of the to-be-extracted sound.

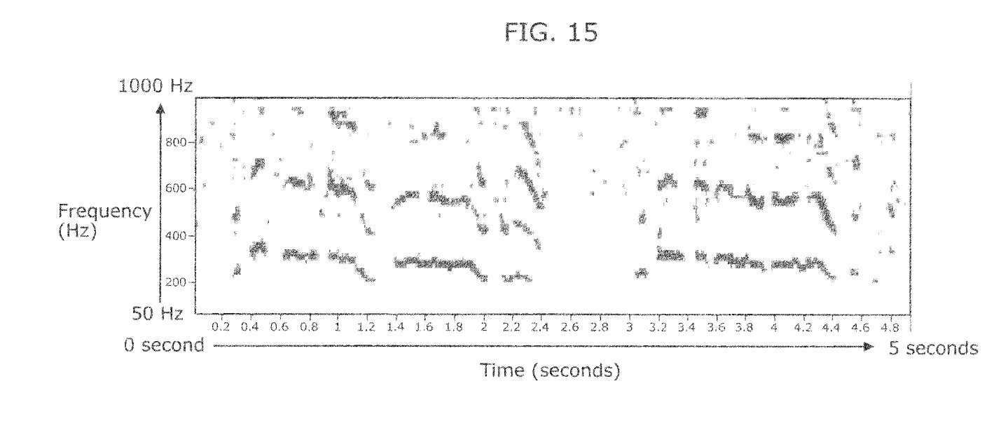

FIG. 15 shows an exemplary spectrogram of the voice extracted from the mixed sound 2401 shown in FIG. 10. The way of presentation is the same as in FIG. 10, and thus no detailed description thereof is repeated. As clear from this, the frequency signal of the voice has been extracted from the mixed sound having a partially-lost harmonic structure.

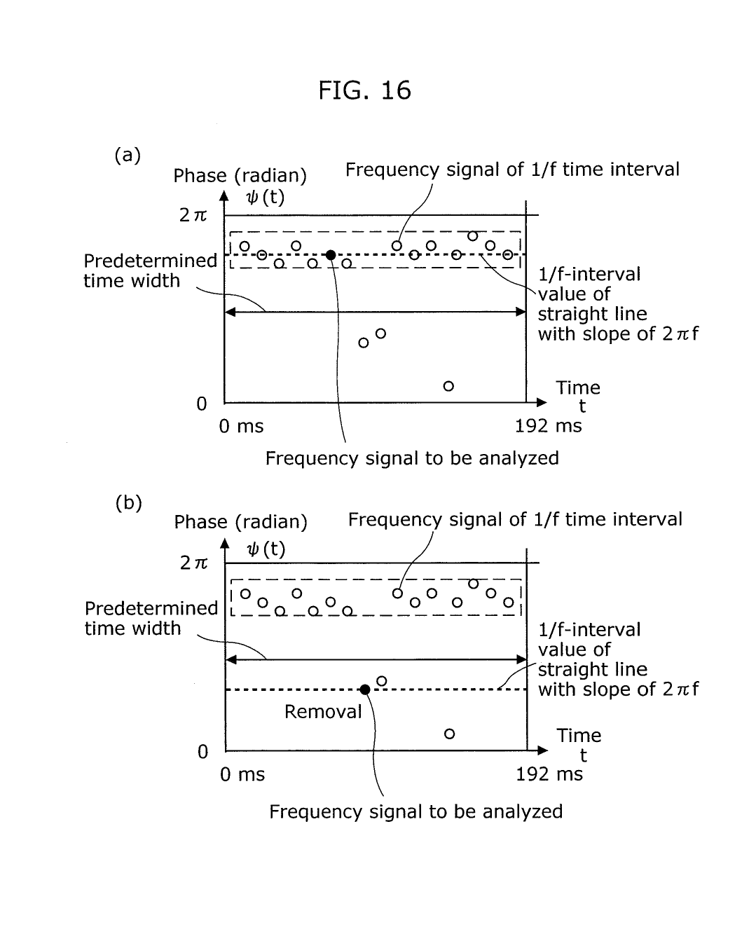

Here, a consideration is given of the phase of a frequency signal to be removed as a noise. Here, the second threshold value is set to π/2 (radian). FIG. 16 is a schematic diagram showing the phases of frequency signals, of the mixed sound, in a predetermined time width used to calculate phase distances. The horizontal axis is the time axis, and the vertical axis is the phase axis. Each of the filled circles shows a current phase of the analysis-target frequency signal, and each open circle shows a current phase of the frequency signal used to calculate the phase distance from the phase of the frequency signal marked with the corresponding filled circle. Here, the phases of the frequency signals are shown at a 1/f time interval. As shown in FIG. 16(a), calculating a phase distance at ψ′(t) according to the expression ψ′(t)=mod 2π(ψ(t)−2πft) (here, f denotes a reference frequency) is equivalent to calculating a distance, at ψ(t), from a straight line that passes through the phase ψ(t) of the analysis-target frequency signal with a slope of 2πf with respect to time t (the straight line having a 1/f time interval is horizontal with respect to the time axis). In FIG. 16(a), the phases of the frequency signals are present near this straight line. Therefore, the phase distances with the frequency signals in number equal to or greater than the first threshold value are equal to or smaller than the second threshold value, and the analysis-target frequency signal is determined to be of a frequency signal of the to-be-extracted sound. In addition, as shown in FIG. 16(b), when there is almost no frequency signals near the straight line that passes through the analysis-target frequency signal with a slope of 2πf with respect to time, the phase distances with the frequency signals in number equal to or greater than the first threshold value are greater than the second threshold value, and the analysis-target frequency signal is removed as a noise without being determined to be a frequency signal of the to-be-extracted sound.

With this structure, it is possible to separate toned sounds such as an engine sound, a siren sound, and a voice in distinction from toneless sounds such as a wind noise, a rain sound, and a background noise on a per time-frequency domain basis, using the phase distances ψ′(t) according to the expression ψ′(t)mod2π(ψ(t)−2πft) (here, f denotes a reference frequency) when the phase of the frequency signal at the current time point t is ψ(t) (radian). In addition, it is possible to determine frequency signals of a toned sound (or a toneless sound).

In addition, the phase distance of a frequency signal at a 1/f time interval can be easily calculated using the expression ψ′(t)=mod 2π(ψ)(t)−2πft)=ψ(t) (here, f denotes a reference frequency).

Here, a description is given of a phase distance according to the expression ψ′(t)=mod 2π(ψ(t)−2πft)=ψ(t) (here, f denotes a reference frequency). As described with reference to FIG. 3A, the frequency signal (having frequency components) of a toned sound has a regular equal angle speed in a predetermined time width and rotates by 2π (radian) at a 1/f time interval.

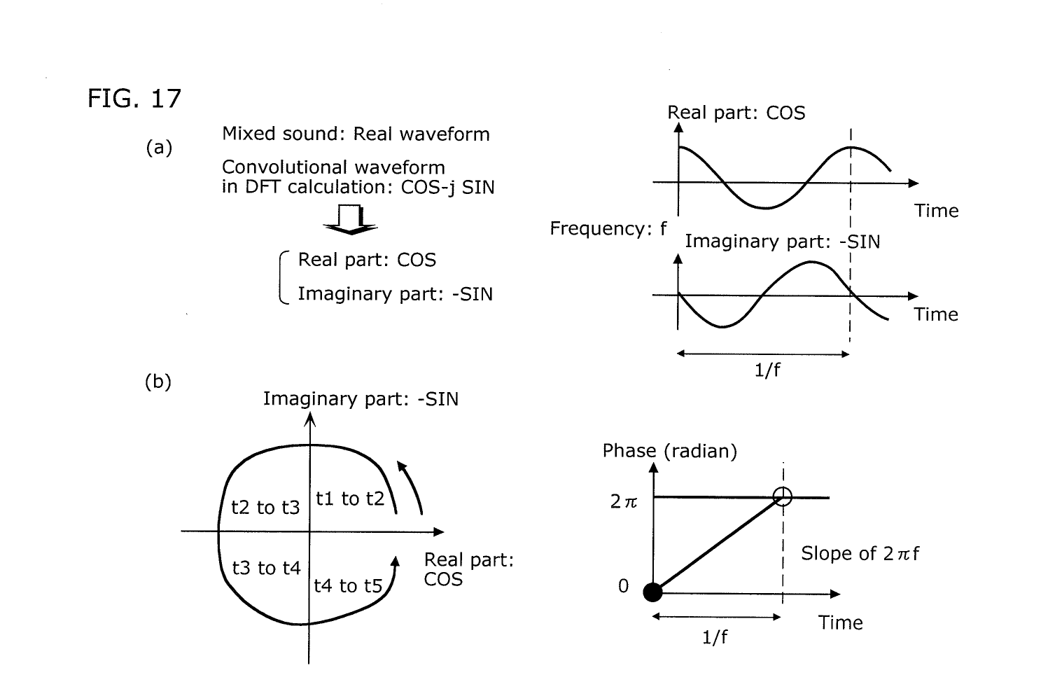

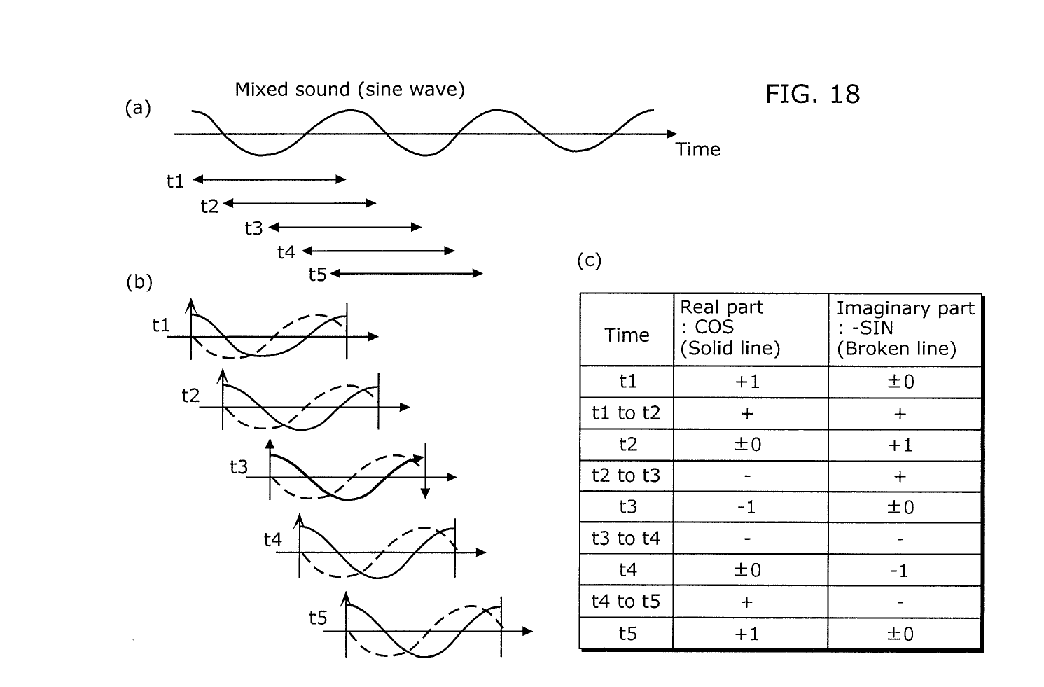

FIG. 17(a) shows the waveform of a signal to be convoluted into the to-be-extracted sound in DFT (Discrete Fourier Transform) calculation. The real part is a cosine waveform, and the imaginary part is a negative sine waveform. Here, a signal of a frequency f is analyzed. In the case where the to-be-extracted sound is a sine wave of a frequency f, analysis shows that the frequency signal has a phase ψ(t) that shifts with time counterclockwise as shown in FIG. 17(b). At this time, the horizontal axis represents the real part, and the vertical axis represents the imaginary part. Assuming that the counterclockwise direction is the positive direction, the phase ψ(t) increments by 2π (radian) at a 1/f time interval. In other words, the phase ψ(t) shifts with a slope of 2πf with respect to time t. With reference to FIG. 18, a description is given of a mechanism of shifting a current phase ψ(t) with time counterclockwise. FIG. 18(a) shows a to-be-extracted sound (that is a sine wave having a frequency f). Here, the magnitude (power) of the amplitude of the to-be-extracted sound is normalized to 1. FIG. 18(b) shows the waveform (of a frequency f) of a signal to be convoluted into the to-be-extracted sound in a DFT calculation in frequency analysis. The solid line shows the cosine waveform as the real part, and the broken line shows the negative sine wave as the imaginary part. FIG. 18(c) shows the codes corresponding to the values obtained in the convolution of the waveform shown in FIG. 18(b) into the to-be-extracted sound shown in FIG. 18(a) in the DFT calculation. FIG. 18(c) shows that the current phase shifts: to the first quadrant in FIG. 17(b) when the current time point shifts from t1 to t2; to the second quadrant in FIG. 17(b) when the current time point shifts from t2 to t3; to the third quadrant in FIG. 17(b) when the current time point shifts from t3 to t4; and to the fourth quadrant in FIG. 17(b) when the current time point shifts from t4 to t5. This shows that the current phase ψ(t) shifts with time counterclockwise.

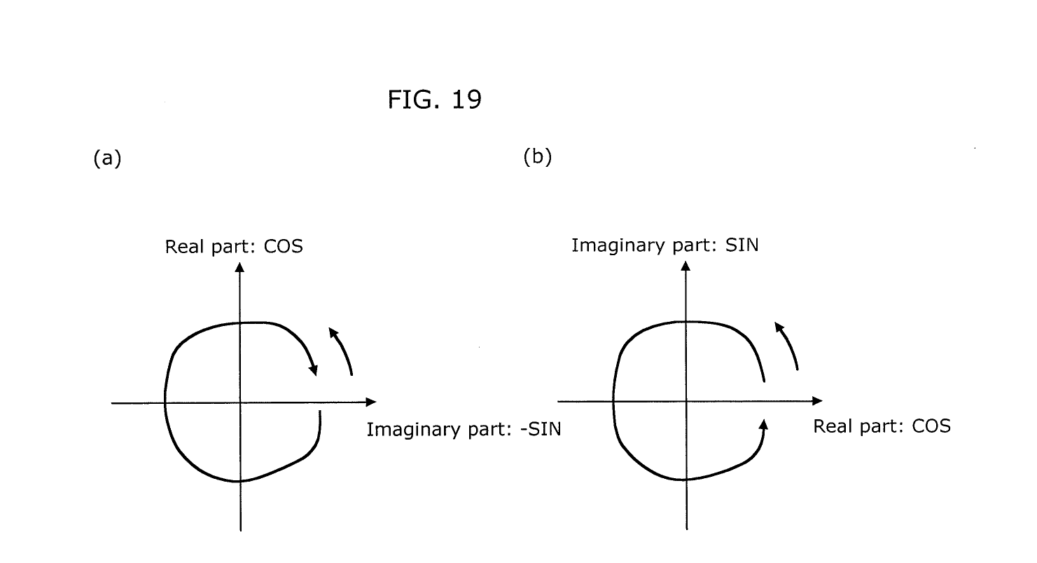

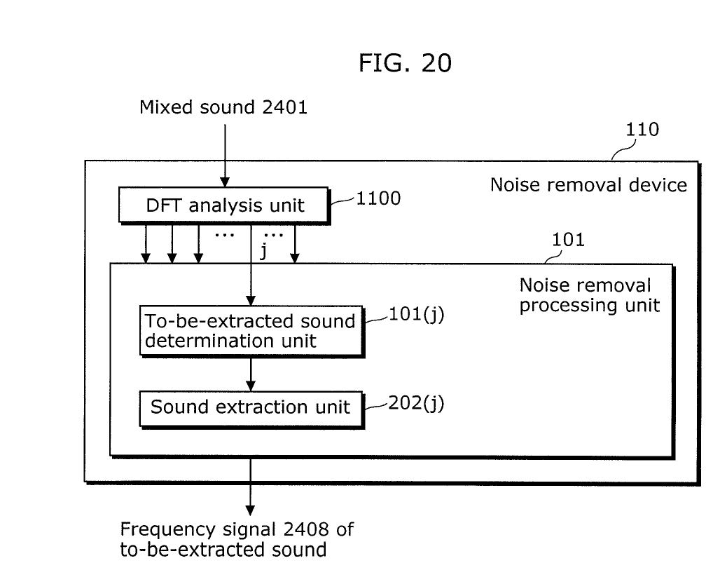

As supplemental information, FIG. 19(a) shows that the current phase ψ(t) inversely shifts when the horizontal axis is the imaginary part and the vertical axis is the real part. Assuming that the counterclockwise direction is the positive direction, the phase ψ(t) increments by 2π (radian) at a 1/f time interval. In other words, the phase ψ(t) shifts with a slope of −2πf with respect to time t. Here, a description is given assuming that the phases are modified to match the axes in FIG. 17(b). In addition, as shown in FIG. 19(b), the current phase ψ(t) inversely shifts when the real part is a cosine waveform and the imaginary part is a sine waveform while the current phase ψ(t) decrements by 2π (radian) at a 1/f time interval when the counterclockwise direction is the positive direction. In other words, the phase ψ(t) shifts with a slope of −2πf with respect to time t. Here, a description is given assuming that the codes of the real and imaginary parts are modified to match the frequency analysis results in FIG. 17(a). This shows that the phase ψ(t) of a frequency signal of a toned sound shifts with a slope of 2πf with respect to time t, resulting in a small phase distance at a phase ψ′(t) according to the expression ψ′(t)=mod 2π(ψ(t)−2ft) (here, f denotes a reference frequency).

### Variation 1 of Embodiment 1

Next, a description is given of Variation 1 of the noise removal device shown in Embodiment 1.

Here, a description is given of a case of using, as a mixed sound 2401, a mixed sound that is a mixture of sine waves of 100 Hz, 200 Hz, and 300 Hz. An object in this example is to remove a frequency signal that is in the sine wave (to-be-extracted sound) of 200 Hz in the mixed sound and is distorted due to frequency leakages from the sine waves of 100 Hz and 300 Hz. Accurate removal of the frequency signal distorted due to the frequency leakages makes it possible, for example, to accurately analyze the frequency structure of an engine sound included in the mixed sound, and to detect the presence of an approaching vehicle based on a Doppler shift. In addition, it is also possible to accurately analyze a formant structure of a voice included in the mixed sound.

FIG. 20 is a block diagram showing the overall structure of a noise removal device according to Variation 1.

In FIG. 20, the same structural elements as in FIG. 6 are assigned with the same reference numerals, and no detailed description thereof is repeated. The noise removal device in this example is different from the noise removal device according to Embodiment 1 in the point that a DFT (Discrete Fourier Transform) analysis unit 1100 (frequency analysis unit) is used instead of the FFT analysis unit 2402. A flowchart indicating a procedure of operations performed by the noise removal device 110 is the same as in Embodiment 1, and shown in FIGS. 8 and 9.

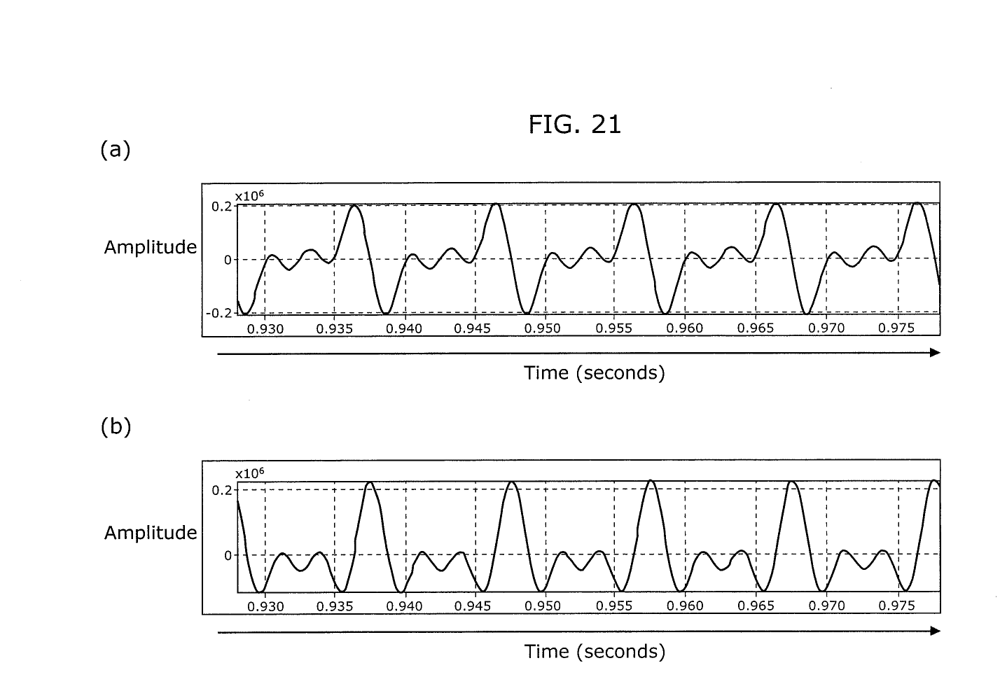

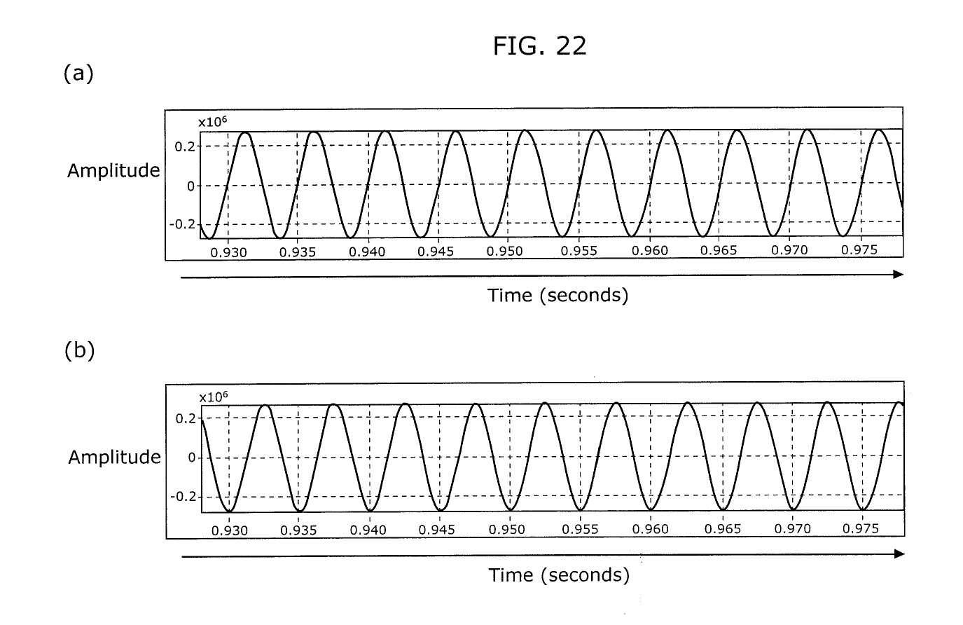

FIG. 21 shows exemplary time waveforms of frequency signals at the frequency of 200 Hz in the case of using the mixed sound 2401 that is a mixture of the sine waves of 100 Hz, 200 Hz, and 300 Hz. FIG. 21(a) shows a time waveform of the real part of the frequency signal at the frequency of 200 Hz, and FIG. 21(b) shows a time waveform of the imaginary part of the frequency signal at the frequency of 200 Hz. The horizontal axis is the time axis, and the vertical axis represents the amplitude of the frequency signal. Here is shown a time waveform having a time length of 50 ms.

FIG. 22 shows time waveforms of frequency signals at the frequency of 200 Hz of the 200-Hz sine wave used to generate the mixed sound 2401 shown in FIG. 21. The way of presentation is the same as in FIG. 21, and thus no detailed description thereof is repeated.

FIGS. 21 and 22 show that the sine wave of 200 Hz includes a portion distorted due to the frequency leakages from the sine waves of 100 Hz and 300 Hz in the mixed sound 2401.

First, the DFT analysis unit 1100 receives the mixed sound 2401, and performs discrete Fourier transform on the mixed sound 2401 to determine a frequency signal having a center frequency of 200 Hz in the mixed sound 2401 (Step S300). In this example, the reference frequency is also a frequency of 200 Hz. Here, discrete Fourier transform is performed on condition that a Hanning window having a time window width ΔT=5 ms (80 pt) is used for the mixed sound 2401 having a sampling frequency of 16000 Hz. In addition, the frequency signals at the respective time points are calculated with time shifts of 1 pt (0.0625 ms) in the time axis direction. FIG. 21 shows the time waveforms of the frequency signals as the results of this processing.

Next, the noise removal processing unit 101 determines, on a per time-frequency domain basis, a signal frequency of a to-be-extracted sound from the mixed sound using, on a per frequency band j (j=1 to M) basis, a to-be-extracted sound determination unit 101(j) (j=1 to M) for the respective frequency signals calculated by the DFT analysis unit 1100 (Step S301(j) (j=1 to M)). Subsequently, the noise removal processing unit 101 removes noises by causing its sound extraction unit 202(j) (j=1 to M) to extract the frequency signal, of the to-be-extracted sound, determined by the to-be-extracted sound determination unit 101(j) (Step S302(j)). In this example, M=1 is satisfied, and the center frequency f of the frequency band indicated as j=i-th is 200 Hz (equal in value to the reference frequency). Hereinafter, a case of j=1 is described. The same processing is performed when j denotes a value other than 1.

The to-be-extracted sound determination unit 101(1) determines the phase distance between a frequency signal at a current time point for analysis and frequency signals at all the time points other than the current time point for analysis, based on the frequency signals at all the time points having a time interval of 1/f (f denotes a reference frequency) in a predetermined time width (100 ms). Here, in the case where the number of frequency signals having a 1/f time interval included in the predetermined time width is equal to or exceeds the first threshold value, the phase distance is determined using all the frequency signals included in the predetermined time width. The frequency signals at the time points for analysis that yield a phase distance equal to or smaller than the second threshold value are determined to be frequency signals 2408 of the to-be-extracted sound (Step S301(1)).

Lastly, the sound extraction unit 202(j) removes noises by causing its to-be-extracted sound determination unit 101(j) to extract the frequency signals determined to be frequency signals 2408 of the to-be-extracted sound (Step S302(1)).

Next, the processing performed in Step S301(1) is described in detail. First, as in the example shown in Embodiment 1, the frequency signal selection unit 200(1) selects frequency signals in number equal to or greater than the first threshold value from the time points at a 1/f (f denotes a frequency of 200 Hz) in a predetermined time width (Step S400(1)).

Here, this example is different from the example shown in Embodiment 1 in the length of time range (predetermined time width) of a frequency signal that the phase distance determination unit 201(1) uses for phase distance calculation. In the example shown in Embodiment 1, the time range is 192 ms, and the time window width ΔT used for frequency signal determination is 64 ms. In this example, the time range is 100 ms, and the time window width ΔT used for frequency signal determination is 5 ms.

Next, the phase distance determination unit 201(1) calculates the phase distance using the phase of the frequency signal selected by the frequency signal selection unit 200(1) (Step S401(1)). The processing performed here is the same as the processing shown in Embodiment 1, and thus no detailed description thereof is repeated. The phase distance determination unit 201(1) determines the frequency signal at the current time point for analysis that yields a phase distance S equal to or smaller than the second threshold value to be a frequency signal 2408 of the to-be-extracted sound (Step S402(1)). This make it possible to determine a frequency signal of a portion that is not distorted due to the sine wave of 200 Hz.

Lastly, the sound extraction unit 202(1) removes noises by causing its to-be-extracted sound determination unit 101(1) to extract the frequency signals determined to be frequency signal 2408 of the to-be-extracted sound (Step S302(1)). The processing performed here is the same as the processing shown in Embodiment 1, and thus no detailed description thereof is repeated.

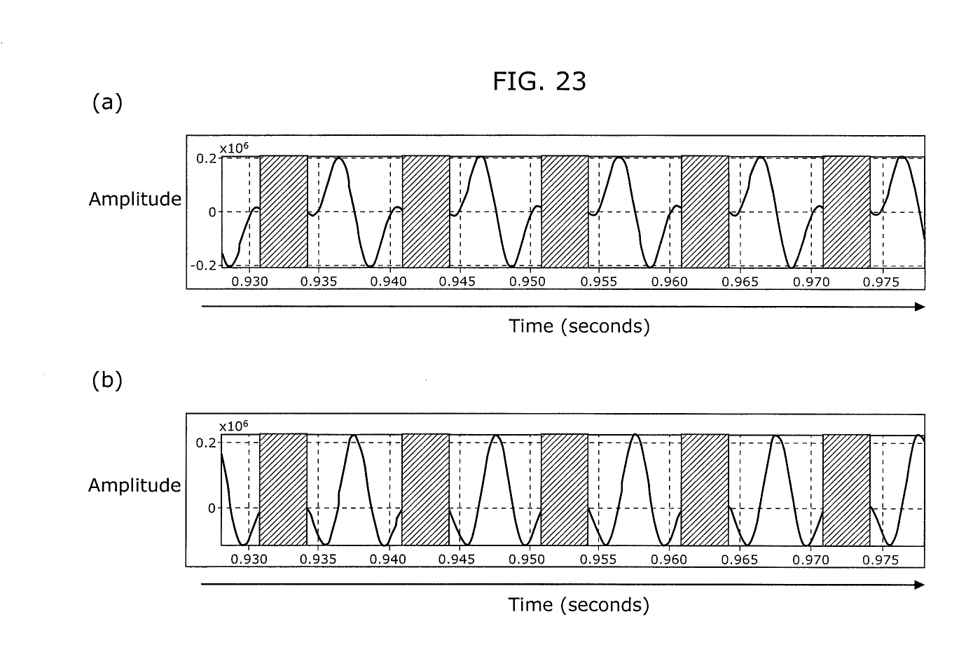

FIG. 23 shows time waveforms of the frequency signals at 200 Hz extracted from the mixed sound 2401 shown in FIG. 21. As to the presentation in FIG. 23, the same description given of FIG. 21 is not repeated. In FIG. 23, the shaded region portions have been removed as being frequency signals distorted due to frequency leakages. Comparison between FIG. 23 with FIGS. 21 and 22 shows that a frequency signal of a sine wave of 200 Hz is extracted after the removal, from the mixed sound 2401, of the frequency signals distorted due to frequency leakages from sine waves of 200 Hz an 300 Hz.

With the structures shown in Embodiment 1 and Variation 1 thereof, the use of phase distances between (i) a frequency signal at a current time point for analysis and (ii) frequency signals at plural time points that are present at either side part of the current time point for analysis and that include a frequency signal at a time point distant more than a time interval ΔT (the time window width used for frequency signal determination) produces, as a result of using a fine time resolution (ΔT), an advantageous effect of being able to remove frequency signals distorted due to frequency leakages from the surrounding frequencies.

### Variation 2 of Embodiment 1

Next, a description is given of Variation 2 of the noise removal device shown in Embodiment 1.

The noise removal device according to Variation 2 is structurally similar to the noise removal device according to Embodiment 1 described with reference to FIGS. 6 and 7, but is different in processing performed by the noise removal processing unit 101.

The phase distance determination unit 201(j) in the to-be-extracted sound determination unit 101(j) generates a phase histogram using frequency signals at time points of a 1/f time interval selected by the frequency signal selection unit 200(j). The phase distance determination unit 201(j) determines, to be frequency signals 2408 of a to-be-extracted sound, the frequency signals having a phase distance equal to or smaller than a second threshold value and having the number of times of appearance equal to or greater than a first threshold value.

Lastly, the sound extraction unit 202(j) removes noises by causing its phase distance determination unit 201(j) to extract the determined frequency signals 2408 of the to-be-extracted sound.

Next, a description is given of operations performed by the noise removal device 100 configured as described above. A flowchart indicating a procedure of operations performed by the noise removal device 100 is the same as in Embodiment 1, and shown in FIGS. 8 and 9.

For the frequency signal determined by the FFT analysis unit 2402 (frequency analysis unit), the noise removal processing unit 101 determines the frequency signals of the to-be-extracted sound, using the to-be-extracted sound determination unit 101(j) (j=1 to M) on a per frequency band j (j=1 to M) basis (Step S301(j) (j=1 to M)). The following describes processing performed on i-th frequency band. The same processing is performed on the other frequency bands. In this example, the center frequency of the i-th frequency band is f.

The to-be-extracted sound determination unit 101(j) generates a phase histogram, using frequency signals at time points having a 1/f time interval in a predetermined time width (3 times a time window width of a window function) selected by the frequency signal selection unit 200(j). The frequency signals that satisfies the conditions of having (i) the phase distance equal to or smaller than the second threshold value and (ii) the number of times of appearance equal to or greater than the first threshold value are determined to be frequency signals 2408 of the to-be-extracted sound (Step S301(j)).

The phase distance determination unit 201(j) generates the phase histogram of the frequency signals selected by the frequency signal selection unit 200(j), and determines the phase distance (Step S401(j)). A method of generating such histogram is described below. Each of the frequency signals selected by the frequency signal selection unit 200(j) is expressed by Expressions 2 and 3. Here, the phase of the frequency signal is calculated using the following Expression.

φₖ=arctan(yₖ/xₖ)(k=−K, . . . ,−2,−1,0,1,2, . . . , K) [Expression 13]

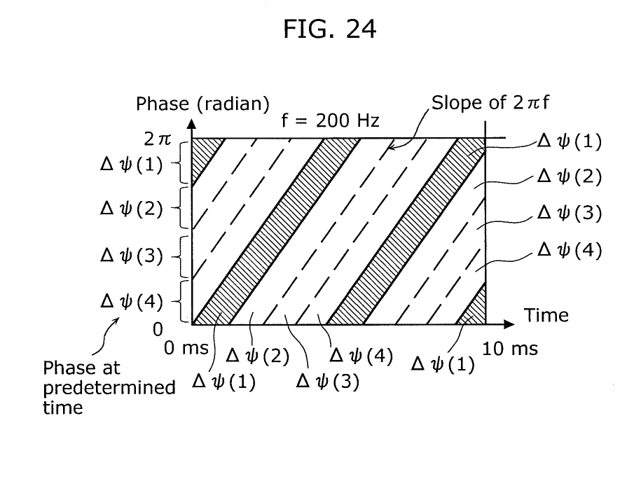

FIG. 24 shows an exemplary method of generating a histogram of the phases of frequency signals. Here, the histogram is generated by calculating the number of times of appearance of each frequency signal in a predetermined time width, for each band in a phase segment represented as Δψ(i) (i 32 1 to 4) that varies with a slope of 2πf (f denotes a reference frequency) with respect to time. The shaded portions in FIG. 24 are regions of Δψ(1). Here, the phases are represented within a limited range of 0 to 2π (radian), and thus the regions are discrete. Here, it is possible to generate the histogram by counting the number of frequency signals included in each of the regions represented as Δψ(i) (i=1 to 4).

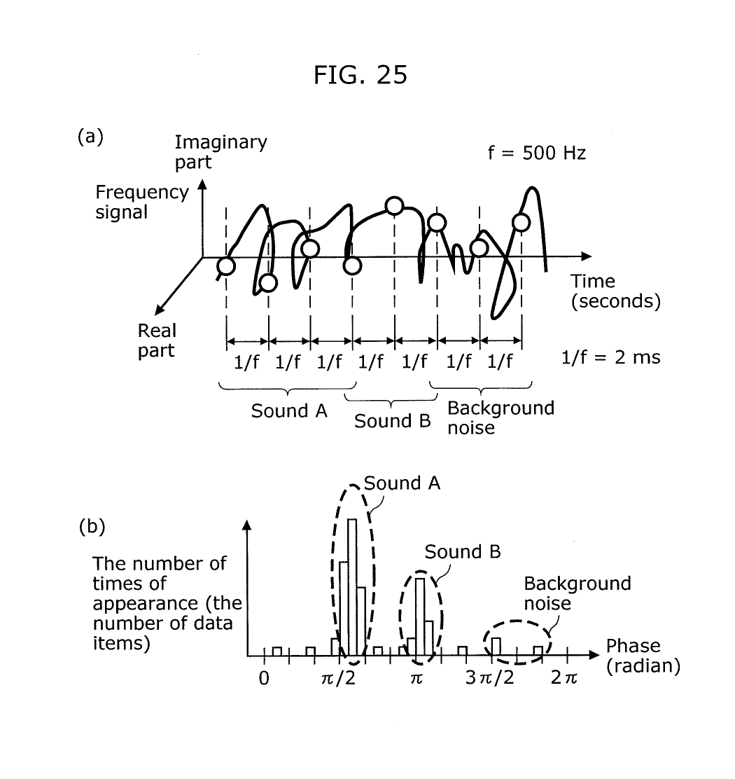

FIG. 25 shows an example of frequency signals selected by the frequency signal selection unit 200(j) and a histogram of the phases of the frequency signals. Here, the analysis is made using Δψ(i) (i=1 to L) finer than in the case of the histogram in FIG. 24.

FIG. 25(a) shows the selected frequency signals. The way of presentation in FIG. 25(a) is the same as in FIG. 12(b), and thus no detailed description thereof is repeated. In this example, the selected frequency signals include frequency signals of a sound A (a toned sound), a sound B (a toned sound), and a background noise (a toneless sound).

FIG. 25(b) schematically shows an exemplary histogram of the phases of the frequency signals. The group of frequency signals of the sound A has similar phases (in this example, near π/2 (radian)), and the group of frequency signals of the sound B has similar phases (in this example, near π (radian)). For this, two peaks are present in the histogram near π/2 (radian) and π (radian). On the other hand, the frequency signals of the background noise do not have any specific phase, and thus no peak is present in the histogram.

For this, the phase distance determination unit 201(j) determines, to be frequency signals 2408 of the to-be-extracted sound, the frequency signals each having a phase distance equal to or smaller than the second threshold value (π/4 (radian)) and having the number of times of appearance equal to or greater than the first threshold value (corresponding to 30 percent of the number of all the frequency signals having a 1/f time interval included in the predetermined time width). In this example, the frequency signals near π/2 (radian) and the frequency signals near t (radian) are determined to be the frequency signals 2408 of the to-be-extracted sound. At this time, the phase distances between frequency signals near π/2 (radian) and frequency signals near π (radian) are equal to or greater than π/4 (radian) (a third threshold value). For this, the groups of frequency signals represented by the respective peaks are determined to be different kinds of to-be-extracted sounds. More specifically, the respective sound A and sound B are separately determined to represent frequency signals of two different to-be-extracted sounds.

Lastly, the sound extraction unit 202(j) can remove noises by extracting each of the frequency signals of the different kinds of to-be-extracted sounds (Step S402(j)).

With this structure, the to-be-extracted sound determination unit classifies the frequency signals into groups of frequency signals satisfying the conditions of (i) being equal to or greater than the first threshold value in number, and (ii) having a degree of similarity equal to or smaller than the second threshold value between the constituent frequency signals. In addition, the to-be-extracted sound determination unit determines, to be of different kinds of to-be-extracted sounds, the frequency signal groups between which the phase distance is equal to or greater than the third threshold value. These processes make it possible to separately determine possible plural kinds of to-be-extracted sounds in the same time-frequency domain. For example, it is possible to separate engine sounds from plural vehicles and separately determine the frequency signals of the respective engine sounds. For this, applying a noise removal device according to the present invention to a vehicle detection device allows a driver to recognize the presence of plural vehicles and thus to drive safely. In addition, this application allows to separately determine voices of plural humans. For this, applying a noise removal device according to the present invention to a sound extraction device allows separate outputs of the voices as sounds.

Embedding a noise removal device according to the present invention into, for example, a sound output device makes it possible to determine, on a per time-frequency domain basis, frequency signals of a sound in a mixed sound, and subsequently output a clear sound by performing inverse frequency transform. In addition, embedding a noise removal device according to the present invention into, for example, a sound source direction detection device makes it possible to determine an accurate sound source direction by extracting the frequency signals of a to-be-extracted sound from which noises have been removed. In addition, embedding a noise removal device according to the present invention into, for example, a voice recognition device makes it possible to accurately perform voice recognition by extracting, on a per time-frequency domain basis, frequency signals of a to-be-extracted sound in a mixed sound even when noises are present around the to-be extracted sound. In addition, embedding a noise removal device according to the present invention into, for example, a sound recognition device makes it possible to accurately perform sound recognition by extracting, on a per time-frequency domain basis, frequency signals of a to-be-extracted sound in a mixed sound even when noises are present around the to-be-extracted sound. In addition, embedding a noise removal device according to the present invention into, for example, another vehicle detection device makes it possible to notify the presence of an approaching vehicle each time of extracting, on a per time-frequency domain basis, a frequency signal of an engine sound in a mixed sound. In addition, embedding a noise removal device according to the present invention into, for example, an emergency vehicle detection device makes it possible to notify the presence of an approaching emergency vehicle each time of extracting, on a per time-frequency domain basis, a frequency signal of a siren sound in a mixed sound.

In addition, considering extraction of a frequency signal of a noise (a toneless sound) that has not been determined to be of a to-be-extracted sound (a toned sound) in the present invention, embedding a noise removal device according to the present invention into, for example, a wind noise level determination device makes it possible to extract, on a per time-frequency domain basis, frequency signals of the wind noise in a mixed sound, calculate the signal powers, and output information indicating the signal powers. In addition, embedding a noise removal device according to the present invention into, for example, a vehicle detection device makes it possible to extract, on a per time-frequency domain basis, frequency signals of a running sound due to friction of tires in a mixed sound, and detect the presence of an approaching vehicle based on the signal powers.

It is to be noted that, as a frequency analysis unit, a cosine transform filter, a Wavelet transform filter, or a band-pass filter may be used.

It is to be noted that, as a window function used by the frequency analysis unit, any window functions such as a Hamming window, a rectangular window, or a Blackman window may be used.

It is to be noted that different values may be used as a center frequency f of the frequency signal generated by the frequency analysis unit and the reference frequency f′ used for phase distance calculation. At this time, when a frequency signal in the frequency f′ is present in the frequency signal having a center frequency f, the frequency signal is determined to be a frequency signal of the to-be-extracted sound. In addition, the frequency signal is specifically f′.

In Embodiment 1 and Variation 1 thereof, the to-be-extracted sound determination unit 101(j) (j=1 to M) selects frequency signals in time segments K (time widths of 96 ms) equal in length in past and future time from among the time points at a 1/f (f denotes a reference frequency) time interval, but time segments are not limited to the time segments K. For example, it is also good to select frequency signals in time segments different in length for past and future time.

In Embodiment 1 and Variation 1 thereof, analysis-target frequency signals used to calculate phase distances are set, and whether or not the frequency signal at each time point is a frequency signal of a to-be-extracted sound is determined, but the present invention is not limited to this. For example, it is possible to collectively determine whether or not all of frequency signals are frequency signals of a to-be-extracted sound by calculating the phase distances between frequency signals altogether and comparing each of the phase distances with a second threshold value. In this case, a temporal variation in an average phase in the time segment is analyzed. For this, it is possible to steadily determine frequency signals of a to-be-extracted sound even when the phase of a noise accidentally matches the phase of the to-be-extracted sound.

### Embodiment 2

Next, a noise removal device according to Embodiment 2 is described. Unlike the noise removal device according to Embodiment 1, the noise removal device according to Embodiment 2 modifies the phase ψ(t) (radian) of a frequency signal at a current time point t of a mixed sound to ψ′(t) according to the expression ψ′(t)=mod 2π(ψ(t)−2πft) (here, f denotes a reference frequency), determines a frequency signal of the to-be-extracted sound, based on the modified phase ψ′(t) of the frequency signal, and removes noises.

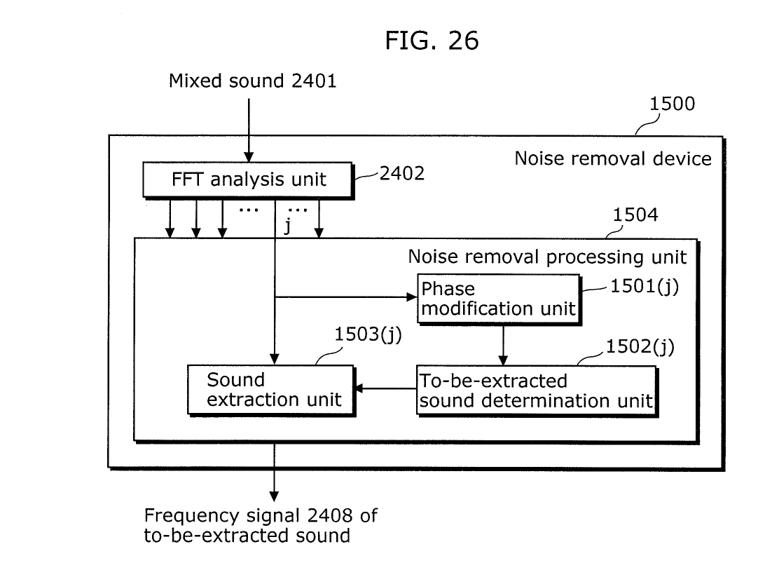

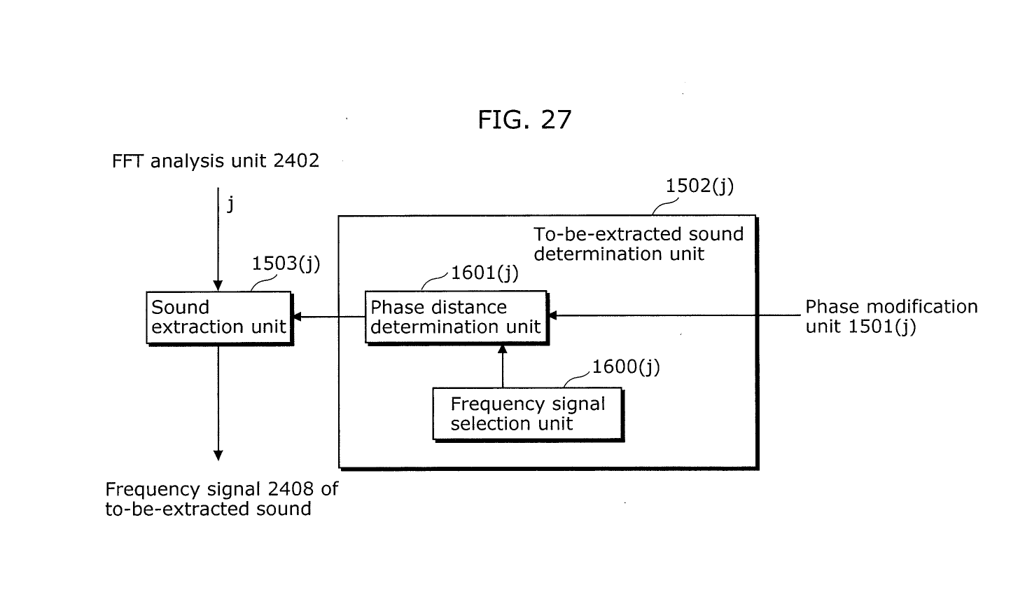

Each of FIG. 26 and FIG. 27 is a block diagram showing the structure of the noise removal device according to Embodiment 2 of the present invention.

In FIG. 26, the noise removal device 1500 includes: an FFT analysis unit 2402 (frequency analysis unit); and a noise removal processing unit 1504 including a phase modification unit 1501(j) (j=1 to M), a to-be-extracted sound determination unit 1502(j) (j=1 to M), and a sound extraction unit 1503(j) (j=1 to M).

The FFT analysis unit 2402 is a processing unit that performs fast Fourier transform on an input mixed sound 2401 to determine frequency signals of the mixed sound 2401. At this time, the frequency signals of the mixed sound 2401 are obtained by multiplexing the mixed sound 2401 by a window function having a predetermined time window width. Hereinafter, it is assumed that the number of frequency bands determined by the FFT analysis unit 2402 is denoted as M, and that the numbers specifying the respective frequency bands are denoted as j (j=1 to M).

The phase modification unit 1501(j) (j=1 to M) is a processing unit that modifies the phases of the frequency signals in the frequency band j determined by the FFT analysis unit 2402 to the phase ψ′(t) according to the expression ψ′(t)=mod 2π(ψ(t)−2πft) (here, f denotes a reference frequency) when the phase ψ(t) (radian) of the frequency signal at a time pint t.

The to-be-extracted sound determination unit 1502(j) (j=1 to M) calculates the phase distance between (i) a frequency signal at a current time point for analysis and having a modified phase in a predetermined time width within a range from 2 to 4 times a time window width of a window function (Hanning window) and (ii) frequency signals at time points other than the current time point for analysis and having modified phases. At this time, the number of frequency signals used to calculate a phase distance is equal to or exceeds a first threshold value. At this time, the phase distance is calculated using ψ′(t). The frequency signal at the current time point for analysis at which a phase distance is equal to or smaller than a second threshold value is determined to be a frequency signal 2408 of the to-be-extracted sound.

Lastly, the sound extraction unit 1503(j) (j=1 to M) removes noises from the mixed sound by extracting the frequency signal 2408 of the to-be-extracted sound determined by the to-be-extracted sound determination unit 1502(j) (j=1 to M) in the predetermined time width within a range from 2 to 4 times the time window width of the window function (Hanning window).

Performing this processing at sequentially-shifted time points having the predetermined time width makes it possible to extract frequency signals 2408 on a per time-frequency domain basis.

FIG. 27 is a block diagram showing the structure of the to-be-extracted sound determination unit 1502(j) (j=1 to M).

The to-be-extracted sound determination unit 1502(j) (j=1 to M) includes a frequency signal selection unit 1600(j) (j=1 to M) and a phase distance determination unit 1601(j) (j=1 to M).

The frequency signal selection unit 1600(j) (j=1 to M) is a processing unit that selects, in a predetermined time width, a frequency signal that the phase distance determination unit 1601(j) (j=1 to M) uses to calculate a phase distance, from among the frequency signals having a phase modified by the phase modification unit 1501(j) (j=1 to M). The phase distance determination unit 1601(j) (j=1 to M) is a processing unit that calculates the phase distances using the modified phases y (t) of the frequency signals selected by the frequency signal selection unit 1600(j) (j=1 to M), and determines the frequency signal that yields a phase distance equal to or smaller than the second threshold value to be a frequency signal 2408 of the to-be-extracted sound.

Next, a description is given of operations performed by the noise removal device 1500 configured as described above. The following describes processing performed on the i-th frequency band. The same processing as described below is performed on the other frequency bands. Here, a description is given of an exemplary case where the center frequency of the frequency band matches the reference frequency (frequency f according to the expression ψ′(t)=mod 2π(ψ(t)−2πft) used for phase distance calculation. In this case, it is possible to determine whether or not a to-be-extracted sound is present in the frequency f. Another method may be used to determine the to-be-extracted sound assuming that plural adjacent frequencies including the frequency band is the reference frequencies. In this case, it is possible to determine whether or not a to-be-extracted sound is present in the frequency around the center frequency. The processing is the same as in Embodiment 1.

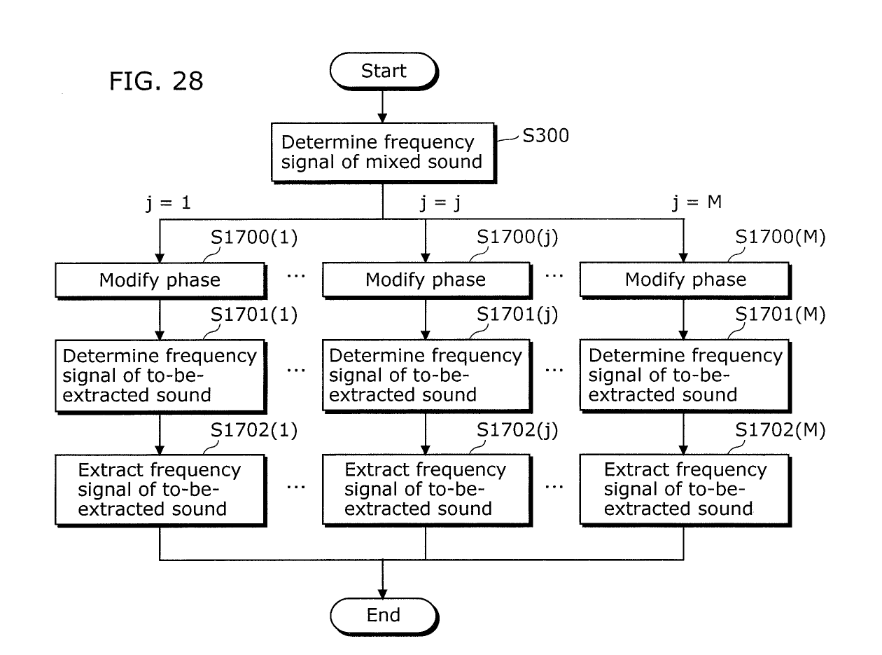

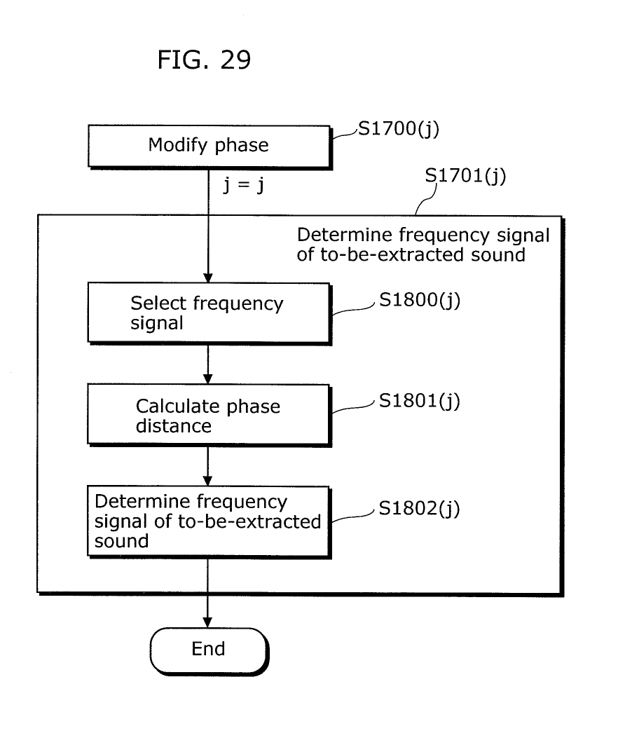

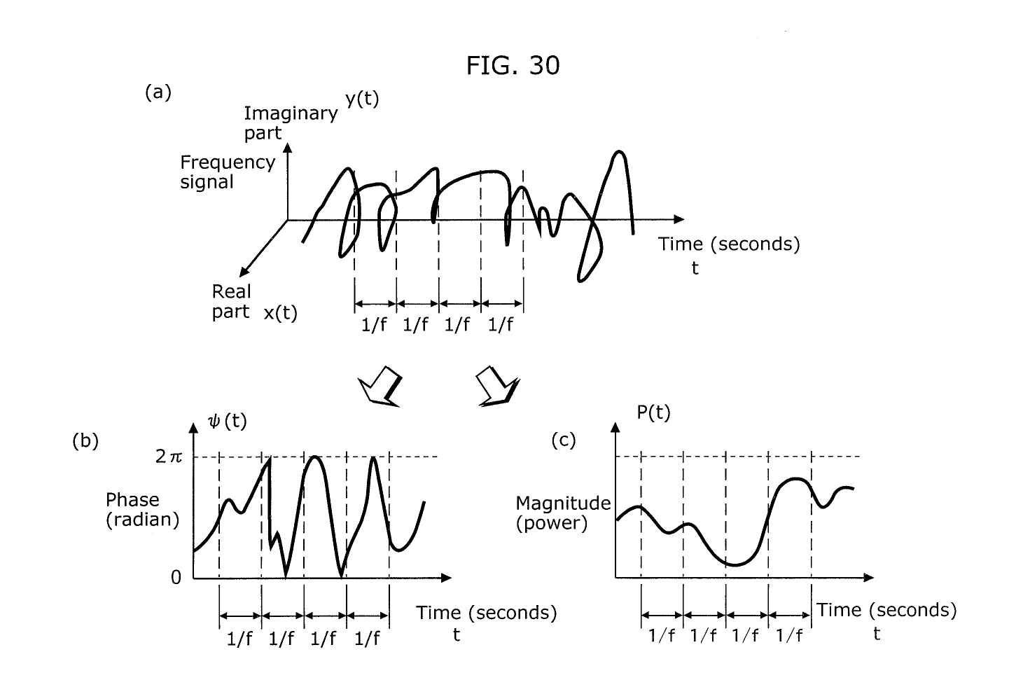

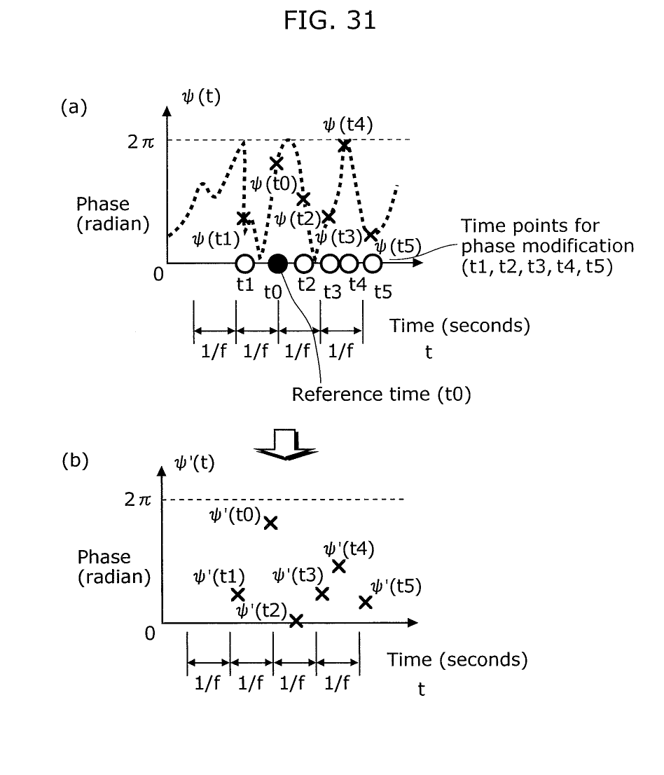

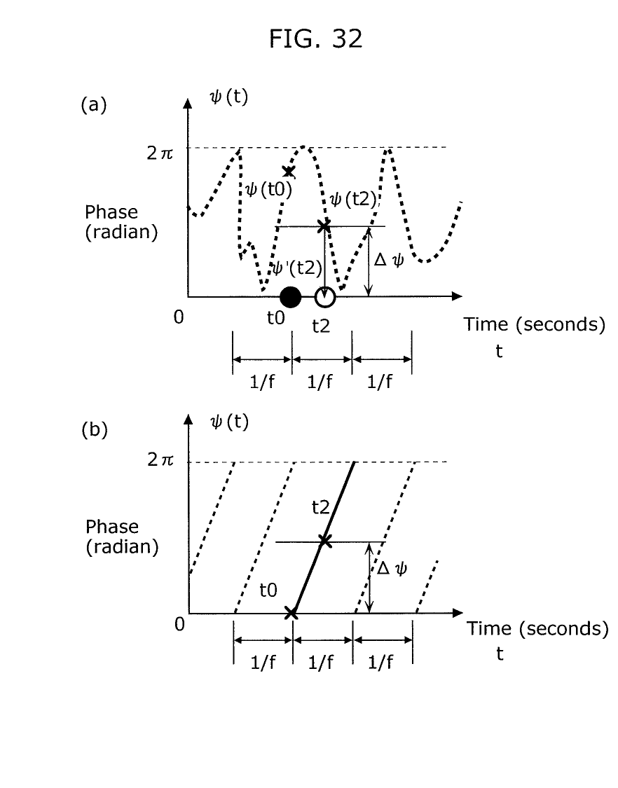

Each of FIG. 28 and FIG. 29 is a flowchart indicating a procedure of operations performed by the noise removal device 1500.

First, the FFT analysis unit 2402 performs fast Fourier transform on the input mixed sound 2401 to determine frequency signals of the mixed sound 2401 (Step S300). Here, the frequency signals are determined in the same manner as in Embodiment 1.

Next, the phase modification unit 1501(j) modifies the phases of the frequency signals determined by the FFT analysis unit 2402 by converting the phases according to the expression ψ′(t)=mod 2π(ψ(t)−2πft) (here, f denotes a reference frequency) when the phase ψ(t) (radian) of the frequency signal at a current time point t is the phase ψ′(t) (Step S1700(j)).

With reference to FIGS. 30 to 32, an exemplary phase modification method is described. FIG. 30(a) schematically shows frequency signals determined by the FFT analysis unit 2402. FIG. 30(b) schematically shows the phases of the frequency signals determined based on FIG. 30(a). FIG. 30(c) schematically shows the magnitudes (power) of the frequency signals determined based on FIG. 30(a). The horizontal axes in FIGS. 30(a) to 30(c) are time axes. The way of presentation in FIG. 30(a) is the same as in FIG. 12(b), and thus no detailed description thereof is repeated. The vertical axis in FIG. 30(b) represents the phases of the frequency signals, and the phases are shown as values within a range from 0 to 2π (radian). The vertical axis in FIG. 30(c) represents the magnitudes (power) of the frequency signals.

Here, the real parts of the frequency signals are represented as indicated below.

x(t) [Expression 14]

The imaginary parts of the frequency signals are represented as indicated below.

y(t) [Expression 15]

Here, the phases ψ(t) and the magnitudes (power) P(t) of the frequency signals are represented according to the two expressions indicated below.

φ(t)=mod 2π(arc tan(y(t)/x(t))) [Expression 16]

P(t)=\sqrt{x(t)²+y(t)²} [Expression 17]

The symbol t denotes a time point of a frequency signal.

Phase modification is performed by converting the phase ψ(t) of each frequency signal shown in FIG. 30(b) into the phase corresponding to the value obtained according to the expression ψ′(t)=mod 2π(ψ(t)−2πft) (here, f denotes a reference frequency).

First, a reference time point is determined. FIG. 31(a) has the same content as in FIG. 30(b), and in this example of FIG. 31(a), the time point t0 marked with a filled circle is determined to be the reference time point.

Next, determinations are made on plural time points of frequency signals whose phases to be modified. In this example of FIG. 31(a), the five time points (t1 to t5) marked with open circles are determined to be the plural time points of frequency signals whose phase are to be modified.

Here, the phase of the frequency signal at the reference time point t0 is represented as indicated below.

φ(t₀)=mod 2π(arc tan(y(t₀)/x(t₀))) [Expression 18]

The phases of the frequency signals at the five time points and having phases to be modified are represented as indicated below.

φ(tᵢ)=mod 2π(arc tan(y(tᵢ)/x(tᵢ))) (i=1,2,3,4,5)

The original phases before such modifications are shown with x marks in FIG. 31(a).

In addition, the magnitudes of the frequency signals at the time points can be represented as indicated below.

P(tᵢ)=\sqrt{x(tᵢ)²+y(tᵢ)²} (i=2,3,4,5) [Expression 20]

Next, FIG. 32 shows a method of modifying the phase of the frequency signal at the time point t2. FIG. 32(a) has the same content as in FIG. 31(a). In addition, FIG. 32(b) shows phases that shift regularly at a 1/f time interval to 0 to 2π (radian) at an equal angle speed.

Here, the modified phase is represented as indicated below.

φ′(tᵢ) (i=0,1,2,3,4,5) [Expression 21]

Comparison based on FIG. 32(b) shows that the phase at the time point t2 is greater than the phase at the reference time point t0 by the value indicated below.

Δφ=2πf(t₂−t₀) [Expression 22]

For this reason, in order to modify the phase difference, in FIG. 32(a), due to time difference from the reference time point t0 corresponding to the phase ψ(t0), ψ′(t2) is calculated by subtracting Δψ from the phase ψ(t2) at the time point t2. The resulting phase ψ′(t2) is the modified phase at the time point t2. At this time, since the phase at the time point t0 is the phase at the reference time point, the modified phase has the same value.

More specifically, the modified phase is calculated according to the two expressions indicated below.

φ′(t₀)=φ(t₀) [Expression 23]

φ′(tᵢ)=mod 2π(φ(tᵢ)−2πf(tᵢ−t₀)) (i=1,2,3,4,5) [Expression 24]

The modified phases of the frequency signals are marked with x in FIG. 31(b). The way of presentation in FIG. 31(b) is the same as in FIG. 31(a), and thus no detailed description thereof is repeated.

Next, the to-be-extracted sound determination unit 1502(j) calculates the phase distance between (i) the frequency signal at a current time point for analysis and (ii) frequency signals at plural time points other than the current time point for analysis, using the frequency signals which are in the predetermined time width within the range from 2 to 4 times the time window width of the window function (Hanning window) and whose phases have been modified by the phase modification unit 1501(j). At this time, the number of frequency signals used to calculate the phase distance is equal to or exceeds a first threshold value. The frequency signal at the current time point for analysis at which a phase distance is equal to or smaller than the second threshold value is determined to be a frequency signal 2408 of the to-be-extracted sound (Step S1701(j)).

First, the frequency signal selection unit 1600(j) selects a frequency signal that the phase distance determination unit 1601(j) uses for phase distance calculation, from among the frequency signals which are in the predetermined time width within the range from 2 to 4 times the time window width of the window function and whose phases have been modified by the phase modification unit 1501(j) (Step S1800(j)). Here, it is assumed that the current time point for analysis is t0, and that the time points of frequency signals whose phase distances from the frequency signal at the time point t0 are t1 to t5. At this time, the number of frequency signals (six frequency signals at t0 to t5) used to calculate the phase distances are equal to or exceed a first threshold value. The threshold is placed because it is difficult to determine regularity in temporal phase variation when the number of frequency signals selected to calculate the phase distances is not sufficient. Here, the time length corresponding to the predetermined time width is determined based on the nature in the temporal phase variation in the to-be-extracted sound.

Next, the phase distance determination unit 1601(j) calculates the phase distance, using all the frequency signals having modified phases and selected by the frequency signal selection unit 1600(j) (Step S1801(j)). In this example, the phase distance S is a phase difference error obtainable by the expression indicated below.

S=⅕Σᵢ₌₁ⁱ⁼⁵{square root over ((φ′(t₀)−φ′(tᵢ))²)} [Expression 25]

In addition, the phase distances S between the frequency signal at the time point t2 for analysis and the frequency signals at the time points t1 to t5 are calculated according to the expression indicated below.

S=⅕(Σᵢ₌₀ⁱ⁼¹{square root over ((φ′(t₂)−φ′(tᵢ))²)}+Σᵢ₌₃ⁱ⁼⁵{square root over ((φ′(t₂)−φ′(tᵢ))²)}) [Expression 26]

It is also good to calculate a phase distance considering that the phase values are in a torus (that is, 0 (radian) and 2π (radian) are the same).

For example, in the case of calculating a phase distance using the phase difference error shown in Expression 25, it is also good to calculate a phase distance using the following right term.

(φ′(t₀)−φ′(tᵢ))²≡min{(φ′(t₀)−φ′(tᵢ))², (φ′(t₀)−(φ′(tᵢ)+2π))², (φ′(t₀)−(φ′(tᵢ)−2π))²} [Expression 27]

In this example, the frequency signal selection unit 1600(j) selects a frequency signal that the phase distance determination unit 1601(j) uses for phase distance calculation, from among the frequency signals having the phase modified by the phase modification unit 1501(j). Other possible methods include a method in which the frequency signal selection unit 1600(j) selects, in advance, frequency signals whose phases are modified by the phase modification unit 1501(j), and the phase distance determination unit 1601(j) calculates the phase distances directly using the frequency signals whose phases have been modified by the phase modification unit 1501(j). In this case, it is possible to reduce the processing amount because it is only necessary to modify the phases of the frequency signals used for phase distance calculation.

Next, the phase distance determination unit 1601(j) determines, to be a frequency signal 2408 of the to-be-extracted sound, each of the analysis-target frequency signals having a phase distance equal to or smaller than the second threshold value (Step S1802(j)).

Lastly, the sound extraction unit 1503(j) removes noises by causing its to-be-extracted sound determination unit 1502(j) to extract the frequency signals determined to be the frequency signals 2408 of the to-be-extracted sound (Step S1702(j)).

Here, a consideration is given of the phases of frequency signals to be removed as noises. In this example, the phase distance is regarded as a phase difference error. Here, a second threshold value is set as π(radian). Here, a third threshold value is also set as π(radian).

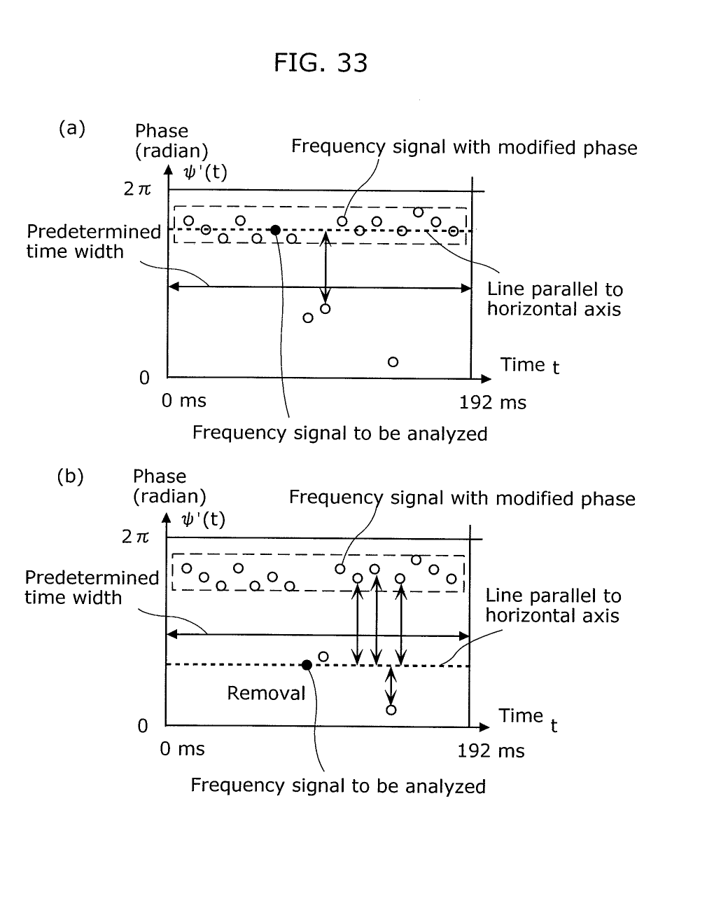

FIG. 33 is a diagram schematically showing the modified phases ψ′(t) of frequency signals, of a mixed sound, in the predetermined time width (192 ms) within a range from 2 to 4 times a time window width of a window function for calculating phase distances. The horizontal axis represents time t, and the vertical axis represents modified phases ψ′(t). The filled circle shows a current phase of the analysis-target frequency signal, and each open circle shows a current phase of the frequency signal used to calculate a phase distance from the phase of the frequency signal marked with the filled circle. As shown in FIG. 33(a), phase distance calculation performed is calculating a phase distance from a straight line which has a slope parallel to the time axis and passes through the modified phase of the analysis-target frequency signal. In FIG. 33(a), modified phases of the frequency signals whose phase distances are calculated are present near the straight line. For this, the phase distances from the frequency signals equal to or greater than the first threshold value in number are equal to or smaller than the second threshold value (π(radian)), and the analysis-target frequency signals are determined to be frequency signals of a to-be-extracted sound. In addition, as shown in FIG. 33(b), when almost no frequency signals whose phase distances are calculated are present near the straight line which has a slope parallel to the time axis and passes through the modified phase of the analysis-target frequency signal, the phase distances from the frequency signals in number equal to or greater than the first threshold value are greater than the second threshold value (π(radian)). For this, there is no possibility that the analysis-target frequency signals are determined to be frequency signals of a to-be-extracted sound, and such frequency signals are removed as noises.

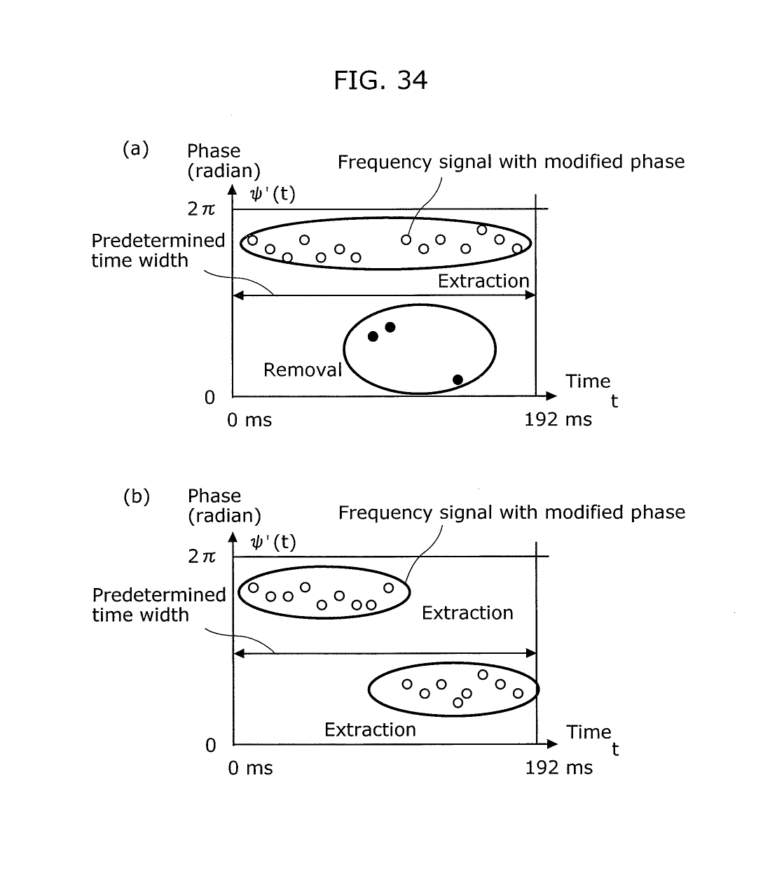

FIG. 34 schematically shows another example of phases of a mixed sound. The horizontal axis is the time axis, and the vertical axis is the phase axis. The modified phases of the frequency signals of the mixed sound are marked with circles. Each of solid lines encloses the frequency signals that belong to a same cluster and has a phase distance between the frequency signals that is equal to or smaller than the second threshold value (π(radian)). These clusters can also be determined using multivariate analysis. The frequency signals in a cluster in which the number of the constituent frequency signals is equal to or greater than the first threshold value are not removed but extracted, and the frequency signals in a cluster in which the number of the constituent frequency signals is smaller than the first threshold value are removed as being noises. As shown in FIG. 34(a), in the case where a noise portion is included in the predetermined time width, it is possible to remove only the noise portion. In addition, as shown in FIG. 34(b), in the case where two kinds of to-be-extracted sounds are present, it is possible to extract the two kinds of to-be-extracted sounds by extracting two frequency signal clusters each of which includes such frequency signals that (i) have a phase distance equal to or greater than the second threshold value (π(radian)) between the frequency signals and (ii) account for 40 percent or more in number (here, 7 or more) of the frequency signals present in the predetermined time width. At this time, the phase distance between these clusters is equal to or greater than the third threshold value (π(radian)), and thus the frequency signals in the respective clusters are determined to be different kinds of to-be-extracted sounds.

With this structure, phase modification according to the expression ψ′(t)=mod 2π(ψ(t)−2πft) is performed on the frequency signals at a time interval finer than 1/f (f denotes a reference frequency) time interval. In this way, it is possible to calculate the phase distances of the frequency signals at a time interval finer than 1/f (f denotes a reference frequency) time interval according to the simple expression using ψ′(t). For this, it is possible to determine the frequency signals of a to-be-extracted sound on a per short time domain basis even in a low frequency band with a long 1/f time interval, using the simple expression ψ′(t)=mod 2π(ψ(t)−2πft).

Embedding a noise removal device according to the present invention into, for example, a sound output device makes it possible to determine, on a per time-frequency domain basis, frequency signals of a sound in a mixed sound, and subsequently output a clear sound by performing inverse frequency transform. In addition, embedding a noise removal device according to the present invention into, for example, a sound source direction detection device makes it possible to determine an accurate sound source direction by extracting the frequency signals of a to-be-extracted sound from which noises have been removed. In addition, embedding a noise removal device according to the present invention into, for example, a voice recognition device makes it possible to accurately perform voice recognition by extracting, on a per time-frequency domain basis, frequency signals of a sound in a mixed sound even when noises are present around the to-be-extracted sound. In addition, embedding a noise removal device according to the present invention into, for example, a sound recognition device makes it possible to accurately perform sound recognition by extracting, on a per time-frequency domain basis, frequency signals of a sound in a mixed sound even when noises are present around the to-be-extracted sound. In addition, embedding a noise removal device according to the present invention into, for example, another vehicle detection device makes it possible to notify the presence of an approaching vehicle each time of extracting, on a per time-frequency domain basis, a frequency signal of an engine sound in a mixed sound. In addition, embedding a noise removal device according to the present invention into, for example, an emergency vehicle detection device makes it possible to notify the presence of an approaching emergency vehicle each time of extracting, on a per time-frequency domain basis, a frequency signal of a siren sound in a mixed sound.

In addition, considering extraction of a frequency signal of a noise (a toneless sound) that has not been determined to be of a to-be-extracted sound (a toned sound) in the present invention, embedding a noise removal device according to the present invention into, for example, a wind noise level determination device makes it possible to extract, on a per time-frequency domain basis, frequency signals of the wind noise in a mixed sound, calculate the signal powers, and output information indicating the signal powers. In addition, embedding a noise removal device according to the present invention into, for example, a vehicle detection device makes it possible to extract, on a per time-frequency domain basis, frequency signals of a running sound due to friction of tires in a mixed sound, and detect the presence of an approaching vehicle based on the signal power.

It is to be noted that, as a frequency analysis unit, a discrete Fourier transform filter, a cosine transform filter, a Wavelet transform filter, or a band-pass filter may be used.

It is to be noted that, as a window function used by the frequency analysis unit, any window functions such as a Hamming window, a rectangular window, or a Blackman window may be used.

The noise removal device 1500 removes noises from all (M in number) the frequency bands determined by the FFT analysis unit 2402, but it is also good to select some of the frequency bands from which noises are desired to be removed, and remove the noises from the selected frequency bands.

It is also possible to collectively determine whether or not plural frequency signals as a whole are of a to-be-extracted sound by calculating the phase distances between the plural frequency signals without determining analysis-target frequency signals and comparing the phase distances with the second threshold value. In this case, a temporal variation in an average phase in the time segment is analyzed. For this, it is possible to steadily determine frequency signals of a to-be-extracted sound even when the phase of a noise accidentally matches the phase of the to-be-extracted sound.

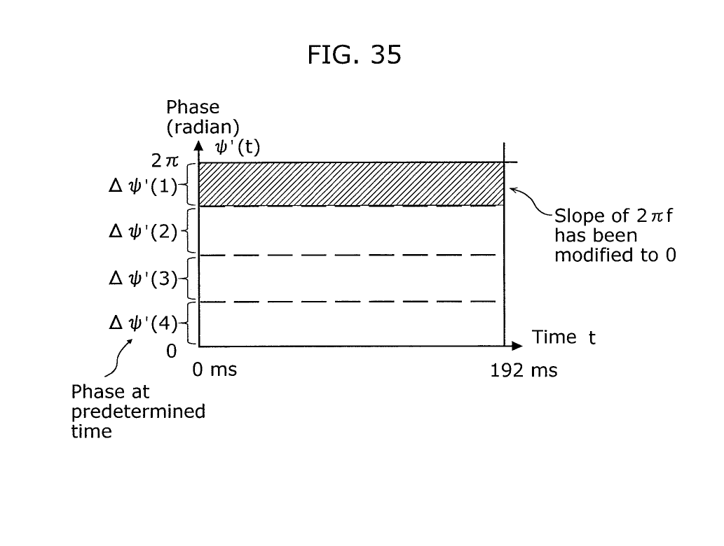

As in Variation 2 of Embodiment 1, it is also good to generate a histogram of phases of frequency signals, using the modified phases, and determine frequency signals of a to-be-extracted sound, with reference to the histogram. In this case, the histogram is as shown in FIG. 35. The way of presentation is the same as in FIG. 24, and thus no detailed description thereof is repeated. The use of modified phases makes Δψ′ regions in the histogram parallel to the time axis, thereby facilitating calculation of the number of times of appearance.

It is also good to determine frequency signals of a to-be-extracted sound by determining the real part and the imaginary part of each frequency signal normalized by power, using the phase distances (Expressions 6, 7, 8, and 9) in Embodiment 1 according to two expressions using the modified phase ψ′(t) indicated below.

x′ₜ=cos(φ′(t)) [Expression 28]

y′ₜ=sin(φ′(t)) [Expression 29]

### Embodiment 3

Next, a description is given of a vehicle detection device according to Embodiment 3. The vehicle detection device according to Embodiment 3 is intended to notify a driver of the presence of an approaching vehicle by outputting a to-be-extracted sound detection flag when it is determined that a frequency signal of an engine sound (to-be-extracted sound) is included in at least one of mixed sounds inputted through microphones. At this time, first, a reference frequency suitable for the mixed sound is determined for each time-frequency domain in advance based on an approximate straight line represented in time and phase space. Subsequently, with regard to the determined reference frequency, the phase distance is determined based on the distance between the determined straight line and the phase, thereby determining a frequency signal of an engine sound.

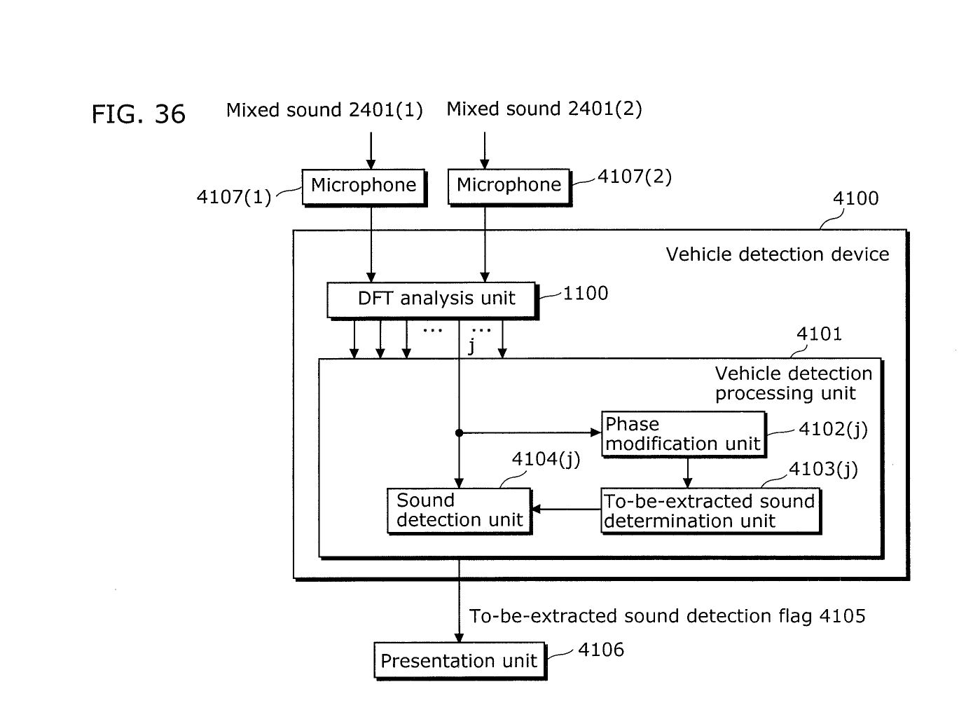

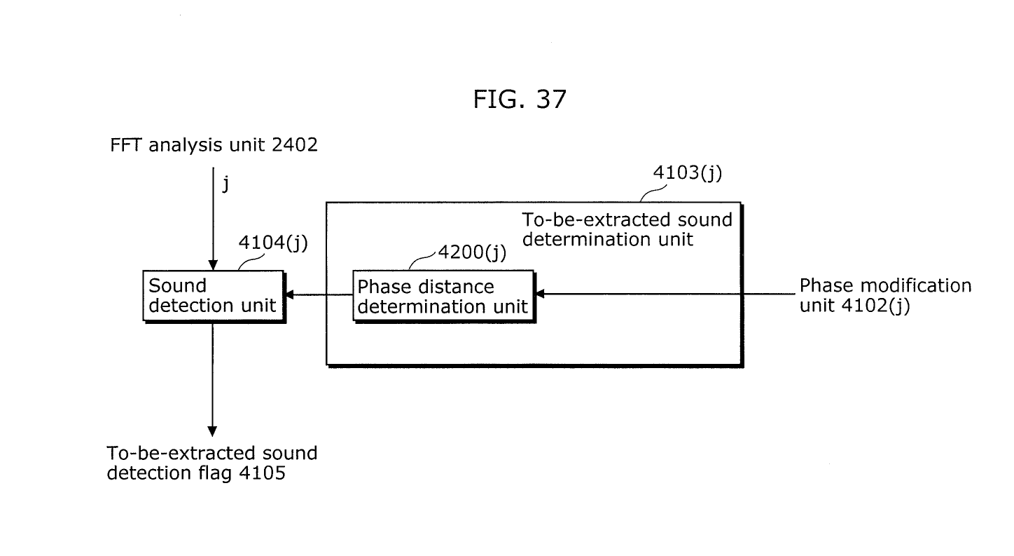

Each of FIG. 36 and FIG. 37 is a block diagram showing a structure of the vehicle detection device according to Embodiment 3 of the present invention.

In FIG. 36, the vehicle detection device 4100 includes: a microphone 4107(1); a microphone 4107(2); a DFT analysis unit 1100 (frequency analysis unit); a vehicle detection processing unit 4101 including a phase modification unit 4102(j) (j=1 to M), a to-be-extracted sound determination unit 4103(j) (j=1 to M), and a sound detection unit 4104(j) (j=1 to M); and a presentation unit 4106.

In addition, in FIG. 37, the to-be-extracted sound determination unit 4103(j) (j=1 to M) includes a phase distance determination unit 4200(j) (j=1 to M).

The microphone 4107(1) receives a mixed sound 2401(1), and the microphone 4107(2) receives a mixed sound 2401(2). In this example, the microphones 4107(1) and 4107(2) are set on front left and front right bumpers, respectively, of the vehicle. The respective mixed sounds include a motorbike engine sound and a wind noise.

The DFT analysis unit 1100 prepares plural window functions having different time window widths, performs discrete Fourier transform on the respective mixed sounds 2401(1) and 2401(2) multiplied by the respective window functions and then inputted, and determines frequency signals 2402(j) (J=1 to L) corresponding to the window function of the mixed sounds 2401. In this example, a frequency signal 2402(1) and a frequency signal 2402(2) are determined based on two window functions (L=2) having the different time window widths. Here, the time window widths of the window functions are 25 ms and 63 ms. These time window widths correspond to time resolutions of the frequency signals. Here, the frequency signals are determined at each 0.1 ms interval. Hereinafter, it is assumed that the number of frequency bands determined by the DFT analysis unit 1100 is denoted as M, and that the numbers specifying the respective frequency bands are denoted as j (j=1 to M). In this example, the 10- to 300-Hz frequency band in which the motorbike engine sound is present is segmented at each 10-Hz interval, based on which M (M=30) frequency signals are determined.

The phase modification unit 4102(j) (j=1 to M) is a processing unit that modifies the phases of the frequency signals in the frequency band j (j=1 to M) determined by the DFT analysis unit 1100 to the phase ψ″(t) according to the expression ψ″(t)=mod 2π(ψ(t)−2πf′t) (f′ is a frequency in a frequency band) when the phase of the frequency signal at the time point t is ψ(t) (radian). This example differs from Embodiment 2 in the point of modifying the phase ψ(t) using a frequency f′ in the frequency band in which frequency signals have been determined, instead of modifying the phase ψ(t) using a reference frequency.

The to-be-extracted sound determination unit 4103(j) (J=1 to M) (phase distance determination unit 4200(j) (J=1 to M)) calculates phase distances of the respective frequency signals 2402(j) (J=1 to L) corresponding to the respective window functions, using the phase ψ″(t) of the frequency signal modified by the phase modification unit 4102(j) (J=1 to M). In other words, the to-be-extracted sound determination unit 4103(j)=1 to M) (phase distance determination unit 4200(j)=1 to M)) calculates the phase distances by determining a reference frequency suitable for the frequency signals based on the approximate straight line in the time and phase space, using the frequency signals at time points at a time interval of 113 ms (predetermined time width) for each of the mixed sounds (mixed sounds 2401(1) and 2401(2)) having a length within a range from 2 to 4 times the time window widths of the window functions. In addition, the to-be-extracted sound determination unit 4103(j)=1 to M)) (phase distance determination unit 4200(j) (J=1 to M)) calculates the phase distance based on the distance between the calculated approximate straight line and the phase, and determines, to be a frequency signal of the engine sound, the frequency signal, in the predetermined time width, which has a phase distance equal to or smaller than the second threshold value.

The sound detection unit 4104(j) (J=1 to M) generates and output a to-be-extracted sound detection flag 4105 when the to-be-extracted sound determination unit 4103(j) (J=1 to M) determines that a frequency signal at one of the time points of an engine sound (a sound to be extracted) is present in at least one of the mixed sounds 2401(1) and 2401(2), based on at least one of the frequency signals among the frequency signals 2402(j) (j=1 to L) corresponding to the window functions.

The presentation unit 4106 notifies the driver of the presence of an approaching vehicle when the to-be-extracted sound detection flag 4105 is inputted by the sound detection unit 4104(j) (j=1 to M).

Each processing unit performs these processes with time shifts in the predetermined time width.

Next, a description is given of operations performed by the vehicle detection device 4100 configured as described above.

The following describes processing performed on the i-th frequency band (the frequency within the frequency band is denoted as f′). The same processing as described below is performed on the other frequency bands.

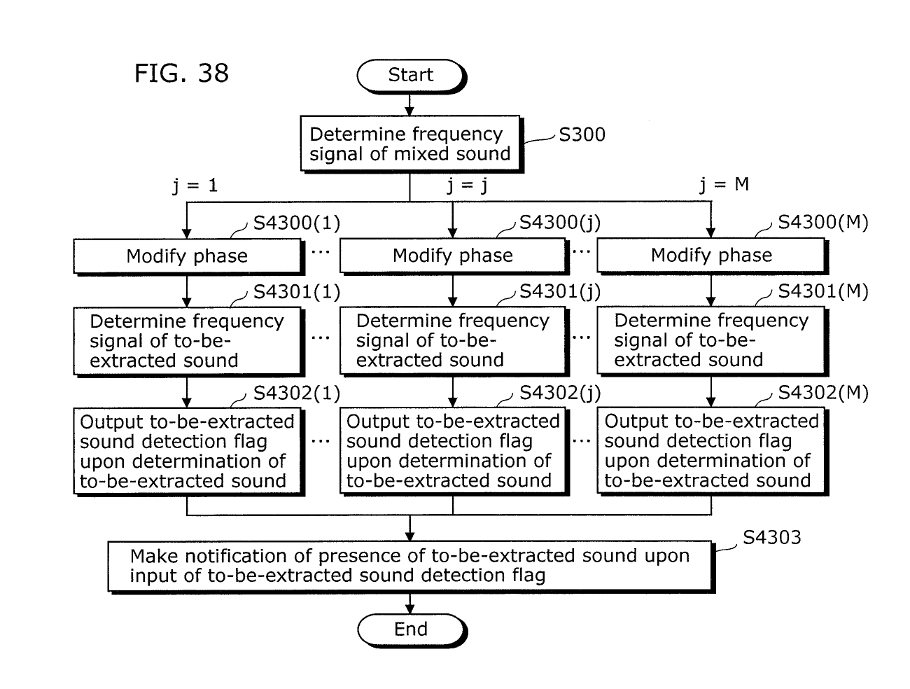

FIG. 38 is a flowchart indicating a procedure of operations performed by the vehicle detection device 4100.

The DFT analysis unit 1100 is intended to receive mixed sounds 2401(1) and 2401(2), prepare plural window functions having different time window widths, multiply the mixed sounds 2401(1) and 2401(2) by the respective window functions, perform discrete Fourier transform on the respective mixed sounds 2401(1) and 2401(2), and determine frequency signals 2402(j) (j=1 to L) corresponding to the window functions of the mixed sounds 2401. In this example, the time window widths of the window functions are set to be 25 ms and 63 ms, and frequency signals 2402(1) and 2402(2) are determined based on the respective window functions (Step S300).

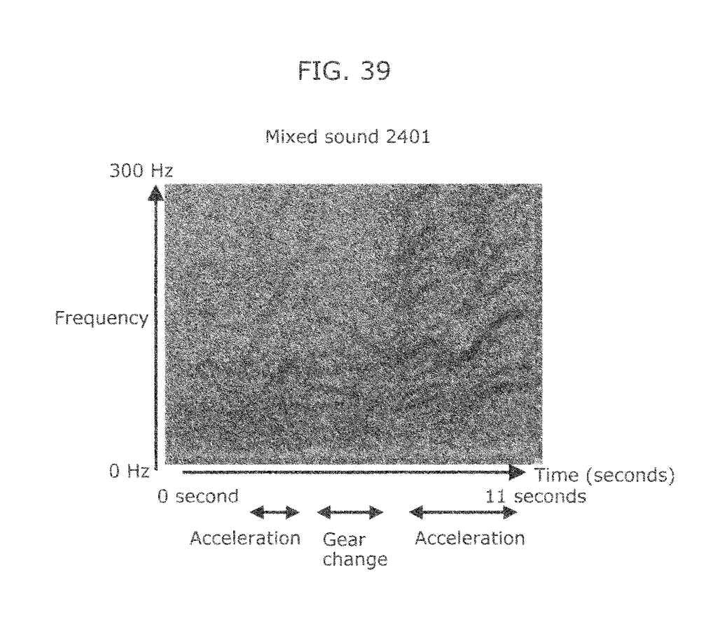

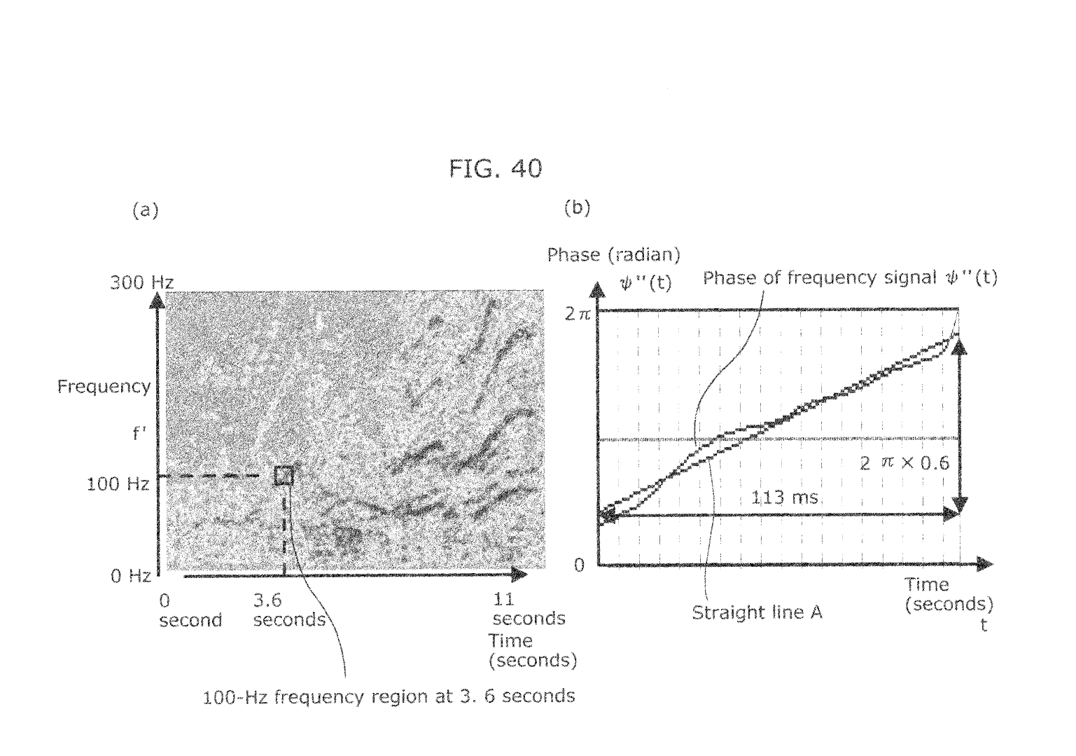

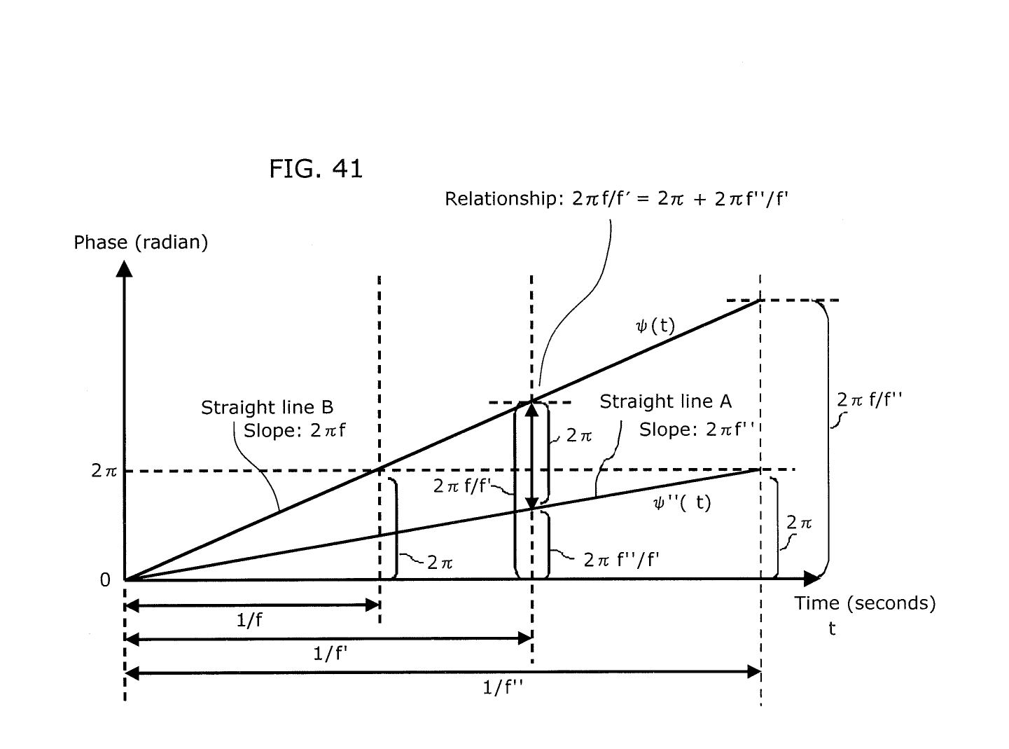

FIG. 39 shows an exemplary spectrogram of the mixed sound 2401. The way of presentation is the same as in FIG. 10, and thus a description is not repeated. The mixed sound 2401 includes a motorbike engine sound and a wind noise. The frequency structure of the engine sound in this diagram is characterized by: (i) a high frequency f (second to fourth seconds) at the time when the motorbike accelerated; (ii) a low frequency f (fourth to seventh seconds) at the time when the motorbike changed the gear; and (iii) a high frequency f (seventh to eleventh seconds) at the time when the motorbike accelerated again.

Next, the phase modification unit 4102(j) modifies the phases of the frequency signals in the frequency band j (frequency f′) determined by the DFT analysis unit 1100 by converting the phases according to the expression ψ″(t)=mod 2π(ψ(t)−2πf′t) (here, f′ denotes a frequency in the frequency band) when the phase of the frequency signal at the current time point t is ψ(t) (radian) (Step S4300(j)). This example differs from Embodiment 2 in the point of modifying the phases using a frequency f′ in the frequency band in which frequency signals have been determined, instead of modifying the phases using a reference frequency f. The other conditions are the same as in Embodiment 2, and thus no detailed description thereof is repeated.

Next, the to-be-extracted sound determination unit 4103(j) (phase distance determination unit 4200(j)) sets a reference frequency f, using the phases ψ″(t) of the frequency signals having modified phases at all the time points in the predetermined time width within the range from 2 to 4 times the time window widths of the window functions, for each of the frequency signals (frequency signals 2402(1) and 2402(2)), corresponding to the window functions, in the mixed sound (each of the mixed sounds 2401(1) and 2401(2). Here, the number of frequency signals is equal to or greater than a first threshold value corresponding to 80 percent of the number of the frequency signals at time points in the predetermined time width. The to-be-extracted sound determination unit 4103(j) (phase distance determination unit 4200(j)) calculates each phase distance using the set reference frequency f. Subsequently, the to-be-extracted sound determination unit 4103(j) (phase distance determination unit 4200(j)) determines, to be frequency signals of the engine sound, the frequency signals, in the predetermined time width, having a phase distance equal to or smaller than the second threshold value.

FIG. 40(a) is a spectrogram of the mixed sound 2401(1). The way of presentation is the same as in FIG. 39, and thus no detailed description thereof is repeated. Here, a description is given of a case of determining a frequency signal of the engine sound (to-be-extracted sound) from the frequency signal 2402(1) corresponding to the window function having a time window width of 25 ms. For this, a predetermined time width for phase distance calculation is set to be 75 ms (3 times the time window width). In the case of determining a frequency signal of the engine sound (to-be-extracted sound) from the frequency signal 2402(2) corresponding to the window function having a time window width of 63 ms, a predetermined time width for phase distance calculation is set to be 189 ms (3 times the time window width).

In relation to FIG. 40(a), FIG. 40(b) shows the phase ψ″(t), modified by a frequency f′ of the frequency band, of the frequency signal 2402(1) at 3.6-second point in the time-frequency domain of a 100-Hz frequency band having a predetermined time width (113 ms). The horizontal axis presents time, and the vertical axis presents phase ψ″(t). In this example, the phase has been modified using the frequency (f′=100 Hz) of the frequency band and is presented according to an expression ψ″(t)=mod 2π(ψ(t)−2π×100×t). In addition, FIG. 40(b) shows a straight line (straight line A) that yields a minimum distance (phase distance) between each of these modified phases ψ″(t) and the straight line defined in the space of time and phases ψ″(t).

The straight line can be determined by linear regression analysis. More specifically, the modified phase ψ″(t(i)) is converted into a response variable assuming that the time point t(i) is an explanatory variable (here, i (i=1 to N) is an index at the time when t is discrete). As indicated below, the straight line A can be generated using, as N items of data, the modified phases ψ″(t(i)) (i=1 to N) at each time point in the time-frequency domain, at 3.6-second point, of the 100-Hz frequency band having a predetermined time width (113 ms).

φ″(t)=S_{tφ″}/Sₜₜ(t− t̅)+ φ̅″ [Expression 30]

Here, the following shows an average time point.

t̅=1/NΣᵢ₌₁^{i=N}t(i) [Expression 31]

The following shows an average modified phase.

φ̅″=1/NΣᵢ₌₁^{i=N}φ″(t(i)) [Expression 32]

The following shows a time point variance.

Sₜₜ=1/NΣᵢ₌₁^{i=N}t(i)²− t̅² [Expression 33]

The following shows a covariance between a time point and a modified phase.

S_{tφ″}=1/NΣᵢ₌₁^{i=N}t(i)φ″(t(i))− t̅ φ̅″ [Expression 34]

Here, with reference to FIG. 41, it is shown that a reference frequency f can be determined based on the slope of the straight line A in FIG. 40(b). Here, it is assumed that the slope of the straight line A shows that the phase ψ″(t) increments from 0 to 2π (radian) at each 1/f″ interval. In short, the straight line A has a slope of 2πf″.

The straight line A in FIG. 41 is the same as the straight line A in FIG. 40(b). The horizontal axis in FIG. 41 is the time axis, and the vertical axis is the phase axis. The straight line (straight line B) defined by time and phases ψ(t) in FIG. 41 is a straight line defined by time and phases ψ(t) of the straight line A representing the phases that have not yet been modified by the frequency f′ (the frequency in the frequency band). In other word, the straight line B is calculated by adding 2π (radian) each time a current time point advances by 1/f′ with respect to the straight line A. This straight line B can be regarded to represent the phases ψ(t) of a to-be-extracted sound in the case where the to-be-extracted sound is present in the time-frequency domain, and the current phase ψ(t) shifts from 0 to 2π (radian) at a 1/f (f denotes a reference frequency) time interval at an equal angle speed. The frequency f corresponding to the slope (2πf) of the straight line B is the reference frequency f desired.

In this example, the frequency f′ is smaller than the reference frequency f, and thus the straight line A has a positive slope. In the case where the frequency f′ in the frequency band equals to the reference frequency f, the straight line A has a zero slope, whereas the straight line A has a negative slope in the case where the frequency f′ is higher than the reference frequency f.

Based on the relationship between the straight lines A and B in FIG. 41, the following is derived.

2π(f/f′)=2π+2π(f″/f′) [Expression 35]

This derives the following.

f=(f′+f″) [Expression 36]

More specifically, this shows that the reference frequency f can be presented as a sum of the frequency f′ in the frequency band and the frequency f″ corresponding to the slope (2π″) of the straight line A.

The time required for the modified phase ψ″(t) to increment from 0 (radian) to 2π (radian) is 0.113/0.6 (=1/f″ (seconds)). Thus the straight line A in FIG. 40(b) is presented as f″=5 (Hz), and the reference frequency f is 105 Hz (100 Hz+5 Hz).

Next, the phase distance (ψ′(t)=mod 2π(ψ(t)−2πft) (here, f denotes a reference frequency)) is calculated using the set reference frequency f. The phase distance can be calculated based on the distance between the phase ψ″(t) modified as shown in FIG. 40(b) and the straight line A.

$${ϕ}^{′} ( t ) = mod 2 π ( ϕ ( t ) - 2 π ft ) = mod 2 π ( ϕ ( t ) - 2 π ( {f}^{′} + {f}^{″} ) t ) = mod 2 π ( ( ϕ ( t ) - 2 π {f}^{′} t ) - 2 π {f}^{″} t ) = mod 2 π ( {ϕ}^{″} ( t ) - 2 π {f}^{″} t ) \qquad [ Expression 37 ]$$

This is because the distance (phase distance) between the phase ψ(t) and the straight line B having a slope of 2πf matches the distance between the phase ψ″(t) and the straight line A having a slope of 2πf″ as shown by the above expression.

In this example, the phase distances are calculated as difference errors between the straight line A and the respective phases ψ″(t) of the frequency signals having modified phases at all the time points in the predetermined time width.

It is also good to calculate phase distances considering that the phase values are in a torus (that is, 0 (radian) and 2π (radian) are the same).

From another view point, the straight line A that yields the minimum phase distances is determined. This shows that the reference frequency f determined based on the frequency f″ to the slope of the straight line A is the reference frequency f that is suitable in the time-frequency domain to minimize the phase distances.

The frequency signal determined to be a frequency signal of the engine sound is the frequency signal in the predetermined time width within the range from 2 to 4 times the time window width of the window function yielding a phase distance equal to or smaller than the second threshold value. In this example, the second threshold value is set to be 0.17 (radian). In this example, the whole frequency signal in the predetermined time width is used to calculate a phase distance, and determinations are collectively made on the frequency signals at the respective time segments of the to-be-extracted sound.

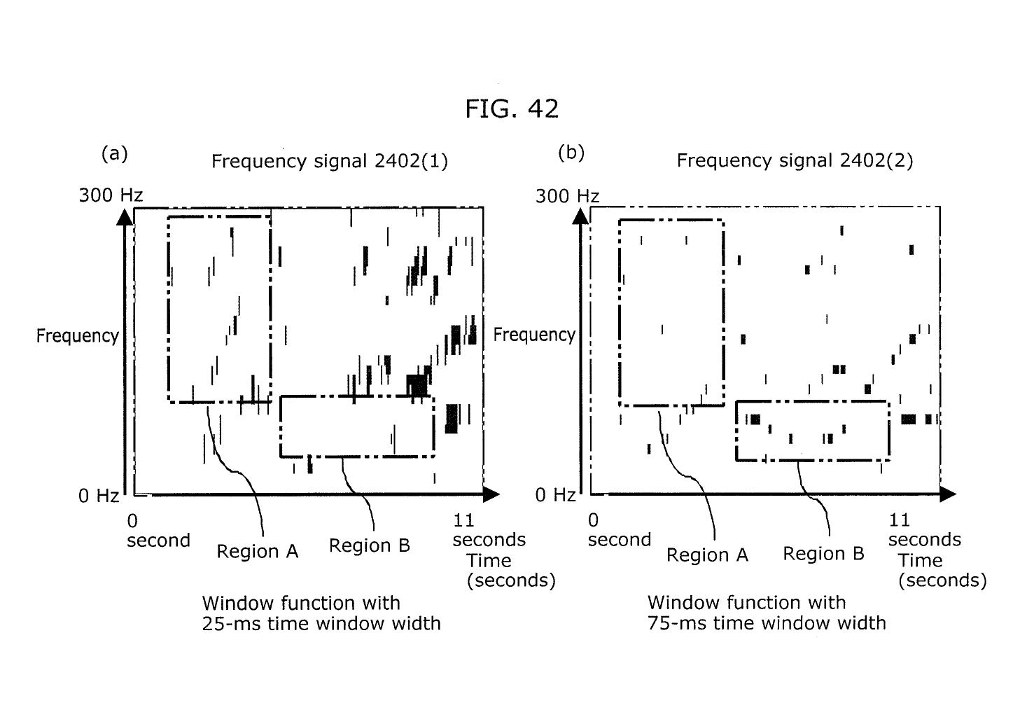

FIG. 42 is a diagram showing an example of a result of determining frequency signals of an engine sound. This shows a result of determining frequency signals of the engine sound from the mixed sound shown in FIG. 39, and the time-frequency portions determined to be frequency signals of the engine sound are presented in black. FIG. 42(a) shows a result of determining frequency signals of the engine sound from the frequency signal 2402(1), and FIG. 42(b) shows a result of determining frequency signals of the engine sound from the frequency signal 2402(2). The horizontal axis is the time axis, and the vertical axis is the frequency axis. Here, the frequency signal 2402(1) is calculated using the window function having a time window width of 25 ms, and the frequency signal 2402(2) is calculated using the window function having a time window width of 75 ms. At this time, the time window widths of the window functions correspond to time resolutions, and the frequency signal 2402(1) has a finer time resolution than that of the frequency signal 2402(2).

With reference to regions A in FIGS. 42(a) and 42(b), it is known that the engine sound has been detected only from the frequency signal 2402(1). This is because the frequency in the engine sound significantly varies with time in each of the time-frequency domains, and thus because the frequency signal 2402(1) having a fine time resolution is suitable for determining the engine sound. With reference to region B in FIGS. 42(a) and 42(b), it is known that the engine sound has been detected only from the frequency signal 2402(2). This is because the frequency in the engine sound slightly varies with time in each of the time-frequency domains, and thus because the frequency signal 2402(2) having a rough time resolution is suitable for determining the engine sound.

These processes are performed on all the frequency bands j (j=1 to M).

Next, the sound detection unit 4104(j) generates and outputs a to-be-extracted sound detection flag 4105 at the time when the to-be-extracted sound determination unit 4103(j) determines that a frequency signal of the engine sound is present in at least one of the mixed sounds 2401(1) and 2401(2) (Step S4302(j)).

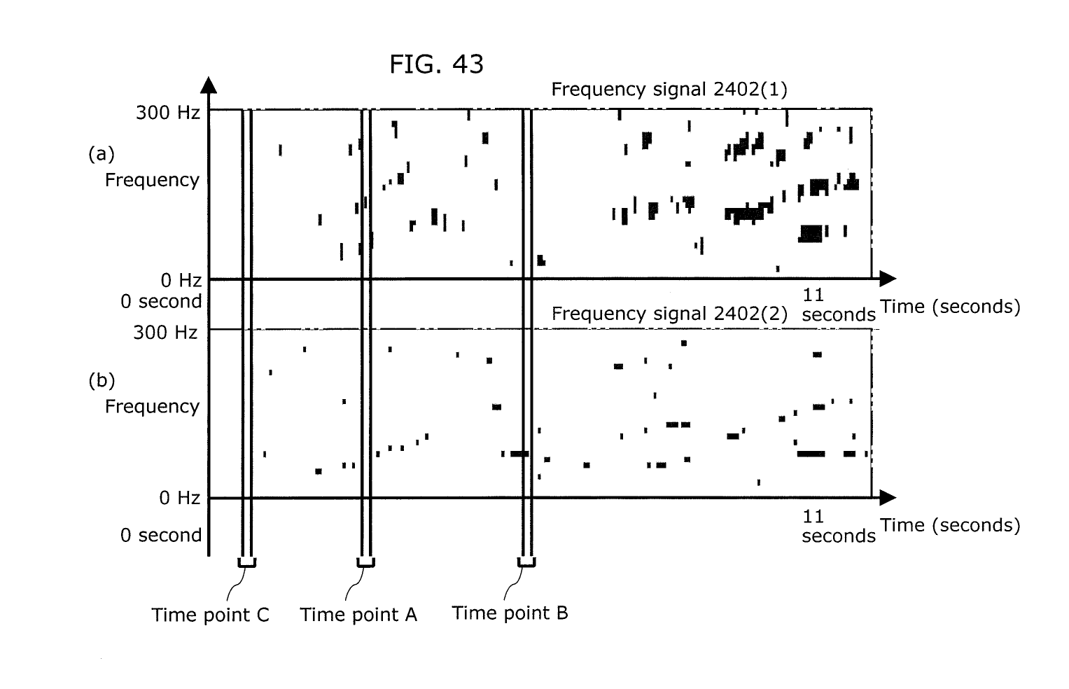

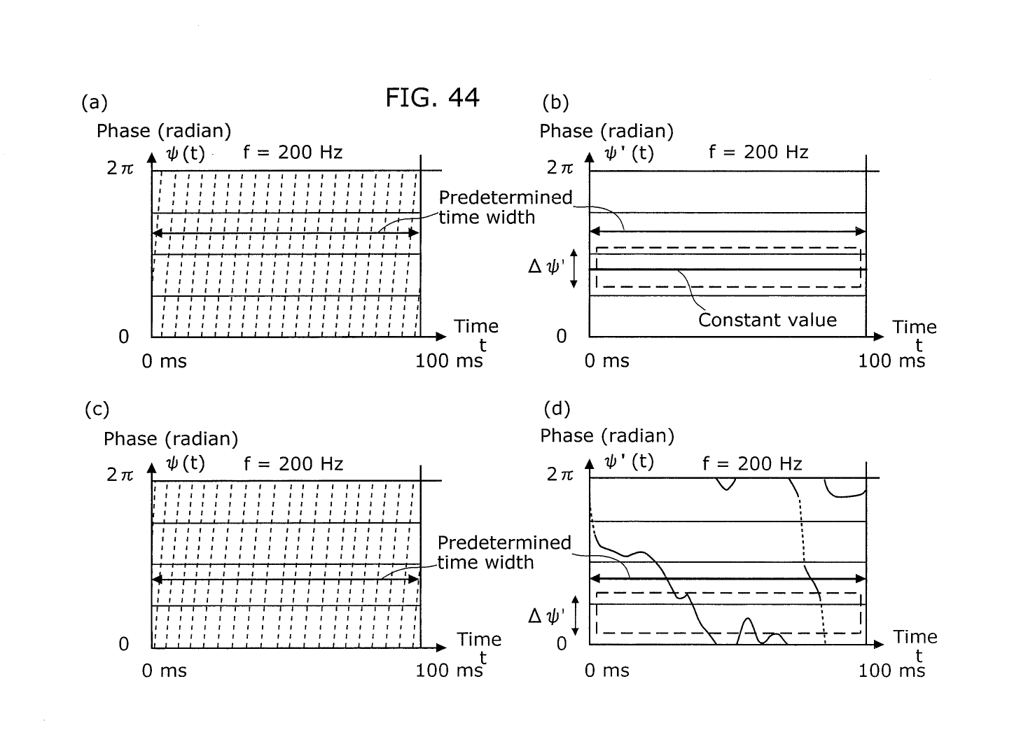

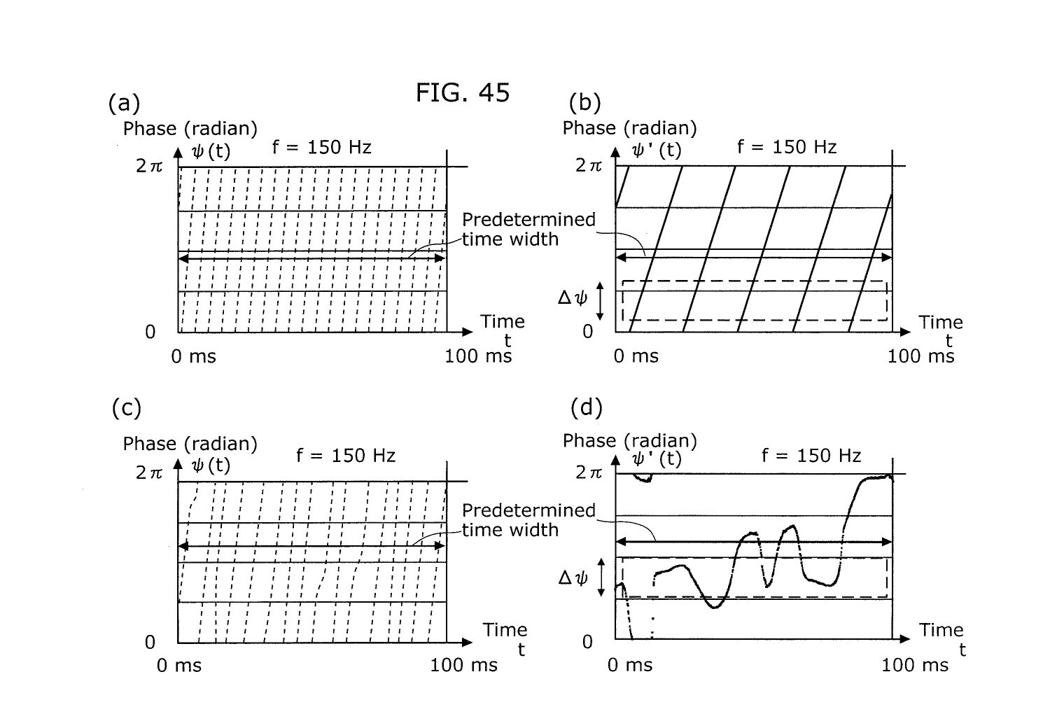

FIG. 43 shows an exemplary method of generating a to-be-extracted sound detection flag 4105. FIG. 43 is a diagram in which FIGS. 42(a) and 42(b) are vertically arranged to show the results along with the corresponding time axes (FIG. 42(a) is in the upper part, and FIG. 42(b) is in the lower part). The vertical axes are the frequency axes, and the horizontal axes are the time axes. The time-frequency portions determined to be frequency signals of the engine sound are presented in black. In this example, the overall results of determinations in the 10- to 300-Hz frequency band in which the motorbike engine sound is present are used to determine, for each 200-ms time segment, whether or not to generate and output a to-be-extracted sound detection flag 4105.

At the time point A in FIG. 43, frequency signals of the engine sound are detected from the mixed sound 2401(1) in FIG. 43(a). In contrast, no frequency signal of the engine sound is detected from the mixed sound 2401(2) in FIG. 43(b). In this case, a frequency signal of the engine sound has been detected from at least the mixed sound 2401(1) in FIG. 43(a), which shows the presence of an approaching vehicle. Thus, a to-be-extracted sound detection flag 4105 is generated and outputted.

At the time point B in FIG. 43, a frequency signal of the engine sound is detected from the mixed sound 2401(1) in FIG. 43(a). In contrast, no frequency signal of the engine sound is detected from the mixed sound 2401(2) in FIG. 43(b). In this case, a frequency signal of the engine sound has been detected from at least the mixed sound 2401(2) in FIG. 43(a), which shows the presence of an approaching vehicle. Thus, a to-be-extracted sound detection flag 4105 is generated and outputted.

At the time point C in FIG. 43, a frequency signal of the engine sound is detected from the mixed sound 2401(1) in FIG. 43(a). In contrast, no frequency signal of the engine sound is detected from the mixed sound 2401(2) in FIG. 43(b). In this case, the result of determination shows absence of an approaching vehicle, and no to-be-extracted sound detection flag 4105 is generated.

It is possible to set the time segment by which a to-be-extracted sound detection flag 4105 is generated, independently of the predetermined time width by which each phase distance is calculated.

Lastly, the presentation unit 4106 notifies a driver of the presence of the approaching vehicle upon input of the to-be-extracted sound detection flag 4105 (Step S4303).

These processes are performed with time shifts in the predetermined time width.

With this structure, it is possible to determine in advance a reference frequency suitable for determining a to-be-extracted sound on a per time-frequency domain basis. This eliminates the need to calculate the phase distances of a number of reference frequencies before determining frequency signals of a to-be-extracted sound. This significantly reduces the processing amount required for phase distance calculation.

In addition, it is possible to determine a time width used to calculate a phase distance based on the time resolution (the time window width of the window function), thereby making it possible to determine frequency signals of the to-be-extracted sound using various time resolutions. In particular, the use of suitable time resolutions makes it possible to accurately determine a frequency signal of the to-be-extracted sound particularly in the case of determining the to-be-extracted sound having a temporally varying frequency structure. For example, a fine time resolution is used to determine frequency signals of a to-be extracted sound such as a voice having a frequency structure which varies significantly and quickly, and a large time resolution (fine frequency resolutions) is used to determine frequency signals of a to-be-extracted sound such as an engine sound during an idle running state having a frequency structure which varies slowly.

This increases the possibility that, even when a microphone cannot detect a to-be-extracted sound from a received mixed sound due to an influence of noises, another microphone can detect the to-be-extracted sound. For this reason, the number of detection errors can be reduced. In this example, it is possible to use such mixed sound that is less affected by a wind noise because the mixed sound has been received through a microphone disposed to reduce the influence. For this, it is possible to accurately detect an engine sound as a to-be-extracted sound, and notify a driver of the presence of an approaching vehicle. The number of microphones used in this example is two, but three or more microphones may be used to determine frequency signals of a to-be-extracted sound.

Whether or not the respective whole frequency signals are frequency signals of the to-be-extracted sound is determined altogether by calculating the phase distances of the plural frequency signals altogether, and comparing each of the phase distances with the second threshold value. For this, it is possible to steadily determine frequency signals of a to-be-extracted sound even when the phase of a noise accidentally matches the phase of the to-be-extracted sound.

It should be noted that the to-be-extracted sound determination unit in one of Embodiments 1 and 2 may be used in the vehicle detection device according to Embodiment 3. It should be noted that the to-be-extracted sound determination unit in Embodiment 3 may be used in Embodiments 1 and 2.

(Method of Determining Frequency Signals of Sounds to be Extracted, Based on Mixed Sound)

The method summarized here is a method of determining frequency signals of sounds to be extracted, based on another mixed sound.

(I) A description is given of a method of determining a 200-Hz sine wave (a 200-Hz frequency signal), based on a mixed sound of the 200-Hz sine wave and a white noise.

FIG. 44 shows a result obtained by analyzing the temporal phase variation when the reference frequency f is 200 Hz in the frequency band having a center frequency f of 200 Hz. FIG. 45 shows a result obtained by analyzing the temporal phase variation when the reference frequency f is 150 Hz in the frequency band having a center frequency f of 150 Hz. In these examples, the predetermined time width used to calculate the phase distances is set to 100 ms, and the temporal phase variation in the time width of 100 ms is analyzed. Each of FIGS. 44 and 45 shows the analysis result obtained using the 200-Hz sine wave and the white noise.

FIG. 44(a) shows the temporal variation in the phase ψ(t) (with no phase modification) of the 200-Hz sine wave. In this time width, the phase ψ(t) of the 200-Hz sine wave cyclically shifts at a slope of 2π×200 with respect to time. FIG. 44(b) shows that the phase ψ(t) shown in FIG. 44(a) is modified to the phase ψ′(t) according to the expression ψ′(t)=mod 2π(ψ(t)−2π×200×t) (where the reference frequency is 200 Hz). It can be seen that the phase ψ′(t) of the 200-Hz sine wave having a modified phase remains constant regardless of time. On account of this, the phase distance in a distance space defined by the expression ψ′(t)=mod 2π(ψ(t)−2π×200×t) (where the reference frequency is 200 Hz) in this time width is small.

FIG. 44(c) shows the temporal variation in the phase ψ(t) (with no phase modification) of the white noise. In this time width, the phase ψ(t) of the white noise seems to cyclically shift at a slope of 2π×200 with respect to time, but actually the phase does not cyclically shift in a precise sense. FIG. 44(d) shows that the phase ψ(t) shown in FIG. 44(c) is modified to the phase according to the expression ψ′(t)=mod 2π(ψ(t)−2π×200×t) (where the reference frequency is 200 Hz). It can be seen that the phase ψ′(t) of the white noise having a modified phase varies within a range from 0 to 2π (radian) over the course of time. On account of this, the phase distance in a distance space defined by the expression ψ′(t)=mod 2π(ψ(t)−2π×200×t) (where the reference frequency is 200 Hz) in this time width is greater than the phase distance of the 200-Hz sine wave shown in FIG. 44(a) or FIG. 44(b).

FIG. 45(a) shows the temporal variation in the phase ψ(t) (with no phase modification) of the 200-Hz sine wave. In this time width, the phase ψ(t) of the 200-Hz sine wave does not cyclically shifts at a slope of 2π×150 with respect to time (but does vary at a slope of 2π×200 with respect to time). FIG. 45(b) shows that the phase φ(t) shown in FIG. 45(a) is modified to the phase according to the expression ψ′(t)=mod 2π(ψ(t)−2π×150×t) (where the reference frequency is 150 Hz). It can be seen that the phase ψ(t) of the 200-Hz sine wave having a modified phase cyclically shifts within a range from 0 to 2π (radian) over the course of time. On account of this, the phase distance in a distance space defined by the expression ψ′(t)=mod 2π(ψ(t)−2π×150×t) (where the reference frequency is 150 Hz) in this time width is greater than the phase distance of the 200-Hz sine wave shown in FIG. 44(a) or FIG. 44(b).

FIG. 45(c) shows the temporal variation in the phase ψ(t) (with no phase modification) of the white noise. In this time width, the phase ψ(t) of the white noise does not vary at a slope of 27π×150 with respect to time. FIG. 45(d) shows that the phase ψ′(t) shown in FIG. 45(c) is modified to the phase according to the expression ψ′(t)=mod 2π(ψ(t)−2π×150×t) (where the reference frequency is 150 Hz). It can be seen that the phase ψ′(t) of the white noise having a modified phase varies within a range from 0 to 2π (radian) over the course of time. On account of this, the phase distance in a distance space defined by the expression ψ′(t)=mod 2π(ψ(t)−2π×150×t) (where the reference frequency is 150 Hz) in this time width is greater than the phase distance of the 200-Hz sine wave shown in FIG. 45(a) or FIG. 45(b).

From the analysis results shown in FIGS. 44 and 45, when the 200-Hz sine wave and the white noise are separated and the frequency signal of the 200-Hz sine wave is thus determined, the second threshold value is set so as to be: greater than the phase distance of the 200-Hz sine wave shown in FIG. 44(a) or FIG. 44(b); smaller than the phase distance of the white noise shown in FIG. 44(c) or FIG. 44(d); smaller than the phase distance of the 200-Hz sine wave shown in FIG. 45(a) or FIG. 44(b); and smaller than the phase distance of the white noise shown in FIG. 45(c) or FIG. 45(d). For example, it can be understood that the second threshold value may be set according to the expression Δψ′=π/6 to π/2 (radian) as shown in FIG. 44(b), FIG. 44(d), FIG. 45(b), and FIG. 45(d). Here, the frequency signal which is not determined to be of the to-be-extracted sound is the frequency signal of the white noise.

It should be noted that the 200-Hz frequency signal of the to-be-extracted sound can be determined, based on a mixed sound of the frequency band (including the 200-Hz frequency) having a center frequency of 150 Hz. In FIG. 45(a), the only process to follow is to determine the phase distance according to the expression ψ′(t)=mod 2π(ψ(t)−2π×200×t) (where the reference frequency is 200 Hz), using the reference frequency of 200 Hz.

(II) A description is given of a method of determining a frequency signal of a motorbike sound based on a mixed sound including the motorbike sound (engine sound) and a background noise. In this example, the second threshold value is set to π/2.

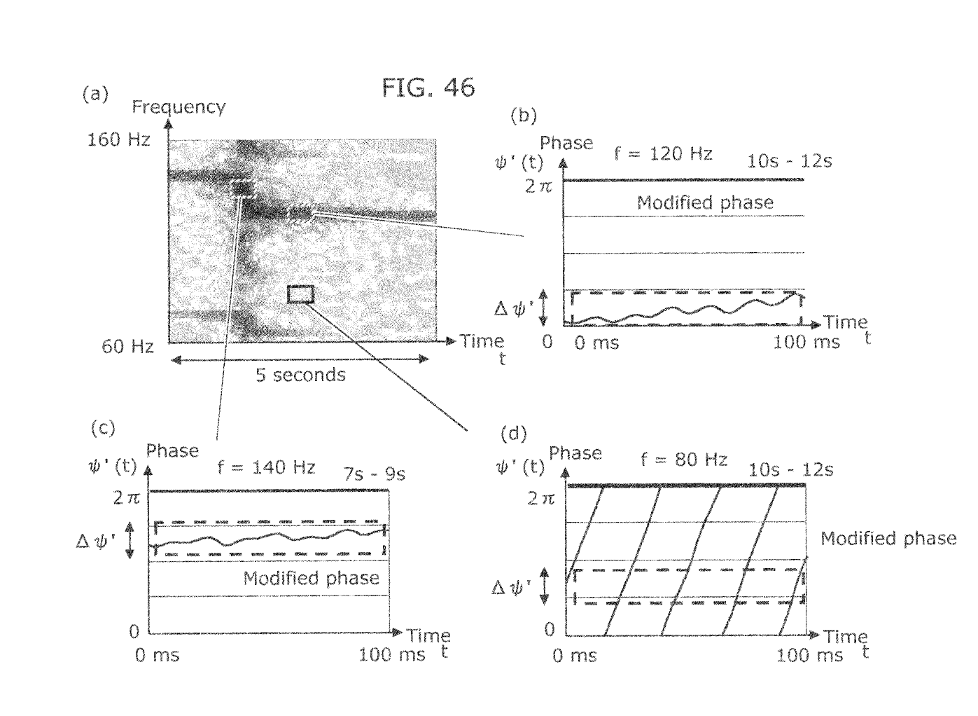

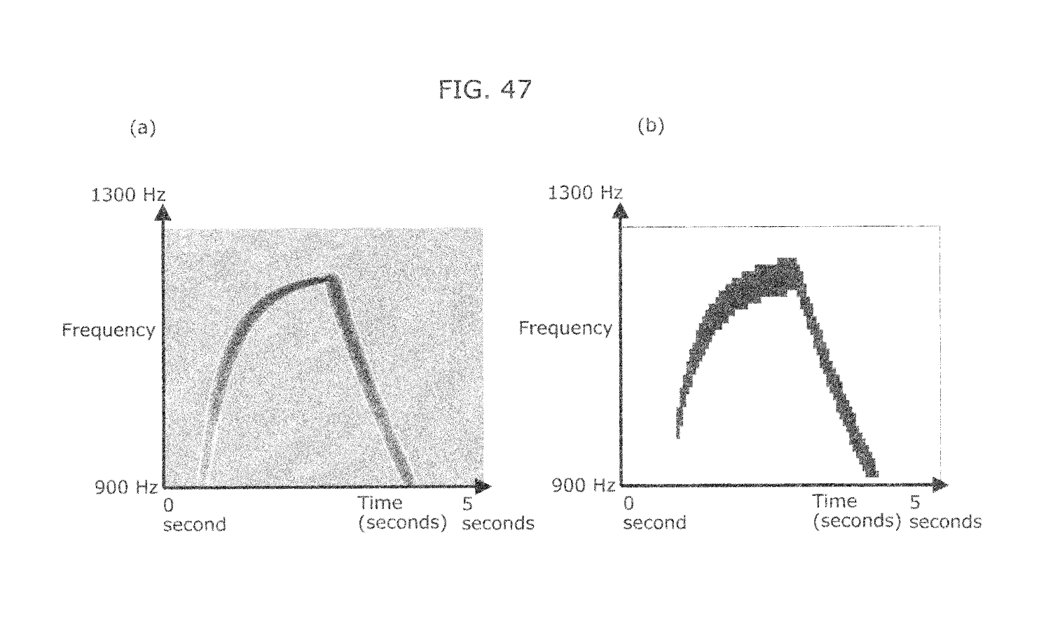

FIG. 46 shows a result obtained by analyzing the temporal variation in the phase of the motorbike sound. FIG. 46(a) shows a spectrogram of the motorbike sound, darker parts indicating the frequency signals of the motorbike sound. The Doppler shift heard when the motorbike passed by is shown. Each of FIGS. 46(b), 46(c), and 46(d) shows the temporal variation in the phase ψ′(t) when the phase modification is performed.

FIG. 46(b) shows an analysis result obtained when the reference frequency is set to 120 Hz, using the frequency signal of the 120-Hz frequency band. The phase distance of the phase ψ′(t) at this time in a time width of 100 ms (the predetermined time width) is equal to or smaller than the second threshold value. Thus, the frequency signal of this time-frequency domain is determined to be a frequency signal of the motorbike sound. Moreover, since the reference frequency is 120 Hz, the determined frequency signal of the motorbike sound can be determined to have a frequency of 120 Hz.

FIG. 46(c) shows an analysis result obtained when the reference frequency is set to 140 Hz, using the frequency signal of the 140-Hz frequency band. The phase distance of the phase ψ′(t) at this time in a time width of 100 ms (the predetermined time width) is equal to or smaller than the second threshold value. Thus, the frequency signal of this time-frequency domain is determined to be a frequency signal of the motorbike sound. Moreover, since the reference frequency is 140 Hz, the determined frequency signal of the motorbike sound can be determined to have a frequency of 140 Hz.

FIG. 46(d) shows an analysis result obtained when the reference frequency is set to 80 Hz, using the frequency signal in the 80-Hz frequency band. The phase distance of the phase ψ′(t) at this time in a time width of 100 ms (the predetermined time width) is greater than the second threshold value. Thus, it is determined that the frequency signal of this time-frequency domain is not a frequency signal of the motorbike sound.

(III) With reference to FIGS. 44 and 46, descriptions are given of: a method of determining frequency signals of a 200-Hz sine wave and a motorbike sound, based on a mixed sound of the motorbike sound (the engine sound), the 200-Hz sine wave, and a white noise; a method of determining a frequency signal of the 200-Hz sine wave, based on the mixed sound; a method of determining a frequency signal of the motorbike sound, based on the mixed sound; and a method of determining a frequency signal of the white noise, based on the mixed sound. In this example, the predetermined time width is set to 100 ms.

First, a description is given of the method of determining the frequency signal of the 200-Hz sine wave and the motorbike sound, in distinction from the white noise. Here, the second threshold value is set to π/2 (radian).

Here, from the analysis result shown in FIG. 44 and the analysis result shown in FIG. 46, the phase distance of the white noise is greater than the second threshold value, and each of the phase distances of the 200-Hz sine wave and the motorbike sound is equal to or smaller than the second threshold value. This makes it possible to determine the frequency signal of the 200-Hz sine wave and the motorbike sound, in distinction from the white noise.

Second, a description is given of the method of determining the frequency signal of the 200-Hz sine wave and the motorbike sound, in distinction from the white noise. Here, the second threshold value is set to π/6 (radian).

Here, from the analysis result shown in FIG. 44, the phase distance of the white noise is greater than the second threshold value, and the phase distance of the 200-Hz sine wave is equal to or smaller than the second threshold value. This makes it possible to determine the frequency signal of the 200-Hz sine wave, in distinction from the white noise. Moreover, from the analysis result shown in FIG. 46, the phase distance of the motorbike sound is larger than the second threshold value in this example. This makes it possible to determine the frequency signal of the 200-Hz sine wave, in distinction from the motorbike sound.

Next, a description is given of the method of determining the frequency signal of the motorbike sound, in distinction from the white noise and the 200-Hz sine wave. In this example, the second threshold value is set to π/6 (radian), and the third threshold value is set to π/2 (radian).

First, the second threshold value is set to π/2 (radian). At this time, the frequency signal including both the motorbike sound and the 200-Hz sine wave is determined based on the analysis result shown in FIG. 44 and the analysis result shown in FIG. 46. Next, the second threshold value is set to π/6 (radian). Then, the frequency signal of the 200-Hz sine wave is determined based on the analysis result shown in FIG. 44 and the analysis result shown in FIG. 46. Lastly, by removing the frequency signal determined to be the 200-Hz sine wave from the frequency signal including both the motorbike sound and the 200-Hz sine wave, the frequency signal of the motorbike sound is determined.

Next, a description is given of the method of determining the frequency signal of the white noise, in distinction from the 200-Hz sine wave and the motorbike sound. In this example, the second threshold value is set to 2π (radian). Here, from the analysis result shown in FIG. 44 and the analysis result shown in FIG. 46, the phase distance of the white noise is larger than the second threshold value, and each of the phase distances of the 200-Hz sine wave and the motorbike sound is equal to or smaller than the second threshold value. Thus, by extracting the frequency signal having a phase distance greater than the second threshold value, the frequency signal of the white noise can be determined.

(IV) A description is given of a method of determining a frequency signal of a siren sound from a mixed sound including the siren sound and a background noise.

In this example, the frequency signal of the siren sound is determined for each time-frequency domain, using the same method as described in Embodiment 3. A DFT time window is 13 ms in this example. The frequency signal is obtained by dividing the frequency band ranging from 900 to 1300 Hz into segments at a 10-Hz interval. In this example, the predetermined time width is set to 38 ms, and the second threshold value is set to 0.03 (radian). The first threshold value is the same as in Embodiment 3.

FIG. 47(a) shows a spectrogram of the mixed sound including the siren sound and the background sound. The way of presentation in FIG. 47(a) is the same as in FIG. 40(a), and thus no detailed description thereof is repeated. FIG. 47(b) shows a result obtained by determining the siren sound, based on the mixed sound shown in FIG. 47(a). The way of presentation in FIG. 47(b) is the same as in FIG. 42(a), and thus no detailed description thereof is repeated. From the result shown in FIG. 47(b), it can be seen that the frequency signal of the siren sound is determined for each time-frequency domain.

(V) A description is given of a method of determining a frequency signal of a voice, based on a mixed sound including the voice and a background noise.

In this example, the frequency signal of the voice is determined for each time-frequency domain, using the same method as described in Embodiment 3. A DFT time window is 6 ms in this example. The frequency signal is obtained by dividing the frequency band ranging from 0 to 1200 Hz into segments at a 10-Hz interval. In this example, the predetermined time width is set to 19 ms, and the second threshold value is set to 0.09 (radian). The first threshold value is the same as in Embodiment 3.

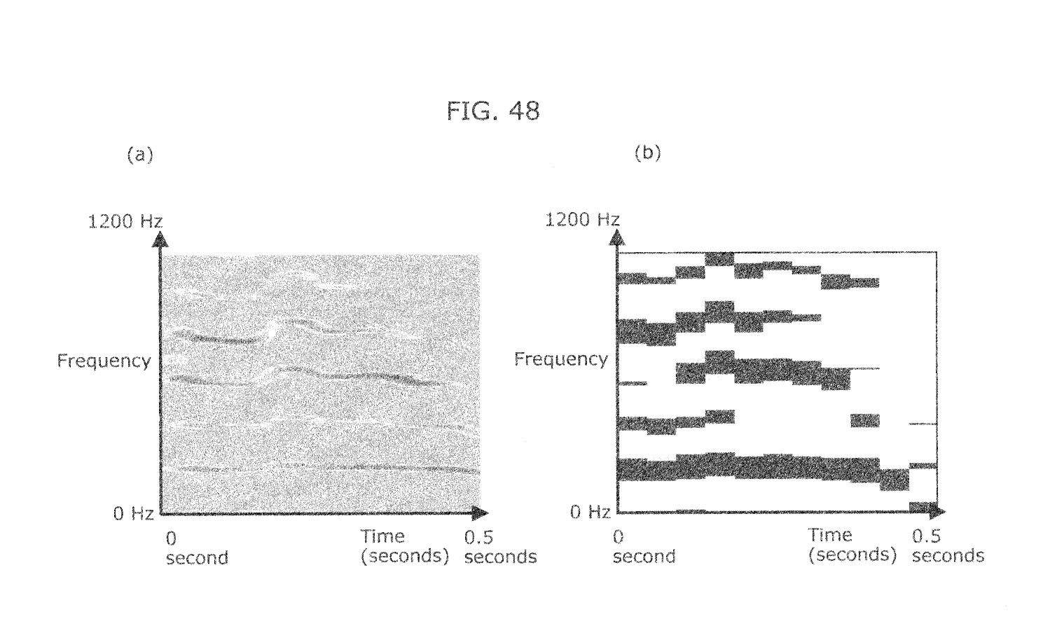

FIG. 48(a) shows a spectrogram of the mixed sound including the voice and the background sound. The way of presentation in FIG. 48(a) is the same as in FIG. 40(a), and thus no detailed description thereof is repeated. FIG. 48(b) shows a result obtained by determining the voice, based on the mixed sound shown in FIG. 48(a). The way of presentation in FIG. 48(b) is the same as in FIG. 42(a), and thus no detailed description thereof is repeated. From the result shown in FIG. 48(b), it can be seen that the frequency signal of the voice is determined for each time-frequency domain.

(VI) A description is given of a result obtained by determining a frequency signal of a 100-Hz sine wave and a white noise.

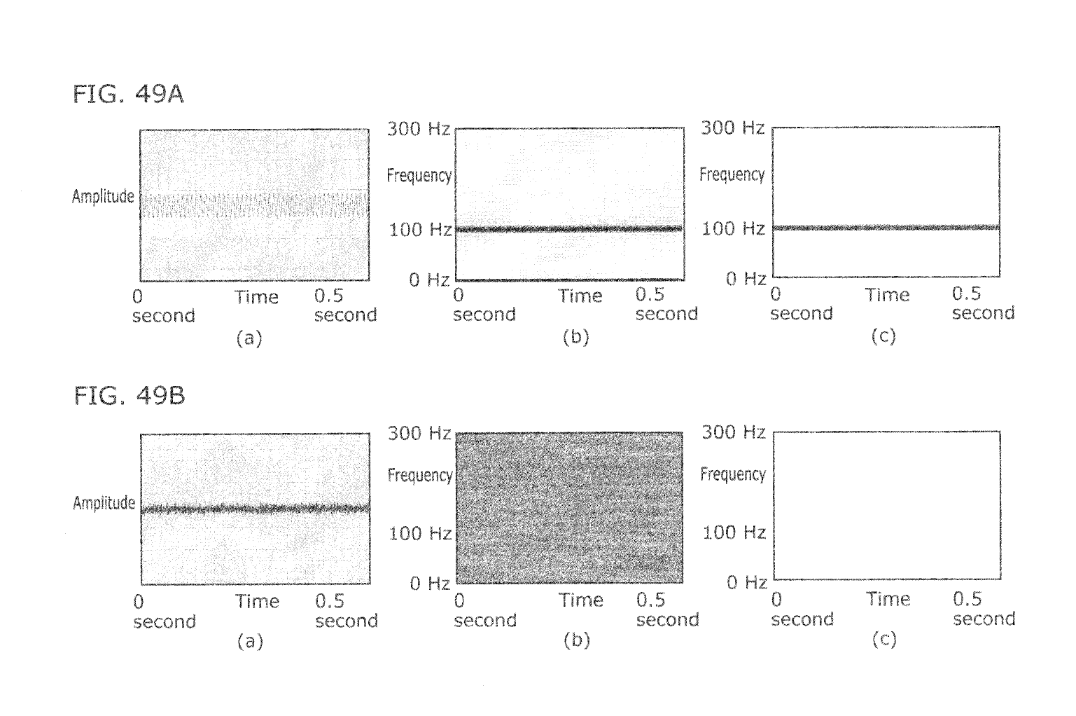

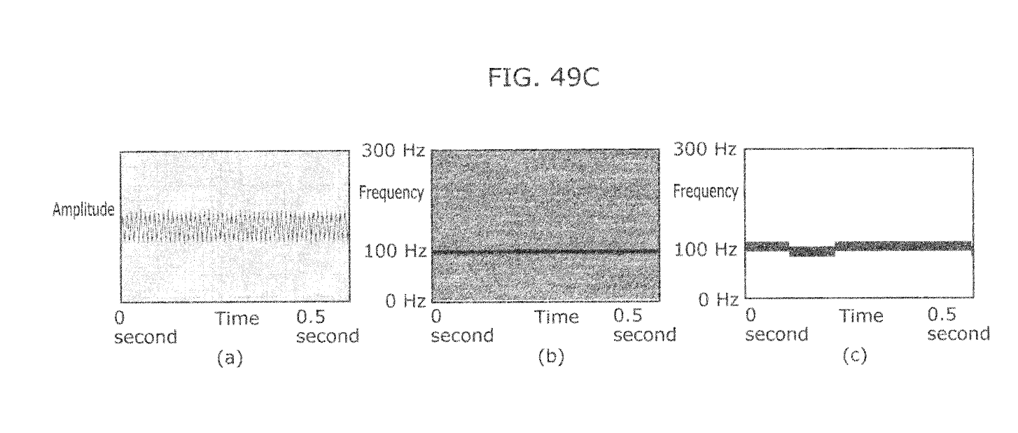

FIG. 49A is a diagram showing a detection result obtained when a 100-Hz sine wave is received. FIG. 49A(a) is a graph showing an audio waveform of the input sound. The horizontal axis represents time, and the vertical axis represents amplitude. FIG. 49A(b) is a spectrogram of the audio waveform of the sound shown in FIG. 49A(a). The way of presentation is the same as in FIG. 10, and thus no detailed description thereof is repeated. FIG. 49A(c) is a graph showing a detection result obtained when the input is the audio waveform shown in FIG. 49A(a). The way of presentation is the same as in FIG. 42(a), and thus no detailed description thereof is repeated. From FIG. 49A(c), it can be seen that the frequency signal of the 100-Hz sine wave is detected. FIG. 49B shows a detection result obtained when the input is the white noise. FIG. 49B(a) is a graph showing an audio waveform of the input sound. The horizontal axis presents time, and the vertical axis presents amplitude. FIG. 49B(b) is a spectrogram of the audio waveform of the sound shown in FIG. 49B(a). The way of presentation is the same as in FIG. 10, and thus no detailed description thereof is repeated. FIG. 49B(c) is a graph showing a detection result obtained when the input is the audio waveform shown in FIG. 49B(a). The way of presentation is the same as in FIG. 42(a), and thus no detailed description thereof is repeated. From FIG. 49B(c), it can be seen that the white noise is not detected.

FIG. 49C is a diagram showing a detection result obtained when the input is a mixed sound including the input sine wave of 100 Hz and the white noise. FIG. 49C(a) is a graph showing an audio waveform of the input mixed sound. The horizontal axis presents time, and the vertical axis presents amplitude. FIG. 49C(b) is a spectrogram of the audio waveform shown in FIG. 49C(a). The way of presentation is the same as in FIG. 10, and thus no detailed description thereof is repeated. FIG. 49C(c) is a diagram showing a detection result obtained when the input is the audio waveform shown in FIG. 49C(a). The way of presentation is the same as in FIG. 42(a), and thus no detailed description thereof is repeated. From FIG. 49C(c), it can be seen that the frequency signal of the 100-Hz sine wave is detected, and that no white noise is detected.

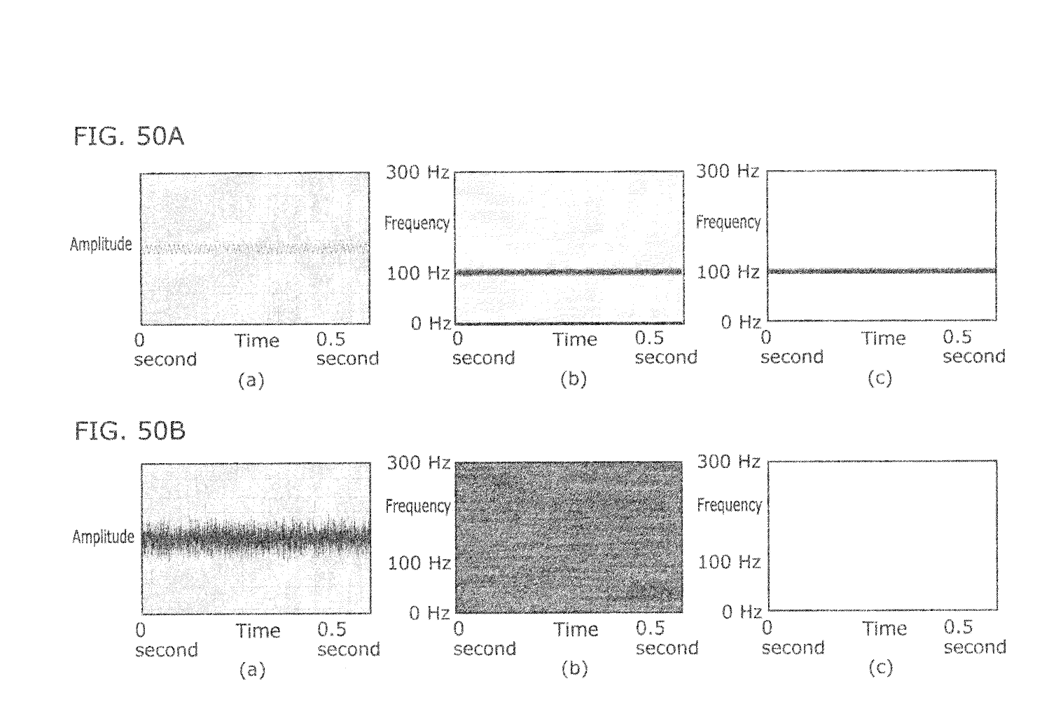

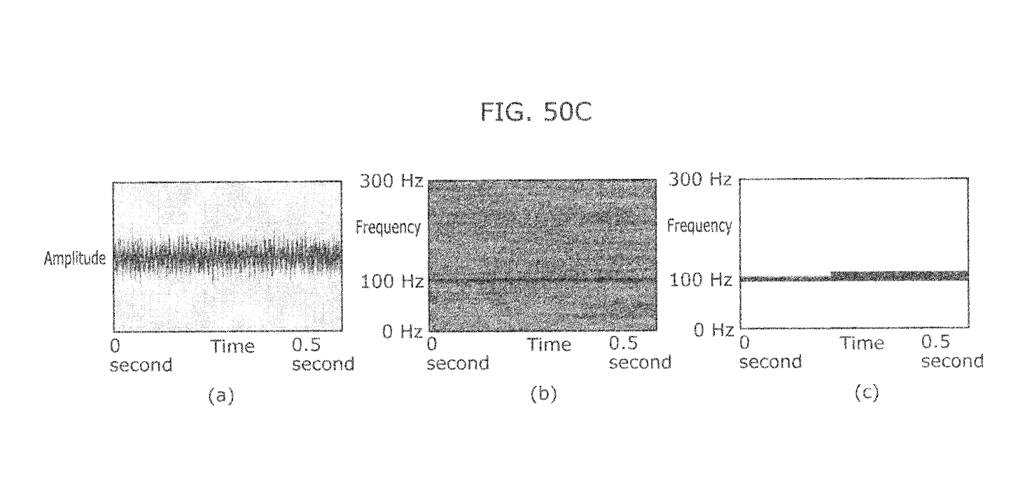

FIG. 50A is a diagram showing a detection result obtained when an input 100-Hz sine wave is smaller in amplitude than the wave shown in FIG. 49A. FIG. 50A(a) is a graph showing an audio waveform of the input sound. The horizontal axis represents time, and the vertical axis represents amplitude. FIG. 50A(b) is a spectrogram of the waveform of the sound shown in FIG. 50A(a). The way of presentation is the same as in FIG. 10, and thus no detailed description thereof is repeated. FIG. 50A(c) is a graph showing a detection result obtained when the input is the audio waveform shown in FIG. 50A(a). The way of presentation is the same as in FIG. 42(a), and thus no detailed description thereof is repeated. From FIG. 50A(c), it can be seen that the frequency signal of the 100-Hz sine wave is detected. As compared with the result shown in FIG. 49A, it can be seen that the frequency signal of the sine wave can be detected independently of the amplitude of the audio waveform of the input sound.

FIG. 50B shows a detection result obtained when the input is the white noise which is larger in amplitude than the white noise shown in FIG. 49B. FIG. 50B(a) is a graph showing an audio waveform of the input sound. The horizontal axis represents time, and the vertical axis represents amplitude. FIG. 50B(b) is a spectrogram of the audio waveform of the sound shown in FIG. 50B(a). The way of presentation is the same as in FIG. 10, and thus no detailed description thereof is repeated. FIG. 50B(c) is a graph showing a detection result obtained when the input is the audio waveform shown in FIG. 50B(a). The way of presentation is the same as in FIG. 42(a), and thus no detailed description thereof is repeated. From FIG. 50B(c), it can be seen that the white noise is not detected. As compared with the result shown in FIG. 49A, it can be seen that the white noise is not detected independently of the amplitude of the audio waveform of the input sound.

FIG. 50C is a diagram showing a detection result obtained when the input is a mixed sound including a sine wave of 100 Hz and a white noise having an S/N ratio different from the ratio shown in FIG. 49B. FIG. 50C(a) is a graph showing an audio waveform of the input mixed sound. The horizontal axis represents time, and the vertical axis represents amplitude. FIG. 50C(b) is a spectrogram of the audio waveform shown in FIG. 50C(a). The way of presentation is the same as in FIG. 10, and thus no detailed description thereof is repeated. FIG. 50C(c) is a diagram showing the detection result obtained when the input is the audio waveform shown in FIG. 50C(a). The way of presentation is the same as in FIG. 42(a), and thus no detailed description thereof is repeated. From FIG. 50C(c), it can be seen that the frequency signal of the 100-Hz sine wave is detected, and that no white noise is detected. As compared with the result shown in FIG. 49A, it can be seen that the frequency signal of the sine wave can be detected independently of the amplitude of the audio waveform of the input sound.

(Setting Time Length as Predetermined Time Width used for Phase Distance Calculation)

A description is given of a case where it is possible to appropriately determine frequency signals of a to-be-extracted sound by setting the time length corresponding to a predetermined time width used to calculate phase distances to a length within a range from 2 to 4 times the time window widths of window functions.

For example, in the case where the frequency structure of a to-be-extracted sound varies significantly with time, it is possible to follow the variation in the frequency structure by reducing the time window width (corresponding to a time resolution) of the window function (in other words, by increasing a frequency resolution). In the case where the time length set as the time width (predetermined time width) used to calculate a phase distance is equal to or more than 4 times the time window width of the window function, the frequency structure of the to-be-extracted sound is outside this time-frequency domain, and the phase distance thereof is greater than a second threshold value. This disables determination of the frequency signals of the to-be-extracted sound. In contrast, in the case where the time length set as the time width (predetermined time width) used to calculate a phase distance falls below 2 times the time window width of the window function, the phase of the frequency signal is smoothed in the time widow width of the window function at the time of calculating the frequency signal. This disables analysis of the time structure of phases. For this reason, it is necessary to set a time length within a range from 2 to 4 times the time window width of the window function as the predetermined time width used to calculate the phase distance.

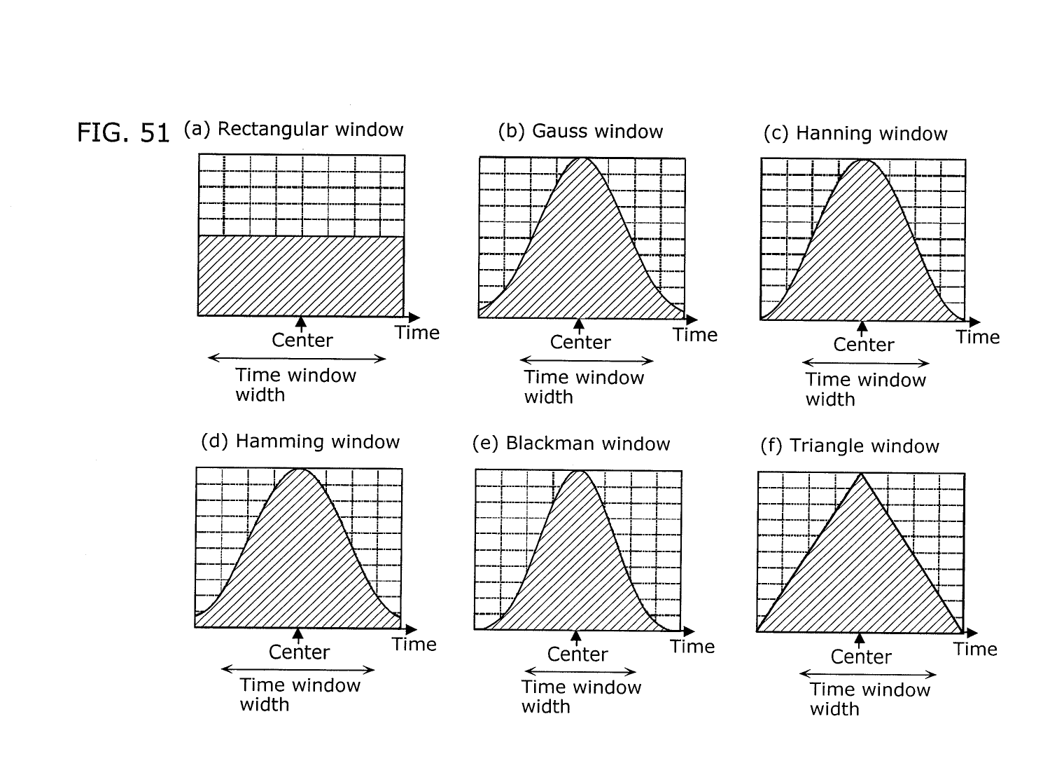

FIG. 51 shows examples of window functions. FIGS. 51(a), 51(b), 51(c), 51(d), 51(e), and 51(f) show a rectangular window, a Gauss window, a Hanning window, a Hamming window, a Blackman window, a triangle window, respectively. The horizontal axes represent time axes, and the vertical axes represent magnitudes in amplitude.

A time window width of a window function is a time width that has a center time point as the gravity of the window function and accounts for 90 percent of a window function size. In the case of each of the window functions in FIG. 51, the time window width of the window function is the time width corresponding to 90 percent of the dark portion having the center time point shown in the diagram.

When the mixed sound received by the frequency analysis unit is X(t), and the window function having a predetermined time window width is w(t), the mixed sound multiplied by the window function X′(t) is as presented below.

X′(t)=w(t)X(t) [Expression 38]

Here, the time axis is scaled so that the window function w(t) corresponds to the predetermined time window width. The mixed sound in this time window width is used to determine the frequency signal, and the time window width corresponds to the time resolution of the frequency signal. Hereinafter, a Hunning window is used as an example of window functions.

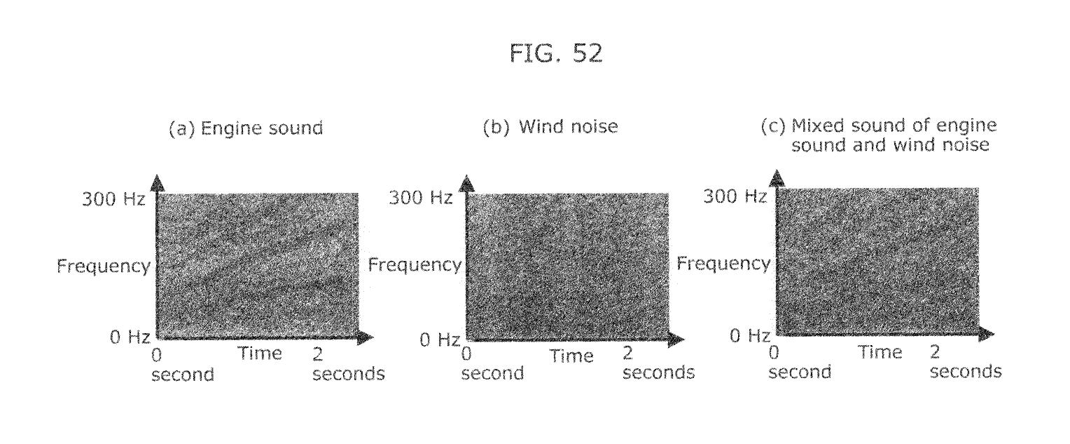

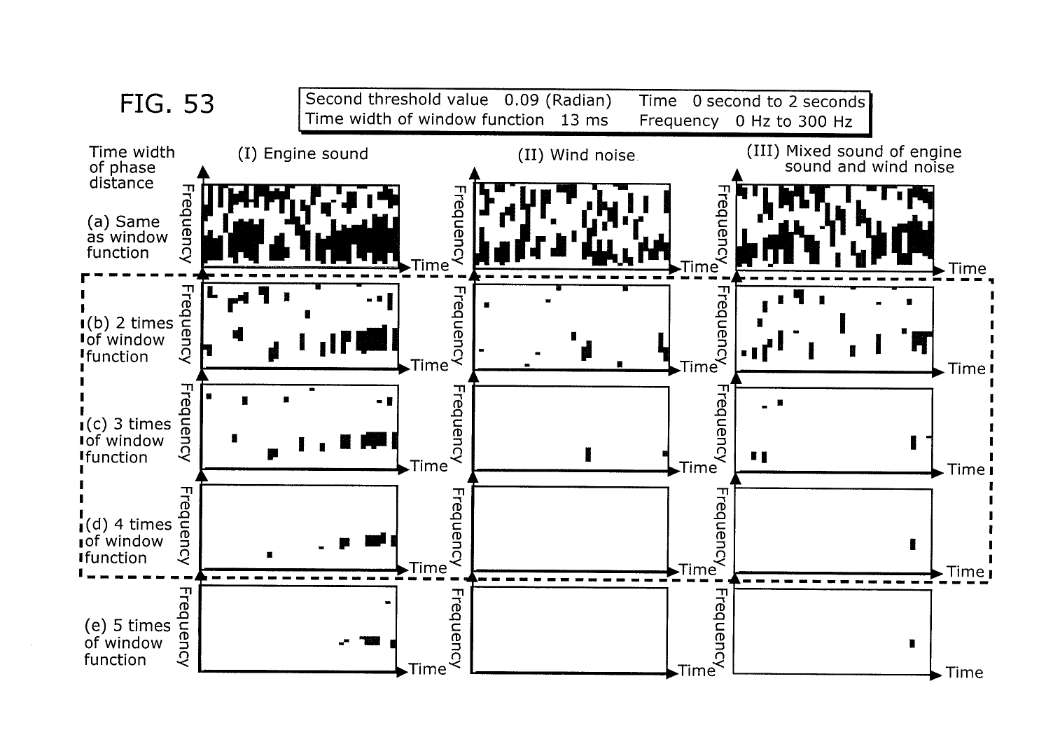

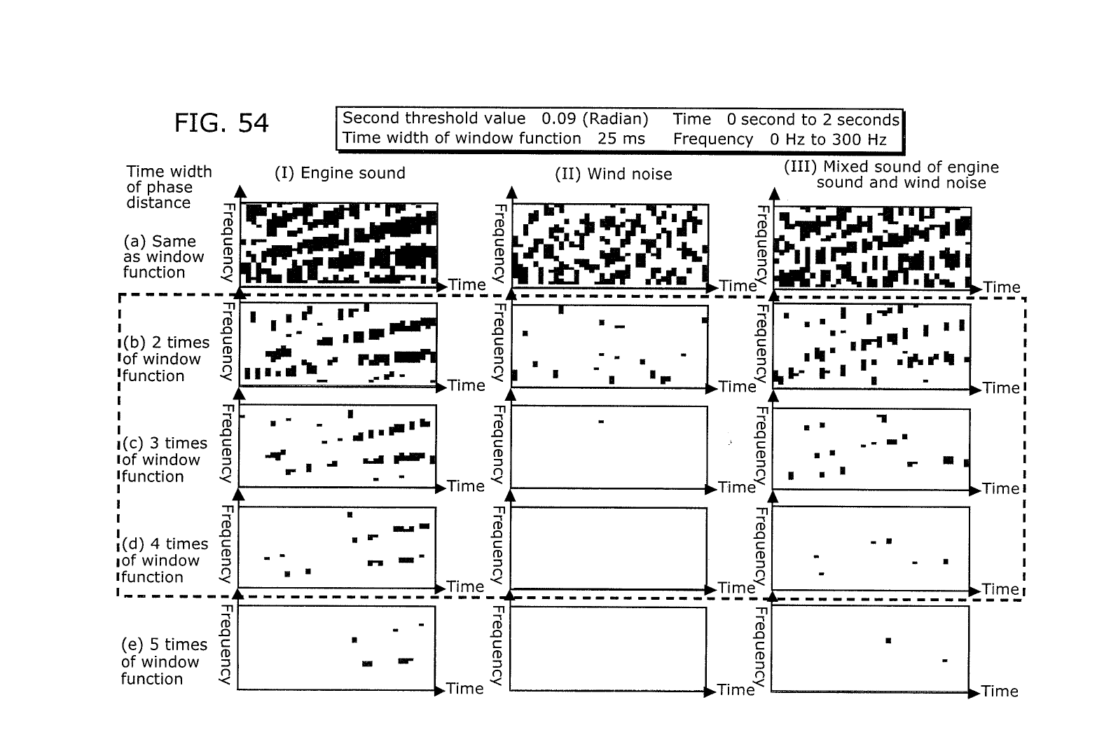

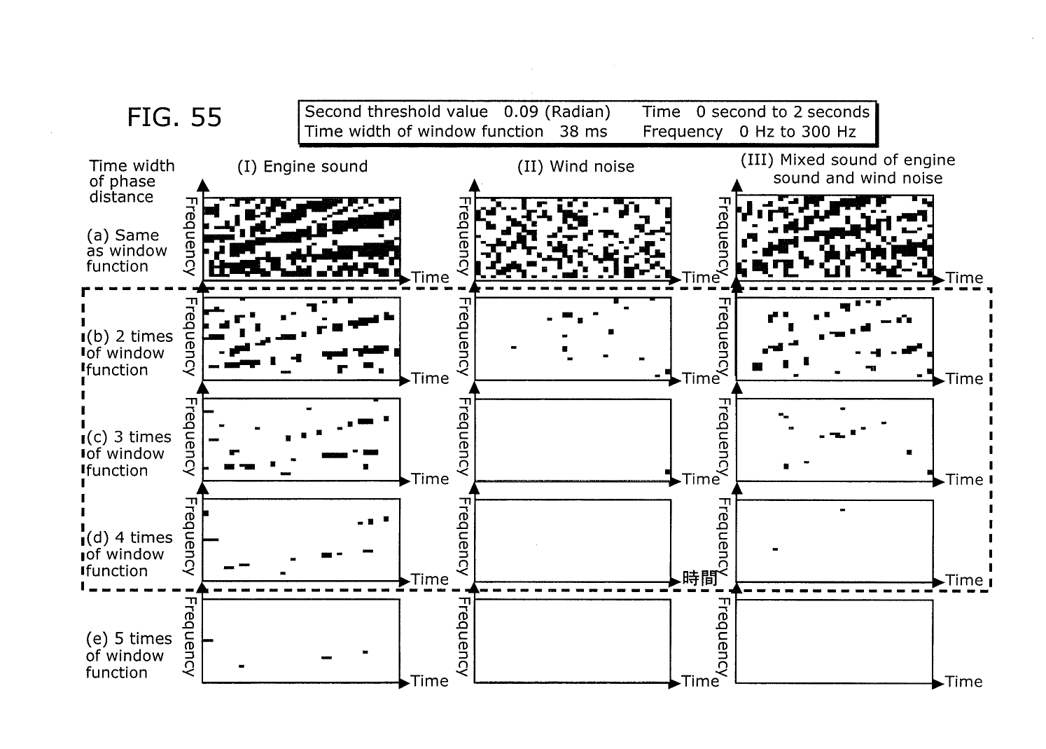

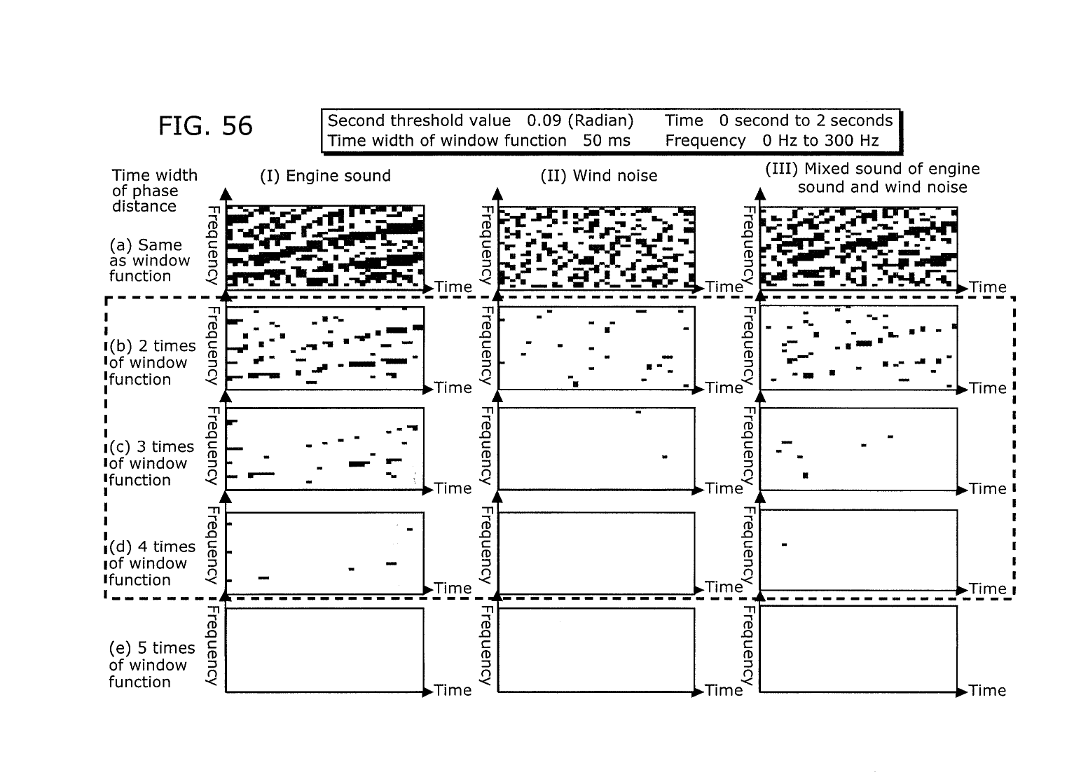

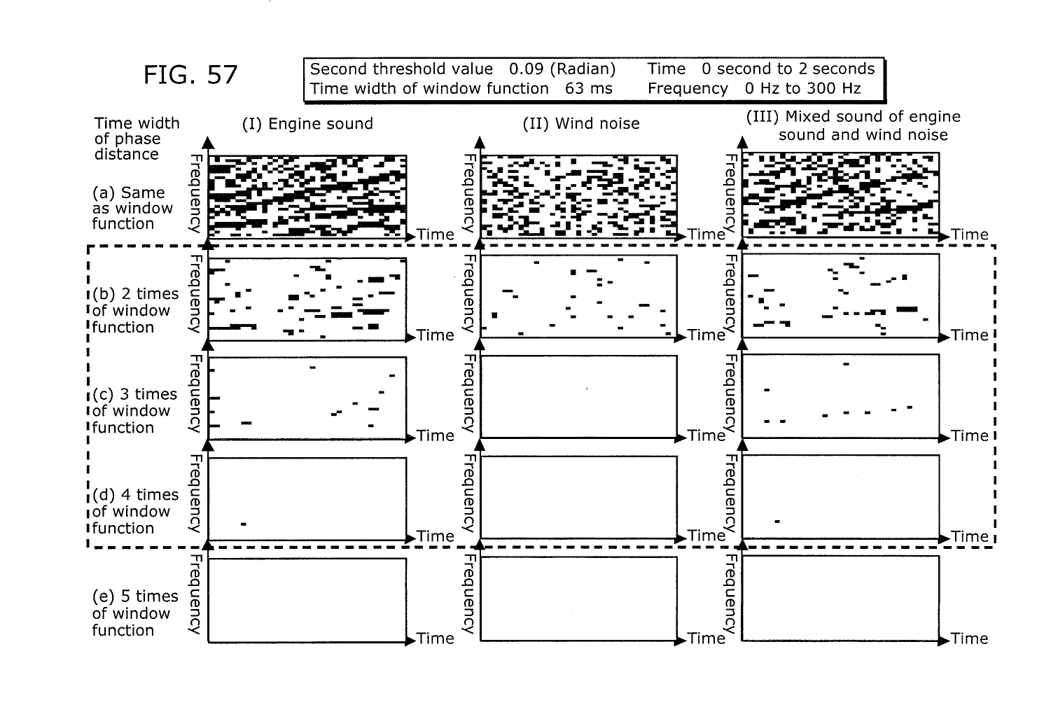

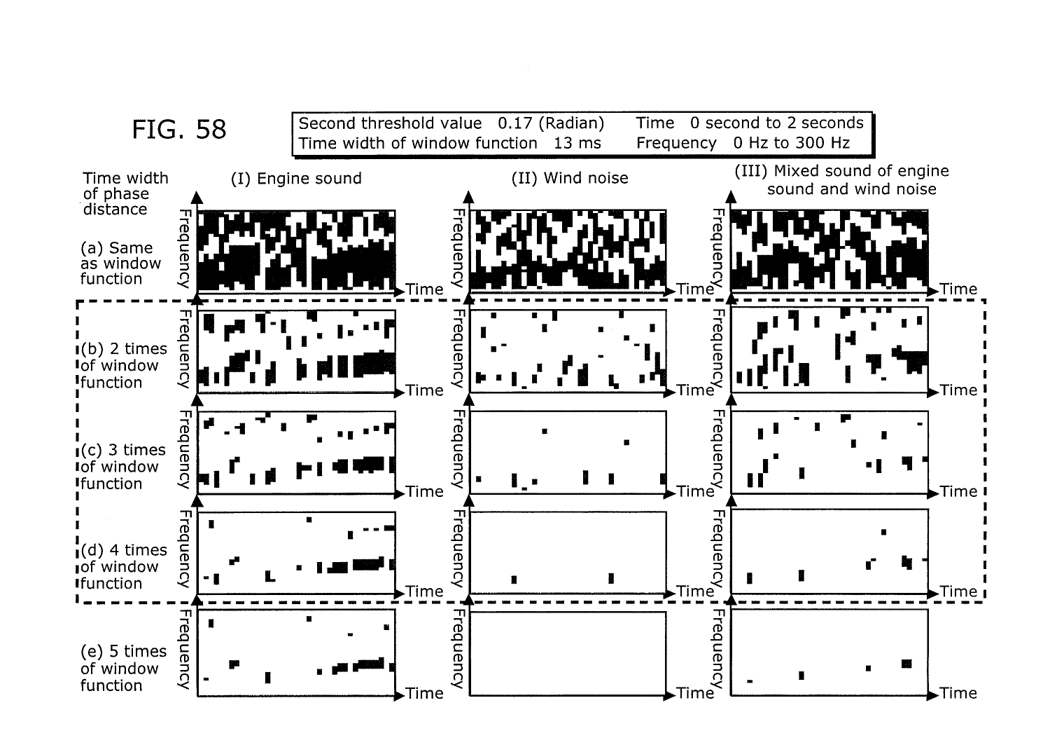

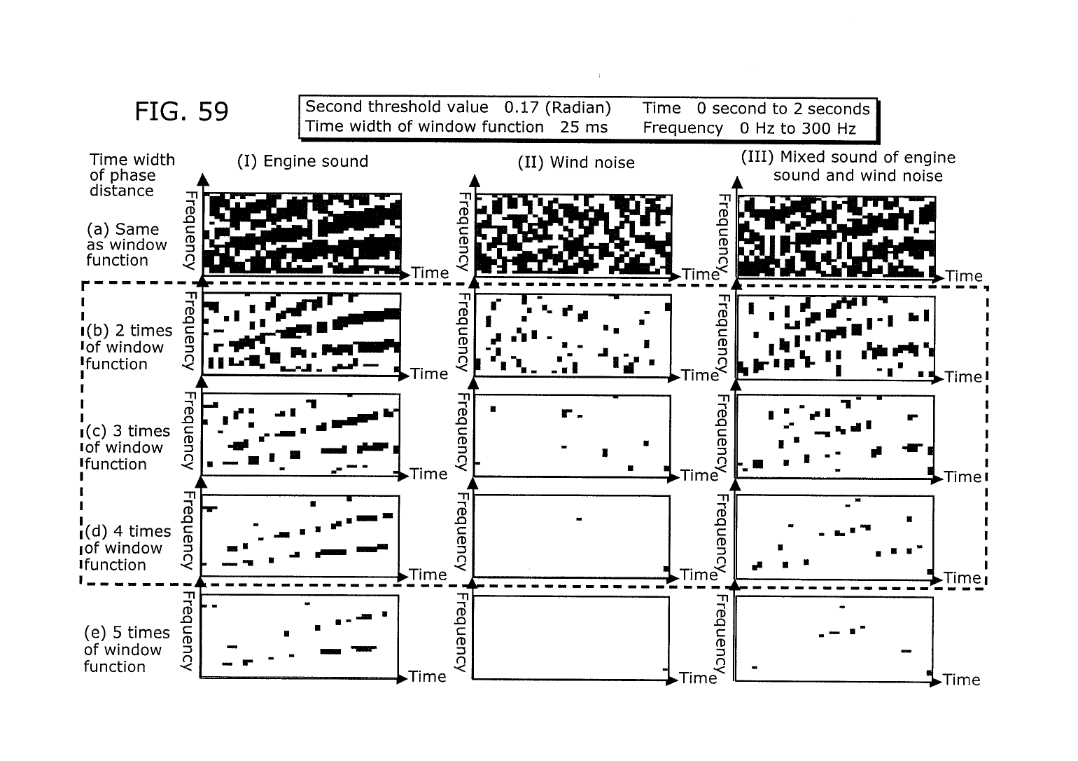

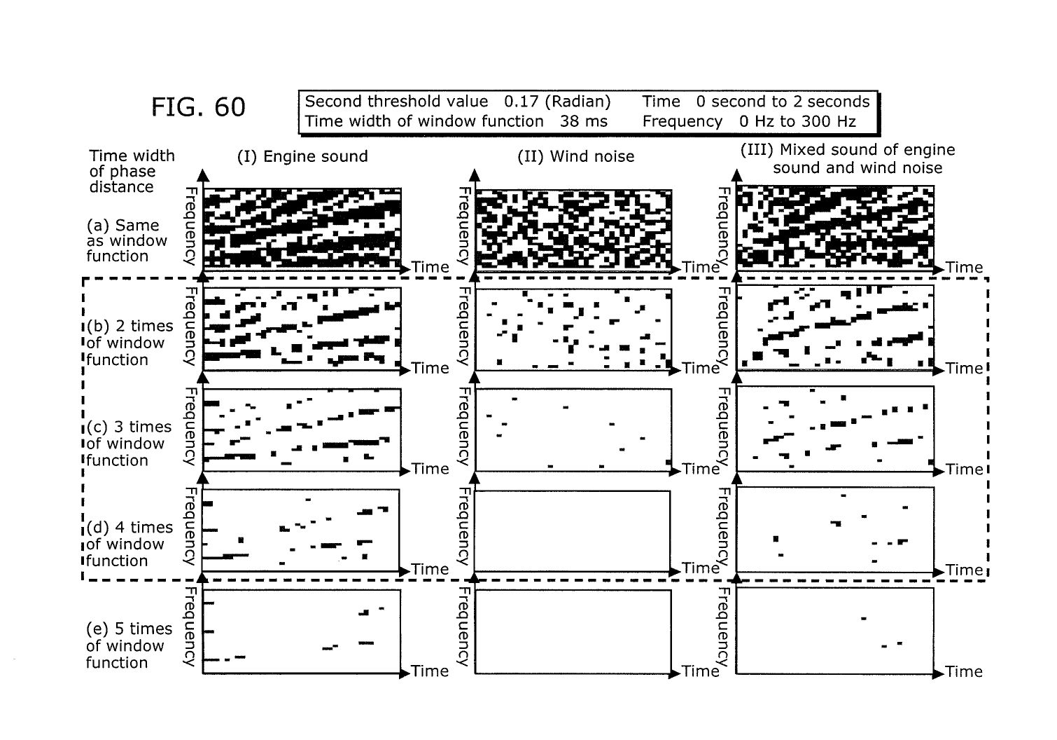

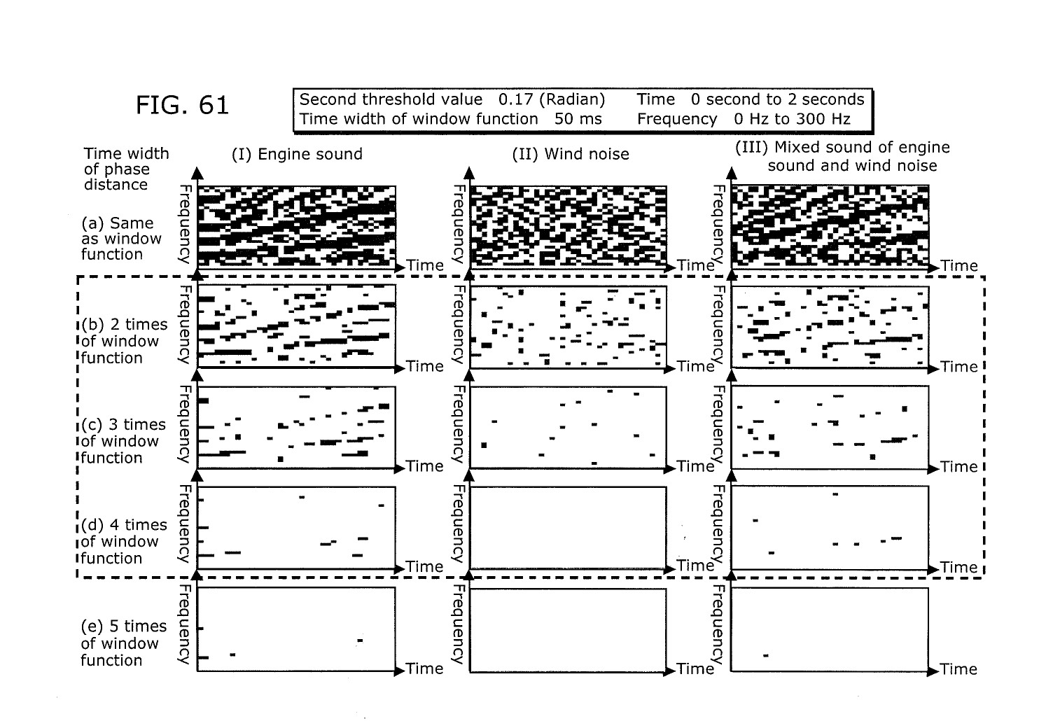

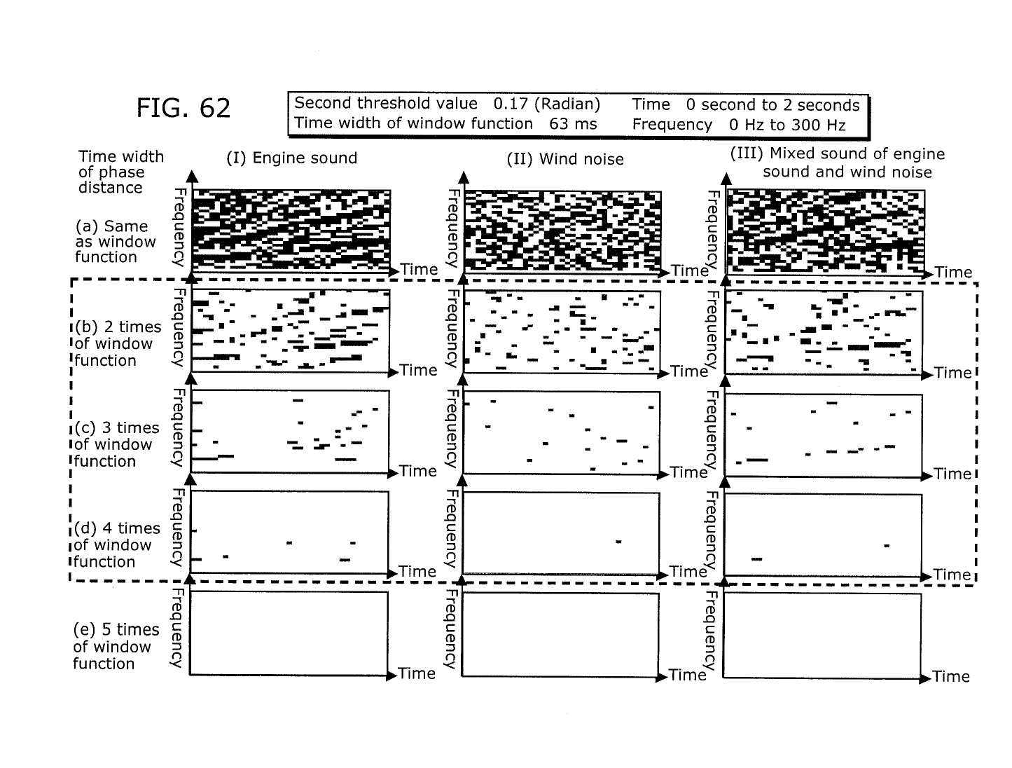

FIG. 52 shows exemplary spectrograms of an engine sound, a wind noise, and a mixed sound including the engine sound and the wind noise. The way of presentation is the same as in FIG. 10, and thus the description is not repeated. FIGS. 52(a), 52(b), and 52(c) are spectrograms of the engine sound, the wind noise, and the mixed sound including the engine sound and the wind noise, respectively. These spectrograms show a 0- to 300-Hz frequency band at a 0 to 2 second range.

Each of FIGS. 53 to 57 shows results of determining frequency signals of sounds including a to-be-extracted sound shown in FIG. 52, in the same manner as in Embodiment 3. The second threshold value is set to 0.09 (radian). The horizontal axis represents the time axis, and the vertical axis represents the frequency axis. Here are shown the results of determining a 0- to 300-Hz frequency band at a 0 to 2 second range. The columns (I), (II), and (III) show the results of determining the frequency signals of the engine sound, the wind noise, and the mixed sound including the engine sound and the wind noise, respectively. The line (a) shows the results of determinations using, for phase distance calculation, the time width corresponding to the time window width of the window function. Likewise, the lines (b), (c), (d), and (e) show the results of determinations using, for phase distance calculation, the time widths that are 2 times, 3 times, 4 times, and 5 times the time window widths of the window functions, respectively.

FIGS. 53, 54, 55, 56, and 57 show the results of determinations using, as the time window widths of the window function, 13, 25, 38, 50, and 63 ms, respectively.

The results of determinations on the engine sound in the column (I) in each of FIGS. 53 to 57 show that the percentages of detecting a frequency signal of the engine sound decrease when the time window widths used to calculate the phase distances are 5 times or more of the time window width of the window function. The results of determinations on the wind noise in the column (II) in each of FIGS. 53 to 57 show that the percentages of detecting a frequency signal of the wind noise increase when the time widths used to calculate the phase distances are equal to or smaller than the time window width of the window function. These results show that the time window widths used to calculate the phase distances should be within a range from 2 to 4 times the time window width of the window function in order to separate a toned sound (the engine sound) and a toneless sound (the wind noise).

The results of determinations on the mixed sound including the engine sound and the wind noise in the column (III) in each of FIGS. 53 to 57 show that a frequency signal of the engine sound was able to be determined when the time widths used to calculate the phase distances are set to be within a range of 2 to 4 times the time window width of the window function.

These results of determinations in FIGS. 53 to 57 show that the time widths used to calculate the phase distances should be within a range from 2 to 4 times the time window width of the window function irrespective of the length of the time window width (corresponding to a time resolution) of the window function, in order to separate a toned sound (the engine sound) and a toneless sound (the wind noise).

Each of FIGS. 58 to 62 shows results of determining frequency signals of sounds including a to-be-extracted sound shown in FIG. 52, in the same manner as in Embodiment 3. Here, a second threshold value is set to 0.17 (radian) that is different in the case of FIGS. 53 to 57. The way of presentation is the same as in FIGS. 53 to 57, and thus the description is not repeated.

FIGS. 58, 59, 60, 61, and 62 show the results of determinations using, as the time window widths of the window function, 13, 25, 38, 50, and 63 ms, respectively.

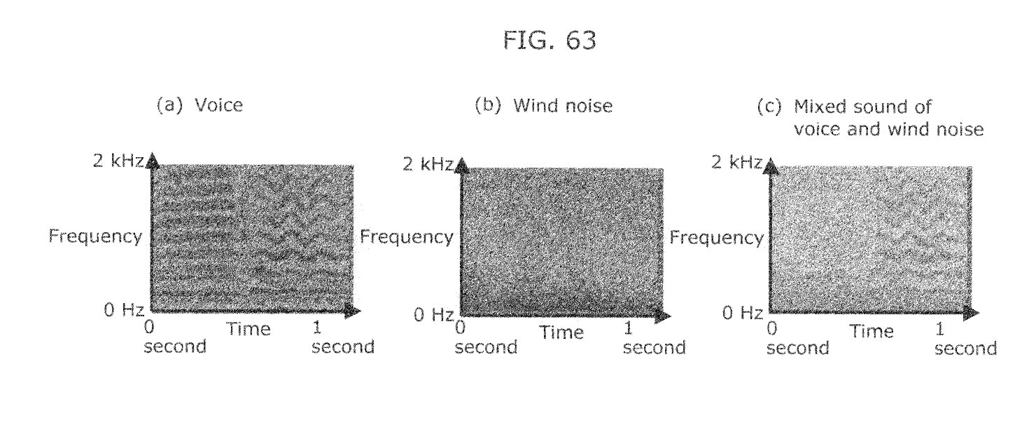

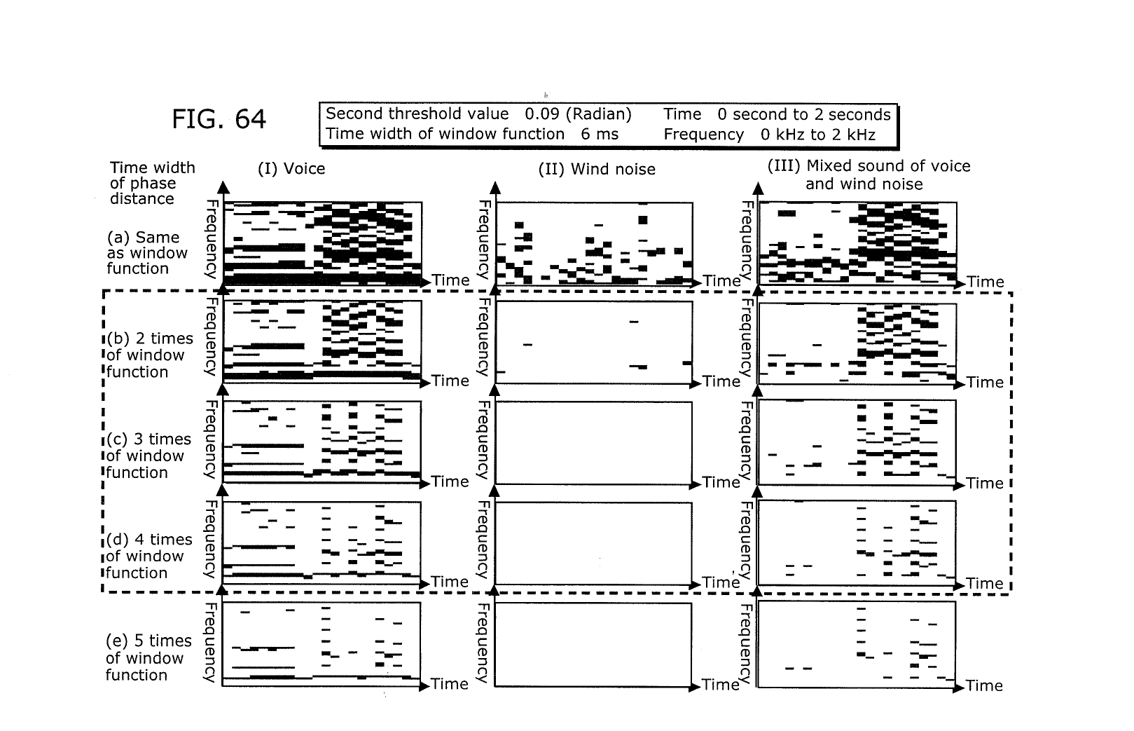

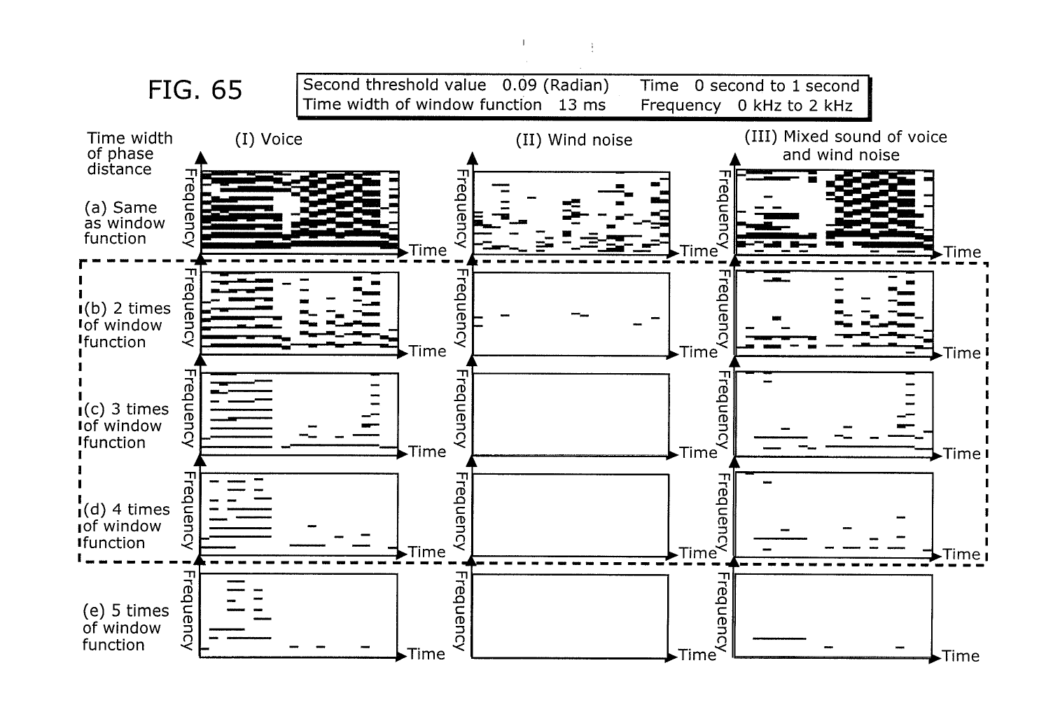

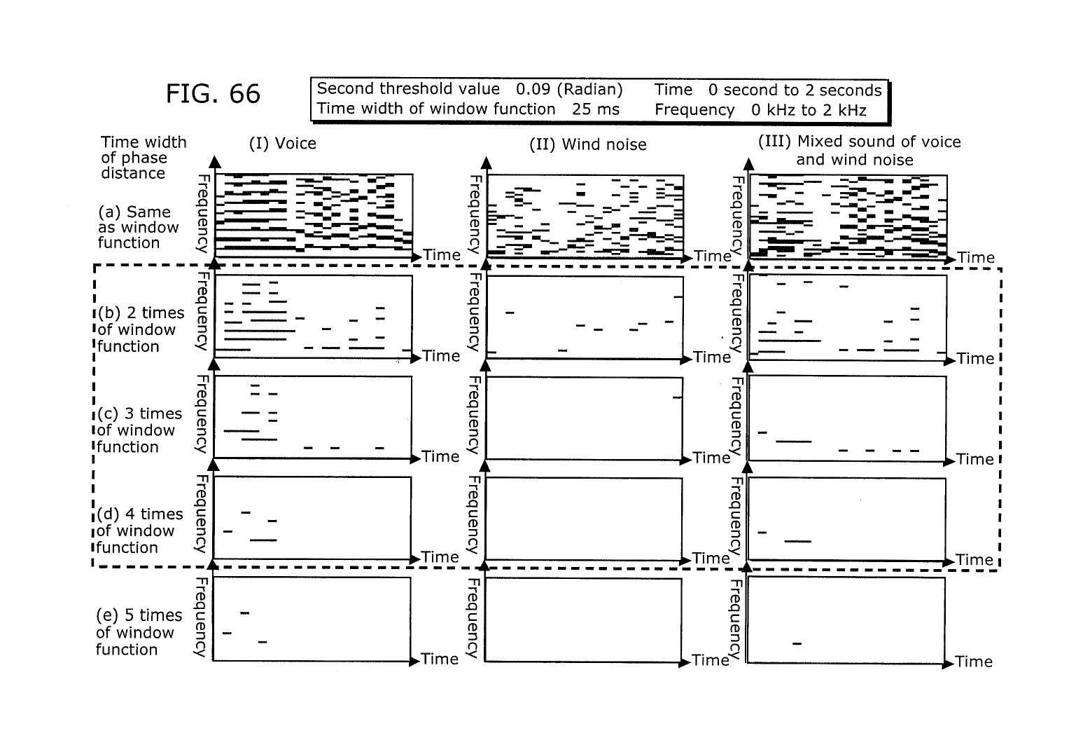

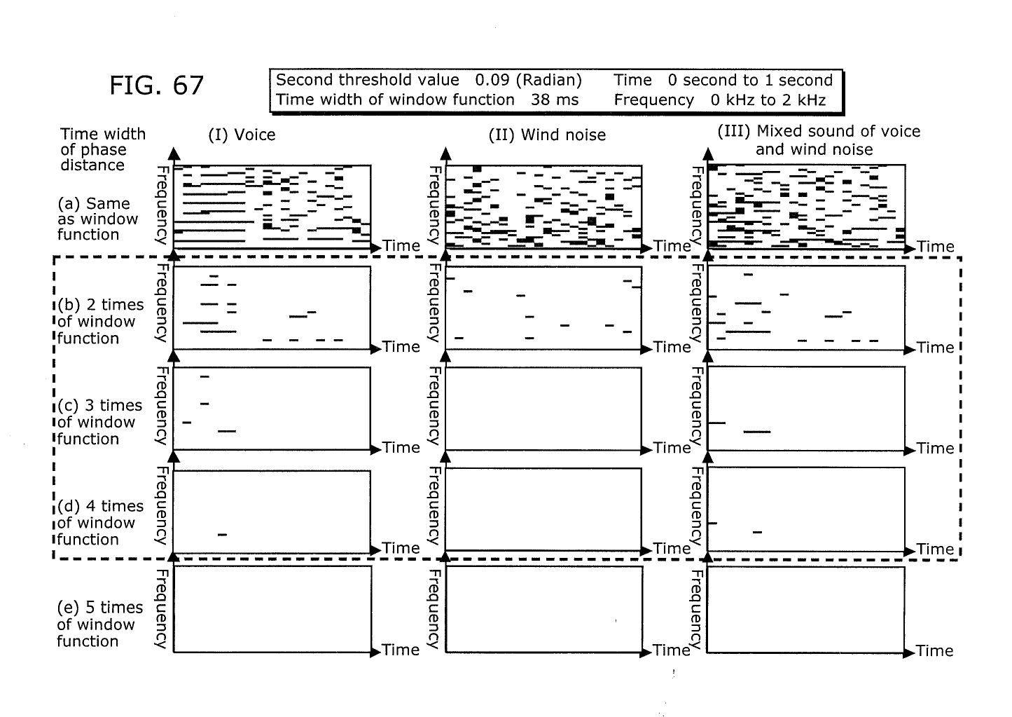

The results of determinations on the engine sound in the column (I) in each of FIGS. 58 to 62 show that the percentages of detecting a frequency signal of the engine sound decrease when the time widths used to calculate the phase distances are 5 times or more of the time window width of the window function. The results of determinations on the wind noise in the column (II) in each of FIGS. 53 to 57 show that the percentages of detecting a frequency signal of the wind noise increase when the time widths used to calculate the phase distances are equal to or smaller than the time window width of the window function. The results of determinations on the mixed sound including the engine sound and the wind noise in the column (III) in each of FIGS. 53 to 57 show that a frequency signal of the engine sound was able to be determined when the time widths used to calculate the phase distances are set to be within a range from 2 to 4 times the time window width of the window function. These results are the same as the results shown in FIGS. 53 to 57. These results show that the time widths used to calculate the phase distances should be within a range from 2 to 4 times the time window width of the window function irrespective of the second threshold value, in order to separate a toned sound (the engine sound) and a toneless sound (the wind noise). FIG. 63 shows spectrograms of a voice, a wind noise, and a mixed sound including the voice and the wind noise. The way of presentation is the same as in FIG. 7, and thus the description is not repeated. FIGS. 63(a), 63(b), and 63(c) are spectrograms of the voice, the wind noise, and the mixed sound including the voice and the wind noise, respectively. These spectrograms show a 0- to 2-kHz frequency band at a 0 to 1 second range.

Each of FIGS. 64 to 67 shows results of determining frequency signals of sounds including a to-be-extracted sound shown in FIG. 48, in the same manner as in Embodiment 3. The second threshold value is set to 0.09 (radian). The horizontal axes represent the time axes, and the vertical axes represent the frequency axes. Here are shown the results of determining a 0- to 2-kHz frequency band at a 0 to 1 second range. The columns (I), (II), and (III) show the results of determining the frequency signals of the voice, the wind noise, and the mixed sound including the voice and the wind noise, respectively. The line (a) shows the results of determinations using, for phase distance calculation, the time width corresponding to the time window width of the window function. Likewise, the lines (b), (c), (d), and (e) show the results of determinations using, for phase distance calculation, the time widths that are 2 times, 3 times, 4 times, and 5 times the time window widths of the window functions, respectively.

FIGS. 64, 65, 66, and 67 show the results of using, as the time window widths of the window function, 6, 13, 25, and 38 ms, respectively.

The results of determinations on the engine sound in the column (I) in each of FIGS. 64 to 67 show that the percentages of detecting a frequency signal of the voice decrease when the time widths used to calculate the phase distance are 5 times or more of the time window width of the window function. The results of determinations on the wind noise in the column (II) in each of FIGS. 64 to 67 show that the percentages of detecting a frequency signal of the wind noise increases when the time widths used to calculate the phase distances are equal to or smaller than the time window width of the window function. The results of determinations on the mixed sound including the voice and the wind noise in the column (III) in each of FIGS. 64 to 67 show that a frequency signal of the voice was able to be determined when the time widths used to calculate the phase distances are set to be within a range from 2 to 4 times the time window width of the window function. These results are the same as the results shown in FIGS. 53 to 57. These results show that the time widths used to calculate the phase distances should be within a range from 2 to 4 times the time window width of the window function irrespective of the kind of the sound to be extracted, in order to separate a toned sound (the voice) and a toneless sound (the wind noise).

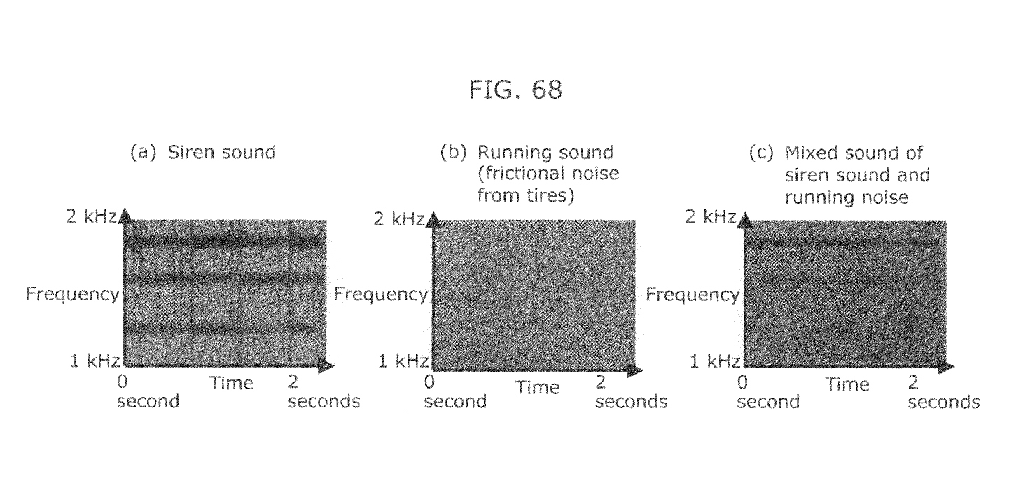

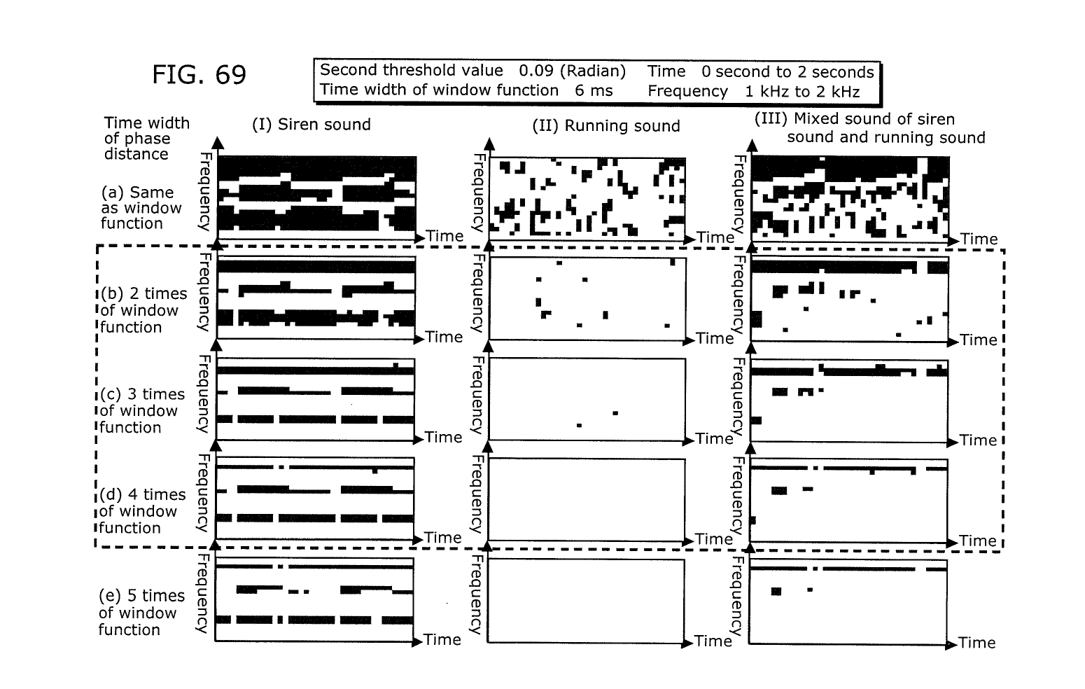

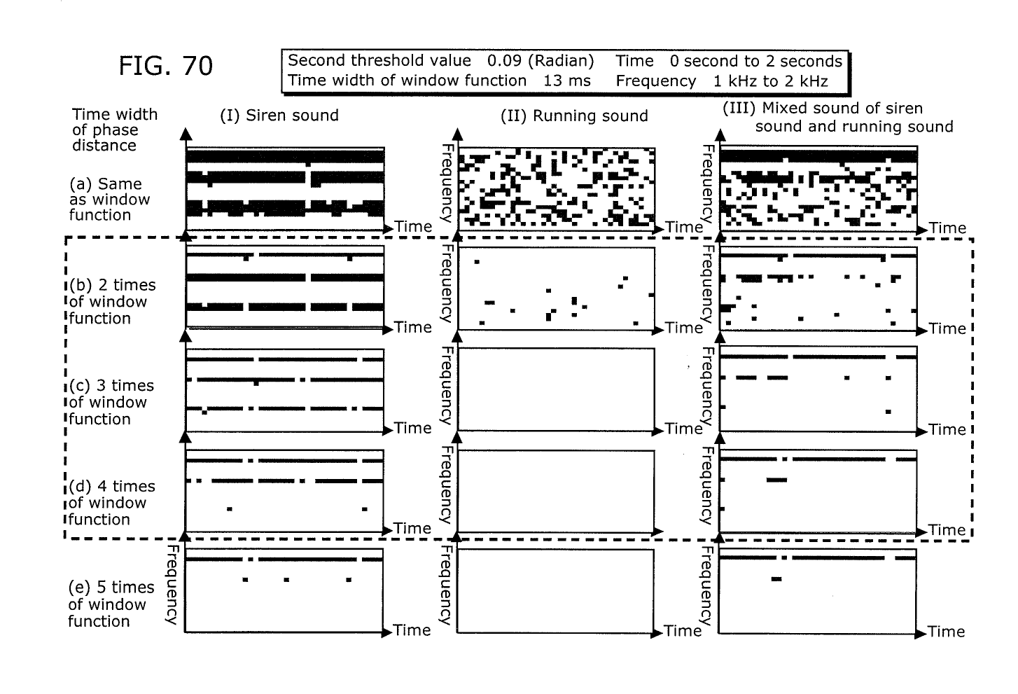

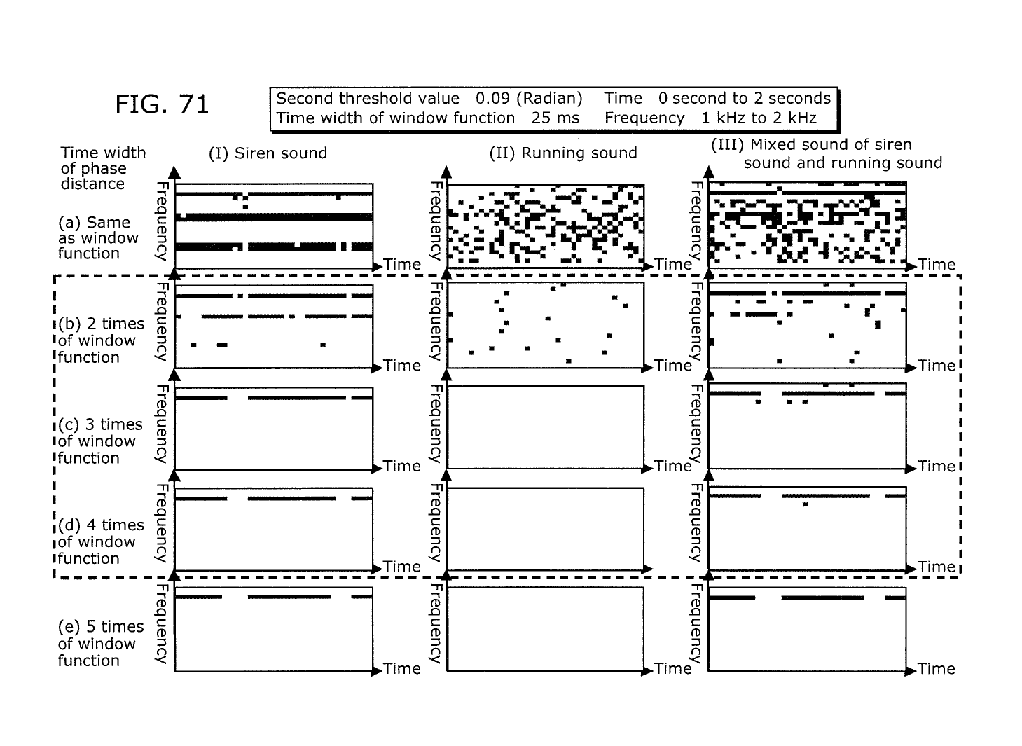

FIG. 68 shows spectrograms of a siren sound, a running sound (frictional noise from tires), and a mixed sound including the siren sound and the running sound (frictional noise from tires). The way of presentation is the same as in FIG. 10, and thus the description is not repeated. FIGS. 68(a), 68(b), and 68(c) are spectrograms of the siren sound, the running sound (frictional noise from tires), and the mixed sound including the siren sound and the running sound (frictional noise from tires), respectively. These spectrograms show a 1- to 2-kHz frequency band at a 0 to 2 second range.

Each of FIGS. 69 to 71 shows results of determining frequency signals of sounds including a to-be-extracted sound shown in FIG. 68, in the same manner as in Embodiment 3. The second threshold value is set to 0.09 (radian). The horizontal axes are the time axes, and the vertical axes are the frequency axes. Here are shown the results of determining a 1- to 2-kHz frequency band at a 0 to 2 second range. The columns (I), (II), and (III) show the results of determinations on the siren sound, the running sound (frictional noise from tires), and the mixed sound including the siren sound and the running sound (frictional noise from tires), respectively. The line (a) shows the result of determinations using, for phase distance calculation, the time width corresponding to the time window width of the window function. Likewise, the lines (b), (c), (d), and (e) show the results of determinations using, for phase distance calculation, the time widths that are 2 times, 3 times, 4 times, and 5 times the time window widths of the window functions, respectively.

FIGS. 69, 70, and 71 show the results of using, as the time window widths of the window function, 6, 13, and 25 ms, respectively.

The results of determinations on the siren sound in the column (I) in each of FIGS. 69 to 71 show that the percentages of detecting a frequency signal of the siren sound decrease when the time widths used to calculate the phase distances are 5 times or more of the time window width of the window function. The results of determinations on the running sound (frictional noise from tires) in the column (II) in each of FIGS. 69 to 71 show that the percentages of detecting a frequency signal of the running sound increase when the time widths used to calculate the phase distances are equal to or smaller than the time window width of the window function. The results of determinations on the mixed sound including the siren sound and the running sound in the column (III) in each of FIGS. 69 to 71 show that a frequency signal of the siren sound was able to be determined when the time widths used to calculate the phase distances are set to be within a range from 2 to 4 times the time window width of the window function. These results are the same as the results shown in FIGS. 53 to 57. These results of determinations in FIGS. 69 to 71 show that the time widths used to calculate the phase distances should be within a range from 2 to 4 times the time window width of the window function irrespective of the kind of the noise (toneless sound), in order to separate a toned sound (the siren sound) and a toneless sound (the running noise (frictional noise from tires)).

The noise removal devices and vehicle detection devices shown in the above-described embodiments may be implemented by causing CPUs of computers to execute programs for operating the respective processing units of the respective devices. In this case, data to be processed by the respective processing units are stored in a memory or a hard disc in the computers.

Although the embodiments are described as examples for only illustrative purposes in all respects, the present invention should be understood as not being limited to these embodiments. Thus, the scope of the present invention is indicated by not the embodiments but the Claims. Those skilled in the art will readily appreciate that many modifications and variations are possible in the exemplary embodiments without materially departing from the novel teachings and advantages of the present invention. Accordingly, all such modifications and variations having meanings equivalent to those in the present invention are intended to be included within the scope of the present invention.

### INDUSTRIAL APPLICABILITY

A sound determination device and the like according to the present invention is capable of determining frequency signals of a to-be-extracted sound included in a mixed sound, on a per time-frequency domain basis. In particular, it is possible to separate toned sounds such as an engine sound, a siren sound, and a voice in distinction from toneless sounds such as a wind noise, a rain sound, and a background noise, and determine frequency signals of a toned sound (or a toneless sound) on a per time-frequency domain basis.

For this, the present invention can be applied to an audio output device which receives inputs of audio frequency signals determined on a per time-frequency domain basis, and output the extracted sound using an inverse frequency transform. In addition, the present invention can be applied to an audio source direction detection device which receives, for a to-be-extracted sound in each of mixed sounds received through at least two microphones, input audio frequency signals determined on a per time-frequency basis, and outputs information indicating the audio source direction of the to-be-extracted sound. Further, the present invention can be applied to a sound identification device which receives input frequency signals, of a to-be extracted sound, determined on a per time-frequency domain basis, and performs voice recognition and sound identification. Furthermore, the present invention can be applied to a wind noise level determination device which receives input frequency signals, of a wind noise, determined on a per time-frequency domain basis, and output information indicating the magnitude of the signal power. In addition, the present invention can be applied to a vehicle detection device which receives input audio frequency signals, of a running noise due to friction of tires, determined on a per time-frequency domain basis, and detect a vehicle based on the signal power. Further, the present invention can be applied to a vehicle detection device which detects frequency signals, of an engine sound, determined on a per time-frequency domain basis, and notify a driver of the presence of an approaching vehicle. Furthermore, the present invention can be applied to an emergency vehicle detection device which detects frequency signals, of a siren sound, determined on a per time-frequency domain basis, and notify a driver of the presence of an approaching emergency vehicle.

What is claimed is:

1. A sound determination device comprising:
a frequency analysis unit configured to receive a mixed sound including sounds to be extracted and noises, multiply the mixed sound by window functions having predetermined time window widths, and determine frequency signals at time points included in a predetermined time width of the mixed sound multiplied by the window functions; and
a to-be-extracted sound determination unit configured to determine, for each of the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals at the time points in the predetermined time width,
wherein the phase distance is a distance between phases ψ′(t) of the condition-satisfying frequency signals when a phase of a frequency signal at a current time point t among the time points is ψ(t) (radian) and the phase ψ′(t) is expressed by an expression ψ′(t)=mod 2π(ψ(t)−2πft), f denoting a reference frequency, and
the predetermined time width is set to be within a range from 2 to 4 times the time window widths of the window functions.

2. The sound determination device according to claim 1,
wherein said to-be-extracted sound determination unit is configured to:
classify the frequency signals into groups of frequency signals satisfying the conditions of (i) being equal to or greater than the first threshold value in number and (ii) having the phase distance between the frequency signals that is equal to or smaller than the second threshold value;
check whether or not a phase distance between the respective groups of frequency signals is equal to or greater than a third threshold value; and
determine the respective groups of frequency signals to be of different kinds of sounds to be extracted when the phase distance between the respective groups of frequency signals is equal to or greater than the third threshold value.

3. The sound determination device according to claim 1,
wherein said frequency analysis unit is configured to determine frequency signals at time points at a 1/f interval from among the frequency signals at the time points in the predetermined time width by calculation using each of the window functions having the time window widths, f denoting a reference frequency,
said to-be-extracted sound determination unit is configured to determine whether or not each of the frequency signals determined by the calculation using a corresponding one of the window functions is a frequency signal of one of the sounds to be extracted, and
said sound determination device further comprises
a sound detection unit configured to generate and output a to-be-extracted sound detection flag when at least one frequency signal at one of the time points determined by the calculation using a corresponding one of the window functions is determined to be a frequency signal of one of the sounds to be extracted.

4. The sound determination device according to claim 1, further comprising
a phase modification unit configured to modify the phase ψ(t) (radian) of the frequency signal at the current time point t to ψ′(t) according to the expression ψ′(t)=mod 2π(ψ(t)−2πft), f denoting the reference frequency,
wherein said to-be-extracted sound determination unit is configured to calculate the phase distance ψ(t) using the modified phase ψ′(t) of the frequency signal.

5. The sound determination device according to claim 1,
wherein said to-be-extracted sound determination unit is configured to generate, in time and phase space, an approximate straight line representing the phases of the frequency signals at the time points in the predetermined time width, and calculate the phase distance between each of the frequency signals at the time points and the approximate straight line.

6. A sound detection device comprising:
the sound determination device according to claim 1; and
a sound detection unit configured to generate and output a to-be-extracted sound detection flag when said sound determination device determines that a frequency signal among the frequency signals of the mixed sound is a frequency signal of one of the sounds to be extracted.

7. The sound detection device according to claim 6,
wherein said frequency analysis unit is configured to receive mixed sounds through microphones, and generate frequency signals from each of the mixed sounds,
said to-be-extracted sound determination unit is configured to determine the sounds to be extracted in each of the mixed sounds, and
said sound detection unit is configured to generate and output a to-be-extracted sound detection flag when said sound determination device determines that a frequency signal at one of the time points among the frequency signals of at least one of the mixed sounds is a frequency signal of one of the sounds to be extracted.

8. A sound extraction device comprising:
the sound determination device according to claim 1; and
a sound extraction unit configured to output a frequency signal among the frequency signals of the mixed sound when said sound determination device determines that the frequency signal is a frequency signal of one of the sounds to be extracted.

9. A sound determination method comprising:
receiving a mixed sound including sounds to be extracted and noises, multiplying the mixed sound by window functions having predetermined time window widths, and determining frequency signals at time points included in a predetermined time width of the mixed sound multiplied by the window functions; and
determining, for each of the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals at the time points in the predetermined time width,
wherein the phase distance is a distance between phases ψ′(t) of the condition-satisfying frequency signals when a phase of a frequency signal at a current time point t among the time points is ψ(t) (radian) and the phase ψ′(t) is expressed by an expression ψ′(t)=mod 2π(ψ(t)−2πft), f denoting a reference frequency, and
the predetermined time width is set to be within a range from 2 to 4 times the time window widths of the window functions.

10. A sound determination program product which, when loaded into a computer, allows the computer to execute:
receiving a mixed sound including sounds to be extracted and noises, multiplying the mixed sound by window functions having predetermined time window widths, and determining frequency signals at time points included in a predetermined time width of the mixed sound multiplied by the window functions; and
determining, for each of the sounds to be extracted, frequency signals satisfying conditions of (i) being equal to or greater than a first threshold value in number and (ii) having a phase distance between the frequency signals that is equal to or smaller than a second threshold value, the condition-satisfying frequency signals being included in the frequency signals at the time points in the predetermined time width,
wherein the phase distance is a distance between phases ψ′(t) of the condition-satisfying frequency signals when a phase of a frequency signal at a current time point t among the time points is ψ(t) (radian) and the phase ψ′(t) is expressed by an expression ψ′(t)=mod 2π(ψ(t)−2πft), f denoting a reference frequency, and
the predetermined time width is set to be within a range from 2 to 4 times the time window widths of the window functions.
